(19) United States
(12) Patent Application Publication
(10) Pub. No.: US 2025/0303940 A1
(43) Pub. Date: Oct. 2, 2025

(54) CONVEYANCE SEAT

(71) Applicant: TS TECH CO., LTD., Asaka-shi, Saitama (JP)

(72) Inventors: Shuichi AKUTSU, Tochigi (JP); Haruki IKAWA, Tochigi (JP); Shoma KOMINO, Tochigi (JP); Ryota KOBAYASHI, Tochigi (JP); Kohei SATO, Tochigi (JP)

(21) Appl. No.: 18/865,279

(22) PCT Filed: May 12, 2023
(86) PCT No.: PCT/JP2023/018018

§ 371 Date: Nov. 12, 2024

Related U.S. Application Data
(60) Provisional application No. 63/341,508, filed on May 13, 2022.
(60) Provisional application No. 63/389,085, filed on Jul. 14, 2022.
(60) Provisional application No. 63/394,407, filed on Aug. 2, 2022.

(30) Foreign Application Priority Data
Apr. 27, 2023 (JP) 2023-073703
May 9, 2023 (JP) 2023-077446
May 9, 2023 (JP) 2023-077447
May 9, 2023 (JP) 2023-077448

(51) Int. Cl. B60N 2/58; B60N 2/28; B60N 2/30; B60N 2/90

(52) U.S. Cl. CPC B60N 2/585; B60N 2/2893; B60N 2/3011; B60N 2/305; B60N 2/919

(57) ABSTRACT

There is provided a conveyance seat in which a skin material can be more easily attached to a frame member. A conveyance seat is a conveyance seat including a frame member; and a skin material that covers the frame member, in which the skin material includes a first engaging portion and a second engaging portion that engage with the frame member, the first engaging portion is provided at one end portion of the skin material, the second engaging portion is provided at the other end portion located on the side opposite to the one end portion, the frame member includes an engaged portion with which the first engaging portion and the second engaging portion of the skin material engage, and the first engaging portion and the second engaging portion engage with the same engaged portion.

### TECHNICAL FIELD

The present invention relates to a conveyance seat, particularly to a conveyance seat including a skin that engages with a frame member.

### BACKGROUND ART

Conventionally, a vehicle seat installed in a conveyance such as an automobile includes a skin material that covers a pad disposed on a frame member, and that is fixed to the frame member. A plurality of hook pieces are sewn to end portions of the skin material, and the skin material is fixed to the frame member by hooking the plurality of hook pieces onto the frame member. In addition, PATENT LITERATURE 1 discloses a vehicle seat in which a skin material is attached to a pad by fitting end portions of the skin material to each other.

### CITATION LIST

### Patent Literature

PATENT LITERATURE 1: JP 2016-87195 A

### SUMMARY OF INVENTION

### Technical Problem

However, the work of a worker hooking the plurality of hook pieces one by one onto predetermined locations on the frame member or fitting the hook pieces to each other is very labor-intensive and time-consuming. For that reason, means for more easily attaching the skin to the frame when the conveyance seat is assembled has been desired.

The present invention has been made in view of the above-described problem, and an object of the present invention is to provide a conveyance seat in which a skin material can be more easily attached to a frame member.

### Solution to Problem

The above-described problem is solved by a conveyance seat of the present invention, the conveyance seat including a frame member; and a skin material that covers the frame member. The skin material includes a first engaging portion and a second engaging portion that engage with the frame member. The first engaging portion is provided at one end portion of the skin material. The second engaging portion is provided at the other end portion located on the side opposite to the one end portion. The frame member includes an engaged portion with which the first engaging portion and the second engaging portion of the skin material engage. The first engaging portion and the second engaging portion engage with the same engaged portion.

According to the conveyance seat of the present invention configured as described above, since the first engaging portion and the second engaging portion located on the side opposite to the first engaging portion are configured to engage with the same engaged portion, the position where the first engaging portion and the second engaging portion are attached becomes clear. For that reason, it is possible to provide the conveyance seat in which incorrect assembly of the first engaging portion and the second engaging portion is suppressed, the attachment workability of the skin material is improved, and the skin material can be more easily attached to the frame.

In the conveyance seat, it is preferable that the engaged portion is a hole portion formed in a rectangular shape in the frame member, that the first engaging portion engages with one side of the hole portion, and that the second engaging portion engages with the other side facing the one side.

The first engaging portion and the second engaging portion can be easily engaged with the same engaged portion by engaging the first engaging portion with the one side of the hole portion formed in a rectangular shape, and engaging the second engaging portion with the other side. In addition, the skin material can be supported in a well-balanced manner, and the attachment state of the skin material is stabilized.

In the conveyance seat, it is preferable that the first engaging portion is provided with a first extending portion that is formed such that a length of the first extending portion in a seat width direction decreases as the first extending portion extends toward a tip of the first engaging portion, and that the second engaging portion is provided with a second extending portion that is formed such that a length of the second extending portion in the seat width direction decreases as the second extending portion extends toward a tip of the second engaging portion.

By providing the first extending portion and the second extending portion, the elasticity of the skin material is also ensured while ensuring the attachment rigidity of the skin material, and the attachment workability of the skin material is improved.

In the conveyance seat, it is preferable that a length of a rear end of the second extending portion in the seat width direction is longer than a length of a rear end of the first extending portion in the seat width direction.

The attachment strength of the second engaging portion can be improved by making the length of the rear end of the second extending portion in the seat width direction longer than the length of the rear end of the first extending portion in the seat width direction.

In the conveyance seat, it is preferable that a length of the first extending portion in a direction perpendicular to the seat width direction is longer than a length of the second extending portion in the direction perpendicular to the seat width direction.

By making the length of the first extending portion in the direction perpendicular to the seat width direction longer than the length of the second extending portion in the direction perpendicular to the seat width direction, elasticity is improved, and it is made easier to attach the first engaging portion to the engaged portion.

In addition, in the conveyance seat, it is preferable that a step portion is formed in the frame member, and that the engaged portion is disposed in the vicinity of the step portion.

By disposing the engaged portion in the vicinity of the step portion, the rigidity of the engaged portion is improved, and the attachment state of the skin material is stabilized.

In addition, in the conveyance seat, it is preferable that a bead is formed in the vicinity of the step portion. The rigidity of the step portion is improved by forming the bead in the vicinity of the step portion, and accordingly, the rigidity of the engaged portion is also improved, so that the attachment state of the skin material is stabilized.

In addition, in the conveyance seat, it is preferable that the frame member includes a fixing portion for fixing the conveyance seat to a conveyance, and that the engaged portion is disposed at a position overlapping the fixing portion in a direction perpendicular to a seat width direction.

By disposing the engaged portion at a position overlapping the fixing portion in the direction perpendicular to the seat width direction, the rigidity of the engaged portion is improved, and the attachment state of the skin material is stabilized.

In addition, in the conveyance seat, it is preferable that the frame member includes a tether anchor for fixing a child seat, and that the engaged portion is disposed at a position overlapping the tether anchor in a seat width direction.

By disposing the engaged portion at a position overlapping the tether anchor in the seat width direction, the rigidity of the engaged portion is improved, and the attachment state of the skin material is stabilized.

In addition, in the conveyance seat, it is preferable that the skin material is provided with a linear fastener that couples side portions of the skin material after the frame member is covered with the skin material, and that a terminal portion of the linear fastener is covered by a hiding portion.

By covering the terminal portion of the linear fastener with the hiding portion, the linear fastener can be made shorter than in the conventional art. In addition, by covering the terminal portion of the linear fastener with the hiding portion, the terminal portion of the linear fastener can be hidden, and design is improved.

### Advantageous Effects of Invention

According to the conveyance seat of the present invention, since the first engaging portion and the second engaging portion located on the side opposite to the first engaging portion are configured to engage with the same engaged portion, the position where the first engaging portion and the second engaging portion are attached becomes clear. For that reason, it is possible to provide the conveyance seat in which incorrect assembly of the first engaging portion and the second engaging portion is suppressed, the attachment workability of the skin material is improved, and the skin material can be more easily attached to the frame.

In addition, the first engaging portion and the second engaging portion can be easily engaged with the same engaged portion by engaging the first engaging portion with the one side of the hole portion formed in a rectangular shape, and engaging the second engaging portion with the other side. In addition, the skin material can be supported in a well-balanced manner, and the attachment state of the skin material is stabilized.

By providing the first extending portion and the second extending portion, the elasticity of the skin material is also ensured while ensuring the attachment rigidity of the skin material, and the attachment workability of the skin material is improved.

The attachment strength of the second engaging portion can be improved by making the length of the rear end of the second extending portion in the seat width direction longer than the length of the rear end of the first extending portion in the seat width direction.

By making the length of the first extending portion in the direction perpendicular to the seat width direction longer than the length of the second extending portion in the direction perpendicular to the seat width direction, elasticity is improved, and it is made easier to attach the first engaging portion to the engaged portion.

By disposing the engaged portion in the vicinity of the step portion, the rigidity of the engaged portion is improved, and the attachment state of the skin material is stabilized.

The rigidity of the step portion is improved by forming the bead in the vicinity of the step portion, and accordingly, the rigidity of the engaged portion is also improved, so that the attachment state of the skin material is stabilized.

By disposing the engaged portion at position overlapping the fixing portion in the direction perpendicular to the seat width direction, the rigidity of the engaged portion is improved, and the attachment state of the skin material is stabilized.

By disposing the engaged portion at a position overlapping the tether anchor in the seat width direction, the rigidity of the engaged portion is improved, and the attachment state of the skin material is stabilized.

By covering the terminal portion of the linear fastener with the hiding portion, the linear fastener can be made shorter than in the conventional art. In addition, by covering the terminal portion of the linear fastener with the hiding portion, the terminal portion of the linear fastener can be hidden, and design is improved.

### BRIEF DESCRIPTION OF DRAWINGS

FIG. 1 is a perspective view of a rear seat composed of conveyance seats of a first embodiment, when viewed obliquely from the rear.

FIG. 2 is a rear view of a seat back of the conveyance seat when viewed from the rear, and is a view showing the attachment state of a skin material.

FIG. 3 is a cross-sectional view taken along line A-A of FIG. 2, and is a view showing a state where an end portion of the skin material is engaged with a back frame.

FIG. 4 is a rear view showing a back surface of a back pad.

FIG. 5 is a rear view showing a back surface of the back frame.

FIG. 6 is a side view showing a left side surface of the seat back.

FIG. 7 is an enlarged view showing a portion B of FIG. 6, and is a view showing a terminal portion of a linear fastener.

FIG. 8 is a cross-sectional view taken along line C-C of FIG. 7.

FIG. 9 is a view showing a back frame of a second example, and is a rear view showing a back surface of the back frame.

FIG. 10 is a description view for describing a procedure for attaching a skin material to the back frame of the second example, and is a view showing a state before a first engaging portion and a second engaging portion are engaged with engaged portions.

FIG. 11 is a view showing a state where the second engaging portion is engaged with a first hole portion.

FIG. 12 is a view showing a state where the first engaging portion is engaged with a second hole portion and a hanging portion is lowered.

FIG. 13 is a side view of a vehicle seat device according to a first example of a second embodiment, and is a view showing a state where a rear seat is in a usage state and a front seat is in a normal state.

FIG. 14 is a view showing a state where the rear seat is in an upright state and the front seat is in a tumble state.

FIG. 15 is a view showing a state where the rear seat is in a stored state and the front seat is in the tumble state.

FIG. 16 is a side view of a vehicle seat device of a second example, and is a view showing a state where the rear seat is in the usage state and the front seat is in the normal state.

FIG. 17 is a view showing a state where the rear seat is in the upright state and the front seat is in the tumble state.

FIG. 18 is a view showing a state where the rear seat is in the stored state and the front seat is in the tumble state.

FIG. 19 is a side view of a vehicle seat device of a third example, and is a view showing a state where the rear seat is in the usage state and the front seat is in the normal state.

FIG. 20 is a view showing a state where the rear seat is in the upright state and the front seat is in the tumble state.

FIG. 21 is a view showing a state where the rear seat is in the stored state and the front seat is in the tumble state.

FIG. 22 is a side view of a vehicle seat device of a fourth example, and is a view showing a state where the rear seat is moved from the usage state to the stored state.

FIG. 23 is a side view of a vehicle seat device of a fifth example, and is a view showing a state where the rear seat is moved from the usage state to the stored state.

FIG. 24 is a side view of a vehicle seat device of a sixth example, and is a view showing a state where the rear seat is moved from the usage state to the stored state.

FIG. 25 is a side view of a vehicle seat device of a seventh example, and is a view showing a state where the rear seat is moved from the usage state to the stored state.

FIG. 26 is a side view of a vehicle seat device of a third embodiment, and is a view showing a state where a rear seat is in a usage state and a front seat is in a normal state.

FIG. 27 is a view showing a state where the rear seat is in a first folded state and the front seat is in a tumble state.

FIG. 28 is a view showing a state where the rear seat is in an upright state and the front seat is in the tumble state.

FIG. 29 is a view showing a state where the rear seat is in a stored state and the front seat is in the tumble state.

FIG. 30 is a view showing a state where the rear seat is in a flipped state and the front seat is in the normal state.

FIG. 31 is a view showing a state where the rear seat is in a second folded state and the front seat is in the normal state.

FIG. 32A is a view showing a state where a first lock member is in a locked position and a second lock member is in a locked position.

FIG. 32B is a view showing a state where the first lock member is in an unlocked position and the second lock member is in the locked position.

FIG. 32C is a view showing a state where the first lock member is in the unlocked position and the second lock member is in an unlocked position.

FIG. 33 is a perspective view of a conveyance seat according to a fourth embodiment.

FIG. 34 is a perspective view showing a frame of the conveyance seat.

FIG. 35 is a cross-sectional view taken along line A-A of FIG. 33, and is a view showing the positions of heaters provided on pads.

FIG. 36 is a view showing the heater and a cushion pad when viewed from the front.

FIG. 37 is a top view showing the cushion pad to which the heater is attached.

FIG. 38 is a bottom view showing the cushion pad to which the heater is attached.

FIG. 39 is a front view showing the cushion pad to which the heater is attached.

FIG. 40A is a front view showing a cushion pad in which another example of a protrusion is formed.

FIG. 40B is a front view showing a cushion pad in which another example of a protrusion is formed.

FIG. 40C is a front view showing a cushion pad in which a protruding portion is formed.

FIG. 40D is a front view showing a cushion pad in which another example of a protrusion is formed.

FIG. 40E is a front view showing a cushion pad in which another example of a protrusion is formed.

FIG. 40F is a top view showing a cushion pad in which a ventilation groove and recessed portions for a seat belt reminder are formed.

FIG. 41A is a view showing a heater including another example of an engaging portion.

FIG. 41B is a view showing a heater including another example of an engaging portion.

FIG. 42 is a front view of a back pad to which the heater is attached, when viewed from the front.

FIG. 43 is a rear view of the back pad to which the heater is attached, when viewed from the rear.

FIG. 44 is a flowchart showing a method for manufacturing a conveyance seat.

FIG. 45 is a top view showing a cushion pad to which a conventional heater is attached.

### DESCRIPTION OF EMBODIMENTS

### First Embodiment

### First Example

Hereinafter, a configuration of a conveyance seat according to a first embodiment of the present invention (present embodiment) will be described with reference to the drawings. However, the embodiment to be described below is one example for easy understanding of the present invention, and does not limit the present invention. Namely, the present invention can be modified or improved without departing from the concept of the present invention, and it goes without saying that the present invention includes equivalents thereof.

Incidentally, hereinafter, a vehicle seat installed in a vehicle will be provided as one example of the conveyance seat, and a configuration example of the vehicle seat will be described. However, the present invention is not limited to vehicle seats installed in ground-traveling conveyances including wheels such as an automobile and a train, and may be applied to a seat installed in an aircraft, a ship, or the like that moves in environments other than the ground.

In addition, in the following description, the “seat front to rear direction” is a front to rear direction of the conveyance seat, and is a direction coinciding with a traveling direction when the vehicle travels. In addition, the “seat width direction” is a width direction of the conveyance seat, and is a direction coinciding with a right to left direction when viewed from an occupant seated in the conveyance seat. In addition, the “seat up to down direction” is an up to down direction of the conveyance seat, and is a direction coinciding with a vertical direction when the vehicle travels on a horizontal surface.

In addition, in the following description, when directions are described with the term “vehicle” added, such as “vehicle inside” and “vehicle outside”, the directions refer to the directions with respect to the vehicle.

In addition, in the following description, unless otherwise specified, the shape, the position, the posture, and the like of each portion of the conveyance seat will be described based on the assumption that the conveyance seat is in a seated state to be described later.

### <Basic Configuration of Conveyance Seat S>

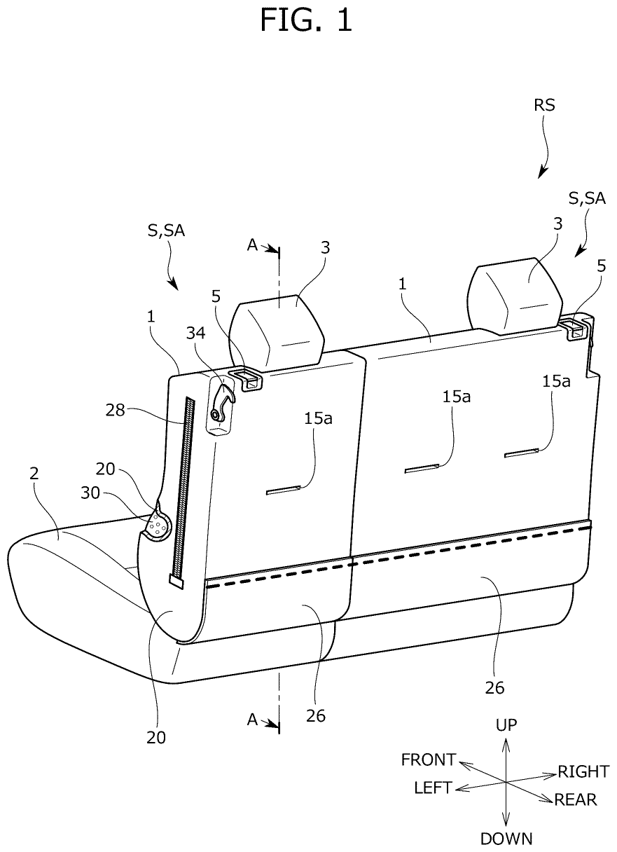

A basic configuration of the conveyance seat according to the present embodiment (hereinafter, a conveyance seat S) will be described with reference to FIG. 1. FIG. 1 is a perspective view of a rear seat RS composed of the conveyance seats S connected to each other, when viewed obliquely from the rear. In FIG. 1, for convenience of illustration, a part of the conveyance seat S is illustrated with a skin material 20 removed.

The conveyance seat S is a seat which is placed on a vehicle body floor and in which the occupant of the vehicle is seated. In the present embodiment, as shown in FIG. 1, the conveyance seat S is used as the rear seat RS corresponding to a rear seat of a vehicle. However, the conveyance seat S is not limited to being the rear seat, and the conveyance seat S may be a front seat of a vehicle, and can also be used as a middle seat in a second row or the rear seat RS in a third row of a vehicle including three rows of seats in the front to rear direction.

As shown in FIG. 1, the conveyance seat S includes, as main components, a seat back 1 serving as a backrest portion that supports the back of the seated occupant; a seat cushion 2 serving as a seating portion that supports the buttocks of the seated occupant; and a headrest 3 that is disposed on an upper portion of the seat back 1 and that supports the head of the seated occupant.

The seat back 1 and the seat cushion 2 are connected to each other with a reclining device interposed therebetween, and the seat back 1 can be rotated in the front to rear direction by releasing a lock device 34 using a reclining knob 5 provided on a shoulder portion of the seat back 1.

The rear seat RS shown in FIG. 1 is configured by connecting the conveyance seats S disposed on the right and left sides; however, since the right and left conveyance seats S have different lengths in the seat width direction, but the other configurations are substantially the same, in the following description, the conveyance seat S disposed on the left side of the rear seat RS will be described.

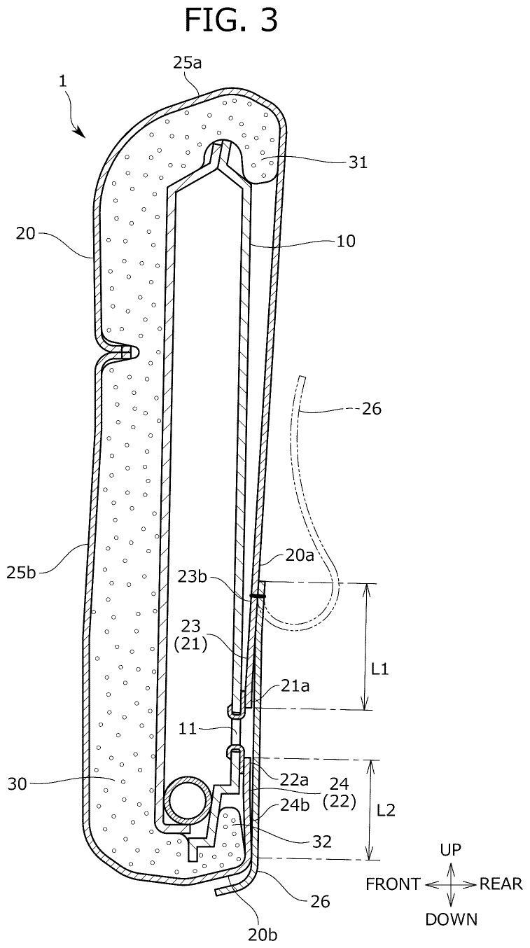

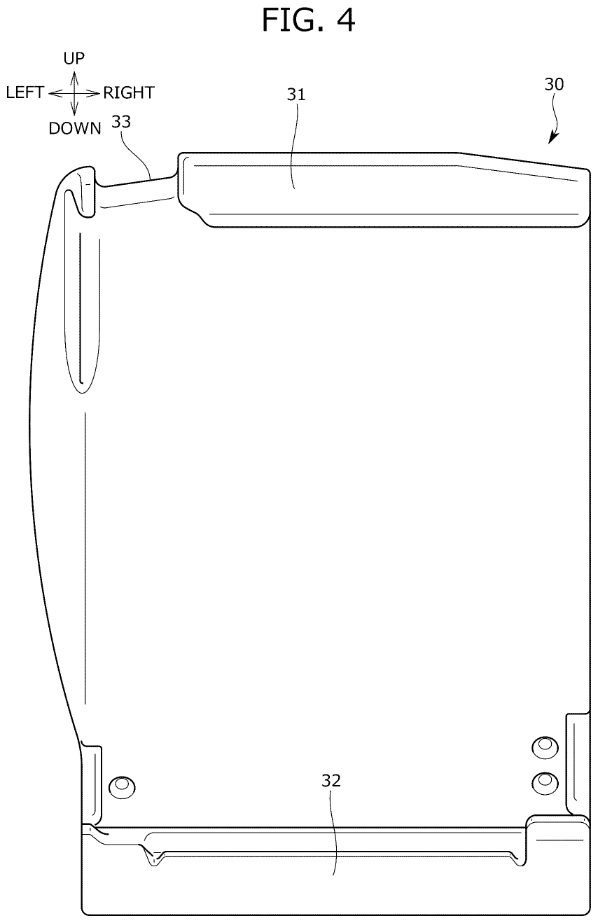

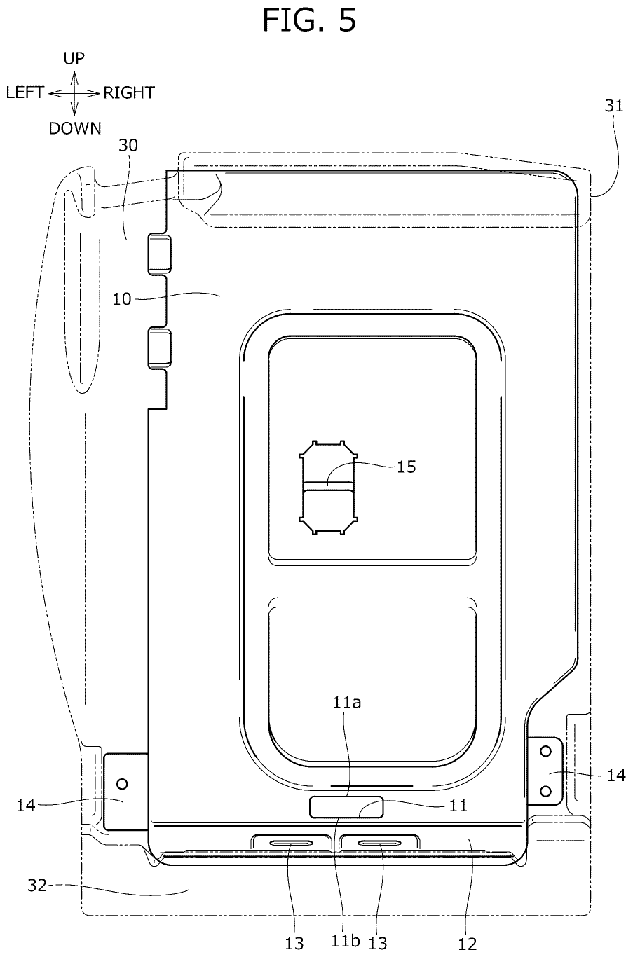

A frame member is provided inside the conveyance seat S. The frame member is mainly composed of a back frame 10 (refer to FIGS. 3 and 5) and a cushion frame (not illustrated). The back frame 10 forms the skeleton of the seat back 1, and the cushion frame forms the skeleton of the seat cushion 2. A back pad 30 shown in FIG. 4 is disposed on the back frame 10, and the back frame 10 is configured by further covering the back pad 30 with the skin material 20. In addition, a cushion pad is placed on the cushion frame, and the cushion frame is configured by covering the cushion pad with the skin material 20.

### <Back Pad 30>

The back pad 30 is, for example, a urethane base material molded by foam molding using a urethane foaming agent. As shown in FIG. 5, the back pad 30 is formed in a rectangular shape to cover the back frame 10. In addition, an upper wrapping portion 31 that wraps around and holds an upper end of the back frame 10 is formed on an upper end side of the back pad 30, and a lower wrapping portion 32 that wraps around and holds a lower end of the back frame 10 is formed on a lower end side of the back pad 30.

In addition, a recess 33 into which the reclining knob 5 is fitted is formed at an upper end of the back pad 30.

Conventionally, in order to wrap around the entire periphery of a back frame, a back pad that is provided on a seat back is formed to wrap around not only an upper end side and a lower end side, but also right and left side portions of the back frame. However, if the entire periphery of the back frame 10 is wrapped around, the back pad is less likely to come off from the back frame, but attachment workability decreases, which is a problem.

In addition, when the reclining knob is provided on the shoulder portion, conventionally, a through-hole for inserting the reclining knob is formed in an upper portion of the back pad. However, when the back pad is attached, the back pad is caught on the reclining knob, so that attachment workability decreases, which is a problem.

In the back pad 30 used in the present embodiment, portions that wrap around the right and left side portions are eliminated, and the upper end and the lower end of the back frame 10 are wrapped around and held by the upper wrapping portion 31 and the lower wrapping portion 32.

The movement of the back frame 10 in the front to rear direction is suppressed by holding the back frame 10 with the upper wrapping portion 31 and the lower wrapping portion 32. Meanwhile, by not providing wrapping portions at right and left side portions of the back pad 30, the work of wrapping around the side portions of the back frame 10 is reduced, the back pad 30 can be easily attached to the back frame 10, and the attachment workability of the back pad 30 is improved. In addition, since the number of wrapping portions is reduced, material costs can be reduced.

In addition, as shown in FIG. 3, the wrapping of the upper wrapping portion 31 is formed to be larger than the wrapping of the lower wrapping portion 32. Since an upper side of the seat back 1 is a portion that is often touched by the occupant, the wrapping of the upper wrapping portion 31 is made larger than the wrapping of the lower wrapping portion 32, so that the coming off of an upper portion of the back pad 30 from the back frame 10 due to contact with the occupant is suppressed.

In addition, as described above, conventionally, when the reclining knob is provided on the shoulder portion of the seat back, the through-hole is formed in an upper end portion of the back pad.

In the back pad 30 of the present embodiment, the recess 33 is formed at a location where the reclining knob 5 is provided, and the reclining knob 5 is prevented from being caught on the back pad 30 during assembly. In other words, in a portion that is conventionally formed as a hole, a rear end portion of the hole is not connected but cut off to form the recess 33, and the back pad 30 is prevented from being caught on the reclining knob 5. Since the chance of being caught is suppressed, the attachment workability of the back pad 30 is improved.

### <Skin Material 20>

The skin material 20 is provided on the seat back 1 to cover the back pad 30 disposed on the back frame 10. The skin material 20 is made of fabric, film, leather, sheet, or the like.

The skin material 20 is formed into a bag shape by sewing together a plurality of skin pieces 25a and skin pieces 25b, each of which is formed in a substantially rectangular shape. Linear fasteners 28 are provided at both side portions of the skin material 20, and the skin material 20 is formed in a bag shape to cover the back pad 30 when the linear fasteners 28 are closed.

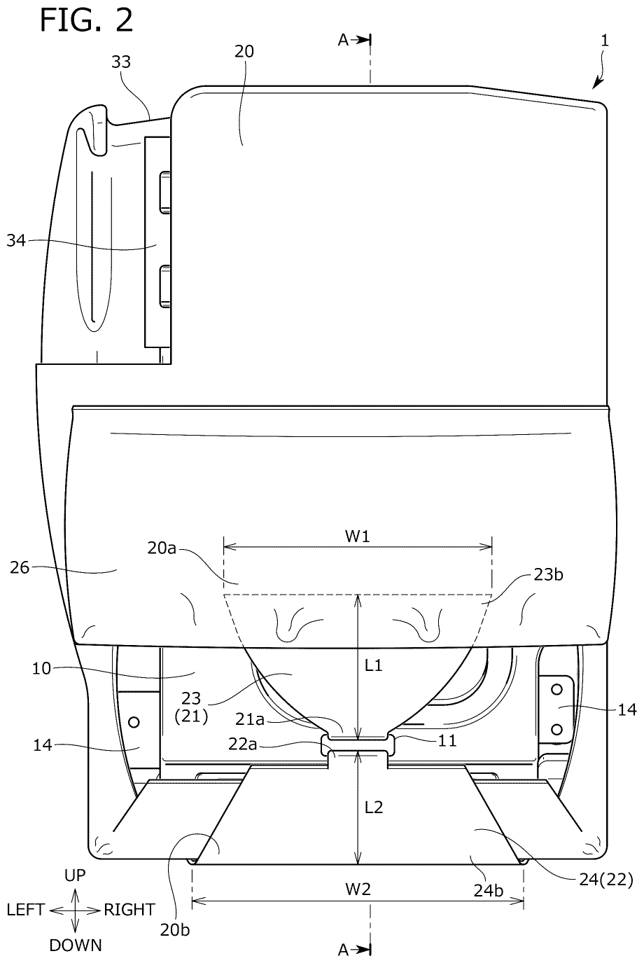

As shown in FIGS. 2 and 3, the skin material 20 includes a first engaging portion 21 and a second engaging portion 22 that engage with the back frame 10. As can be seen from FIG. 3, the skin material 20 is attached to cover a front surface side and a back surface side of an assembly of the back frame 10 and the back pad 30, and is fixed by engaging end portions of the skin material 20 with a hole portion 11 at a lower end portion on the back surface side of the back frame 10.

The first engaging portion 21 is provided at one end portion (first end portion 20a) of the skin material 20 that covers a back surface of the back frame 10. The second engaging portion 22 is provided at the other end portion (second end portion 20b) located on the side opposite to the one end portion of the skin material 20.

In more detail, the first engaging portion 21 is provided at a lower end (first end portion 20a) of the skin material 20 extending downward from an upper end of the seat back 1. The second engaging portion 22 is provided in the skin material 20 (second end portion 20b) disposed at a lower end of the seat back 1.

In other words, the first engaging portion 21 is provided at the one end portion located on the upper side of the skin material 20 disposed to extend along a circumferential direction of the assembly of the back pad 30 and the back frame 10, and the second engaging portion 22 is provided at the other end portion located on the lower side.

A J-hook formed in a hook shape is provided at a tip 21a of the first engaging portion 21, and can engage with the hole portion 11 formed in the back frame 10 to be described later as an engaged portion. In addition, a J-hook is also provided at a tip 22a of the second engaging portion 22, and can engage with the hole portion 11. As shown in FIG. 2, the first engaging portion 21 and the second engaging portion 22 are configured to engage with the same hole portion 11.

As shown in FIG. 5, the hole portion 11 is formed in a rectangular shape. The first engaging portion 21 is configured to engage with an upper side 11a (corresponding to one side of the present invention) of the hole portion 11, and the second engaging portion 22 is configured to engage with a lower side 11b (corresponding to the other side of the present invention) facing the upper side 11a.

Since the first engaging portion 21 and the second engaging portion 22 are configured to engage with the same engaged portion formed in the back frame 10, the position where the first engaging portion 21 and the second engaging portion 22 are attached becomes clear to a worker. For that reason, it is possible to provide the conveyance seat S in which incorrect assembly of the first engaging portion 21 and the second engaging portion 22 is suppressed, the attachment workability of the skin material 20 is improved, and the skin material 20 can be more easily attached to the back frame 10.

Incidentally, the tips 21a and 22a of the first engaging portion 21 and the second engaging portion 22 are configured as J-hooks; however, such a configuration is one example, and the tips 21a and 22a may be configured as projections or through-holes. In that case, the engaged portion may be configured as a wire or a projection depending on the tip shapes of the first engaging portion 21 and the second engaging portion 22.

In addition, in the present example, one hole portion 11 is formed, and the first engaging portion 21 and the second engaging portion 22 are engaged with the one hole portion 11; however, such a configuration is one example, and the number of the hole portions 11 may be one or three or more. However, the first engaging portion 21 and the second engaging portion 22 disposed to face each other are configured to engage with the same hole portion 11.

The shapes of the first engaging portion 21 and the second engaging portion 22 will be described. The first engaging portion 21 is provided with a first extending portion 23 that is formed such that a length of the first extending portion 23 in the seat width direction decreases as the first extending portion 23 extends toward the tip 21a at which the J-hook is provided. In other words, the first extending portion 23 is formed with a substantially trapezoidal shape.

The second engaging portion 22 is provided with a second extending portion 24 that is formed such that a length of the second extending portion 24 in the seat width direction decreases as the second extending portion 24 extends toward the tip 22a at which the J-hook is provided. In other words, the second extending portion 24 is formed with a substantially trapezoidal shape.

In addition, the second extending portion 24 is formed such that a length W2 of a rear end 24b of the second extending portion 24 in the seat width direction is longer than a length W1 of a rear end 23b of the first extending portion 23 in the seat width direction.

The attachment strength of the second engaging portion 22 can be improved by lengthening the length W2 of the rear end 24b of the second extending portion 24 in the seat width direction.

In addition, the first extending portion 23 is configured such that a length L1 of the first extending portion 23 in a direction perpendicular to the seat width direction is longer than a length L2 of the second extending portion 24 in the direction perpendicular to the seat width direction.

In other words, the length L1 of the first extending portion 23 in the up to down direction is larger than the length L2 of the second extending portion in the up to down direction.

By lengthening the length L1 of the first extending portion 23 in the direction perpendicular to the seat width direction, the elasticity of the first extending portion 23 is improved, and it is made easier to attach the first engaging portion 21 to the hole portion 11.

Incidentally, as shown in FIG. 2, a hanging portion 26 that hangs down is provided at the first end portion 20a of the skin material 20, and after the first engaging portion 21 and the second engaging portion 22 are engaged with the hole portion 11, by setting the hanging portion 26 to hang down as shown in FIG. 3, the first engaging portion 21, the second engaging portion 22, and the like are hidden, and the conveyance seat S is not visible from the outside.

### <Back Frame 10>

The seat back 1 is provided with the back frame 10 made of a metal plate formed in a substantially rectangular shape.

In addition, a groove portion or a recess (not illustrated) is appropriately formed in the back frame 10, so that the back frame 10 is reinforced. A step portion 12 is formed at the lower end portion of the back frame 10. In addition, a bead 13 that reinforces the step portion 12 is formed on the step portion 12.

As shown in FIG. 5, a tether anchor 15 for fixing a child seat (not illustrated) is provided in the vicinity of a central portion of the back frame 10. Incidentally, a slit 15a for passing a tether belt extending from the child seat is formed in the skin material 20 at a position corresponding to the tether anchor 15 (refer to FIG. 1).

In addition, seat fixing portions 14 for fixing the conveyance seat S to the vehicle are provided at lower ends of both the side portions of the back frame 10. The conveyance seat S can be fixed to the vehicle by bolt-fixing the seat fixing portions 14 to connecting portions (not illustrated) extending from the vehicle. The seat fixing portions 14 correspond to fixing portions of the present invention.

### <Engaged Portion>

The hole portion 11 that engages with the engaging portions (the first engaging portion 21 and the second engaging portion 22) of the skin material 20 is formed in the vicinity of the step portion 12 of the back frame 10. The hole portion 11 corresponds to an engaged portion of the present invention.

As shown in FIG. 5, the hole portion 11 is formed in a rectangular shape extending in the seat width direction. As described above, the first engaging portion 21 of the skin material 20 engages with the upper side 11a of the hole portion 11, and the second engaging portion 22 of the skin material 20 engages with the lower side 11b facing the upper side 11a. A length of the upper side 11a and a length of the lower side 11b are formed to be the same as or slightly larger than widths of the J-hooks provided at the tips of the first engaging portion 21 and the second engaging portion 22. By forming the hole portion 11 in such a manner, the attachment positions of the first engaging portion 21 and the second engaging portion 22 are made clear, and the shifting of the end portions of the skin material 20 in a lateral direction is suppressed.

The hole portion 11 that is an engaged portion is disposed in the vicinity of the step portion 12 as shown in FIG. 5. In more detail, the hole portion 11 is disposed above the step portion 12 and adjacent to the step portion 12. In addition, it is preferable that the bead 13 is formed in the vicinity of the step portion 12.

The rigidity of the hole portion 11 is improved by disposing the hole portion 11 in the vicinity of the step portion 12. In addition, the rigidity of the step portion 12 is improved by forming the bead 13 in the vicinity of the step portion 12, and accordingly, the rigidity of the hole portion 11 is improved. Since the attachment state of the skin material 20 is stabilized by improving the rigidity of the hole portion 11, the first engaging portion 21 and the second engaging portion 22 are less likely to come off from the hole portion 11.

Incidentally, it is preferable that the hole portion 11 is disposed at a position overlapping the seat fixing portions 14 for fixing the conveyance seat S to a vehicle body in the direction perpendicular to the seat width direction. Namely, the hole portion 11 is disposed side by side with the seat fixing portions 14 in the seat width direction (right to left direction). In other words, when the conveyance seat S is viewed from the side, it is preferable that the hole portion 11 is disposed to partially overlap the seat fixing portions 14.

In addition, it is preferable that the hole portion 11 is disposed at a position overlapping the tether anchor 15, which is provided in the seat back 1, in the seat width direction. Namely, the hole portion 11 is disposed side by side with the tether anchor 15 in the seat up to down direction. In other words, when the conveyance seat S is viewed from above, it is preferable that a part of the hole portion 11 and the tether anchor 15 are disposed to overlap each other.

By disposing the hole portion 11 in such a manner, the rigidity of the hole portion 11 is improved, and the attachment state of the skin material 20 is stabilized.

### <Linear Fastener 28>

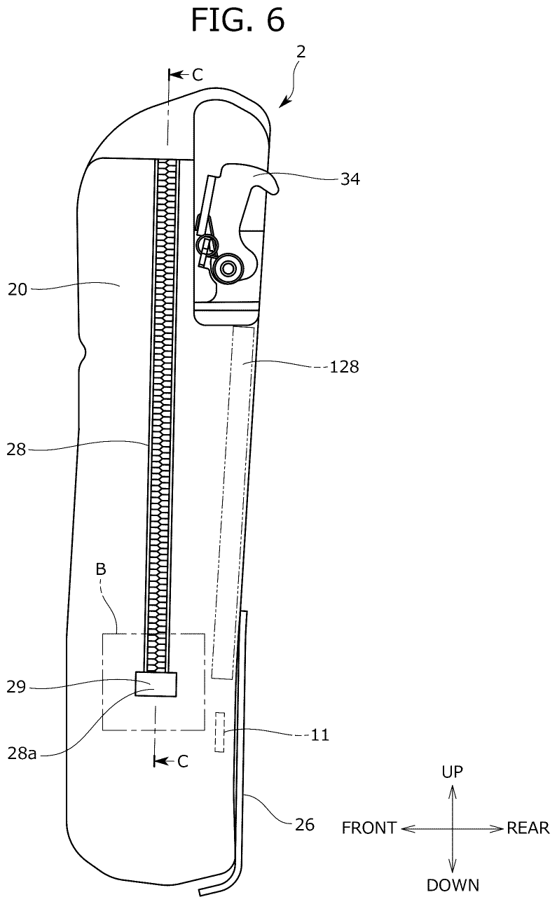

As shown in FIGS. 1 and 6, the linear fasteners 28 are provided at both side portions of the seat back 1. The linear fasteners 28 are members that couple the side portions of the skin material 20 after the back frame 10 is covered with the skin material. The skin material 20 is attached to the back pad 30 disposed on the back frame 10, in a state where the linear fasteners 28 are opened. The worker completes the mounting of the skin material 20 by engaging the first engaging portion 21 and the second engaging portion 22 with the hole portion 11, and then closing the linear fasteners 28 provided on both the side portions.

Conventionally, the linear fastener provided on the skin material is provided in the vicinity of a rear corner of the side portion of the seat back, for example, in a region 128 shown by a dotted line in FIG. 6. However, if a lock device, a striker, or the like is provided at an upper end portion of the seat back, the length of the linear fastener is shortened to avoid the lock device, the striker, or the like, which is a problem. If the linear fastener is shortened, the opening range of the skin material becomes narrower, so that it is difficult to attach the skin material to the back pad, and the ease of attachment decreases.

Therefore, in the present embodiment, as shown in FIG. 6, the linear fastener 28 is disposed at the center of the side portion of the seat back 1 in the front to rear direction to avoid the lock device 34. For that reason, the starting point of the linear fastener 28 can be provided higher, and the linear fastener 28 can be further lengthened. Therefore, an opening width of the skin material 20 becomes larger, so that the workability of covering the back pad 30 with the skin material 20 is improved.

In addition, the linear fastener 28 is provided at the side portion on an opposite side (side portion on the right side) of the seat back 1; however, since the lock device 34 is not provided on a right shoulder of the seat back 1, the linear fastener 28 can be provided without a need to avoid the lock device 34.

As in the present embodiment, by disposing the linear fastener 28 on the left side at substantially the center and providing the starting point higher, the lengths of the linear fasteners 28 attached to the right and left side portions of the seat back 1 can be matched to each other. Since the linear fasteners 28 to be used are made common, incorrect assembly can be suppressed, and manufacturing costs can be reduced.

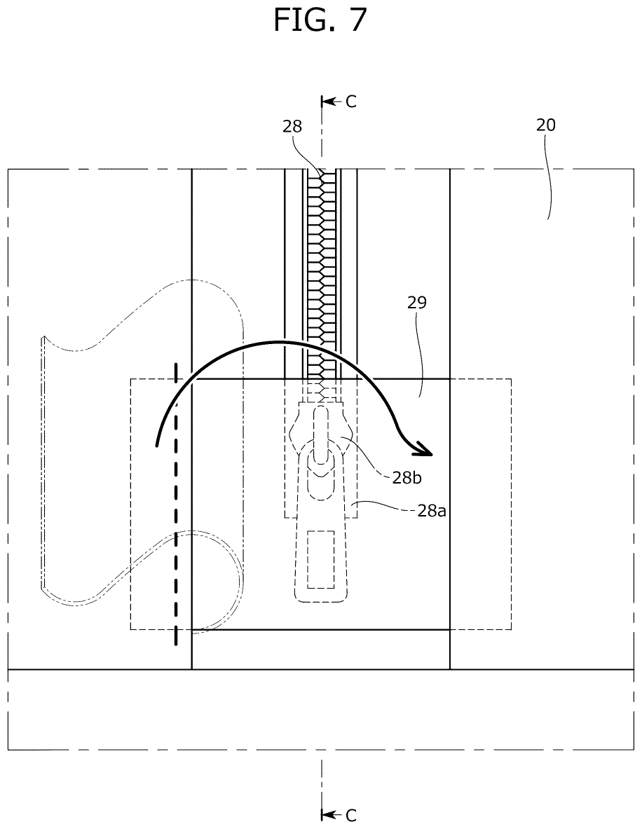

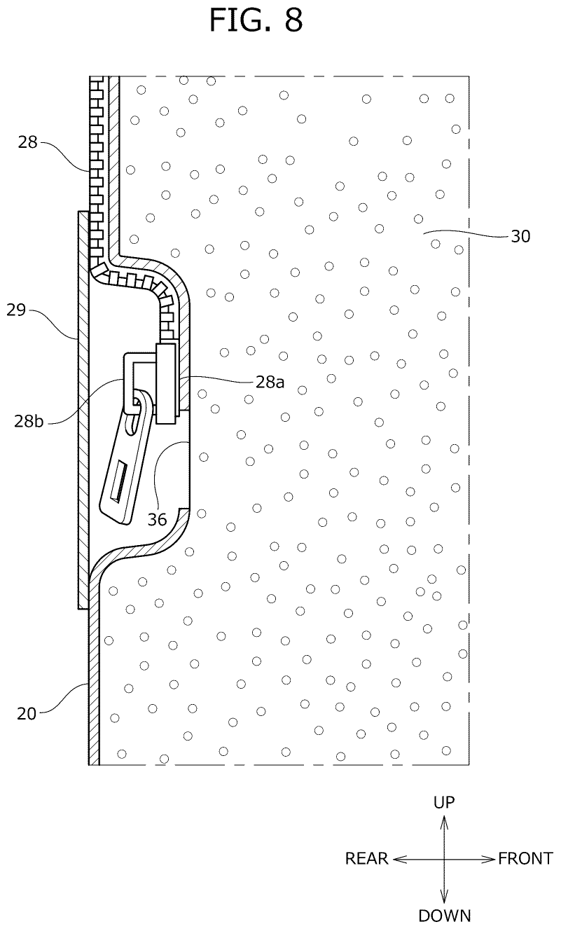

Next, a terminal portion 28a of the linear fastener 28 will be described with reference to FIGS. 7 and 8.

Conventionally, in order to hide a terminal portion of the linear fastener, the terminal portion is woven between the back pad and the back frame. However, in this structure, it is necessary to make the fastener length long.

In the conveyance seat S of the present embodiment, as shown in FIG. 8, a recess 36 is formed in the back pad 30, and the terminal portion 28a and a slider 28b of the linear fastener 28 are stored in the recess 36. Furthermore, the terminal portion 28a and the slider 28b of the linear fastener 28 are hidden by covering the terminal portion 28a and the slider 28b with a strap 29 (hiding portion).

With such a configuration, a portion that is provided long to hide the terminal portion of the linear fastener, which is conventionally required, can be eliminated, and the fastener length can be shortened. In addition, since the terminal portion 28a is not visible from the outside, the design is improved.

### Second Example

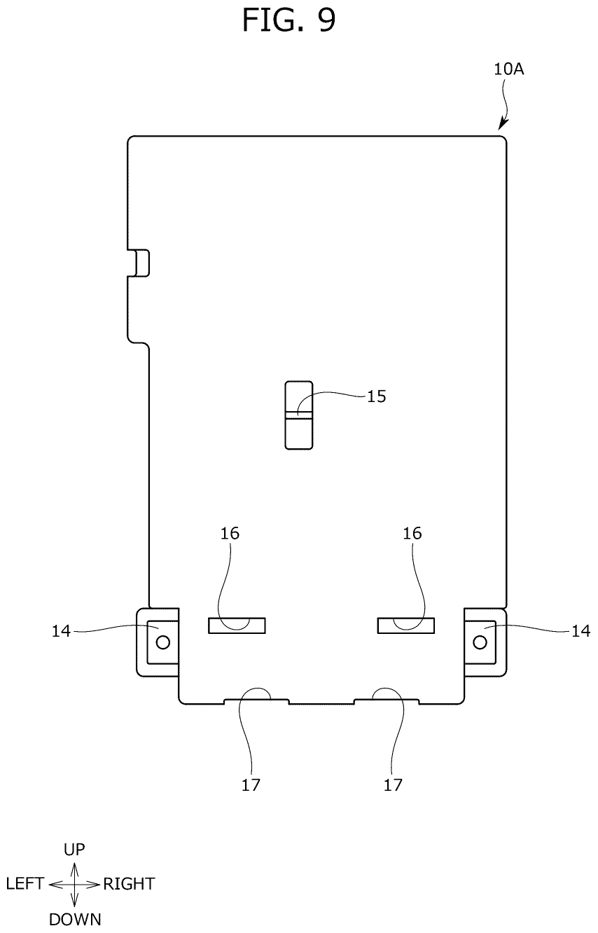

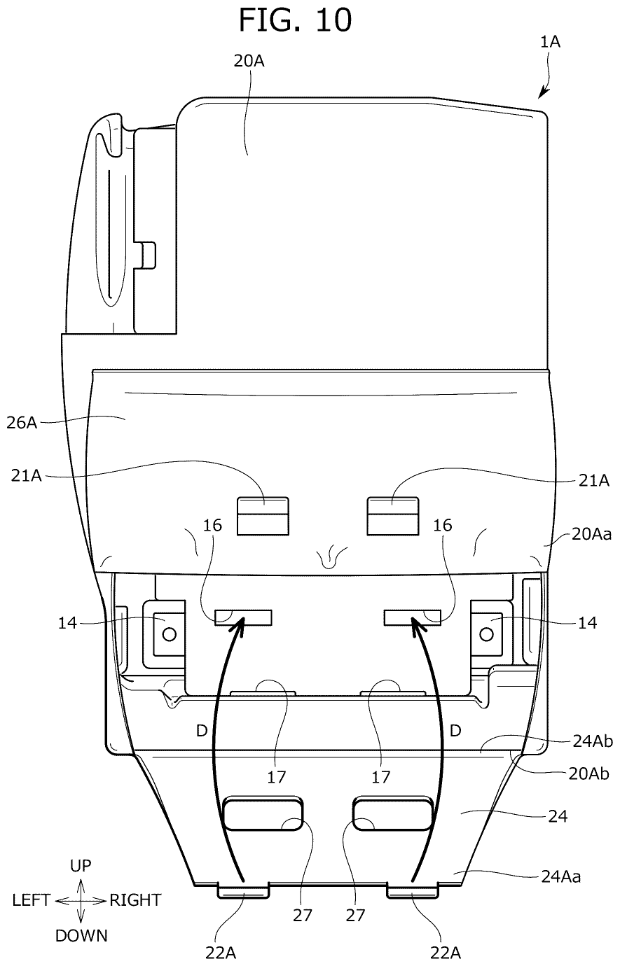

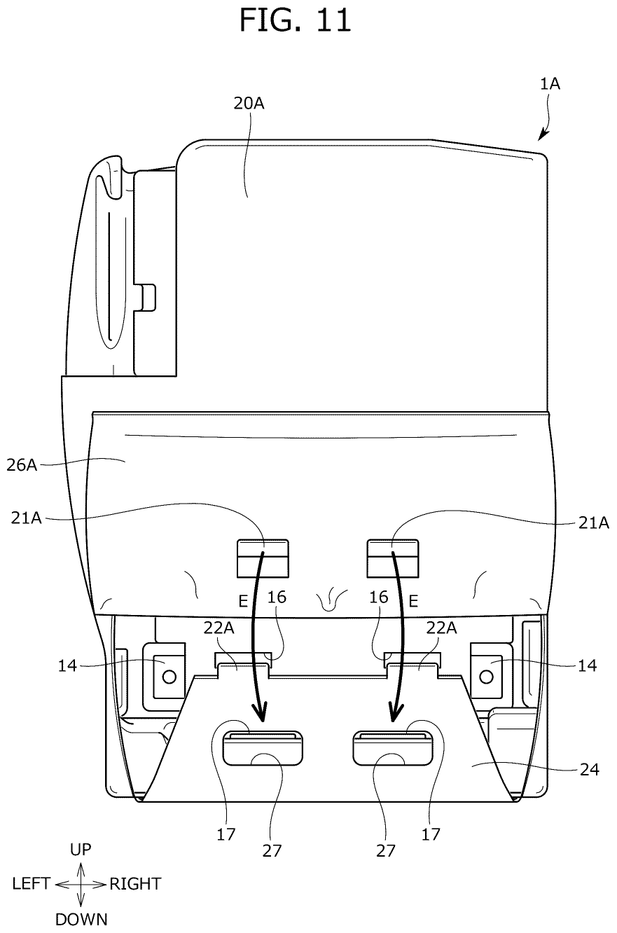

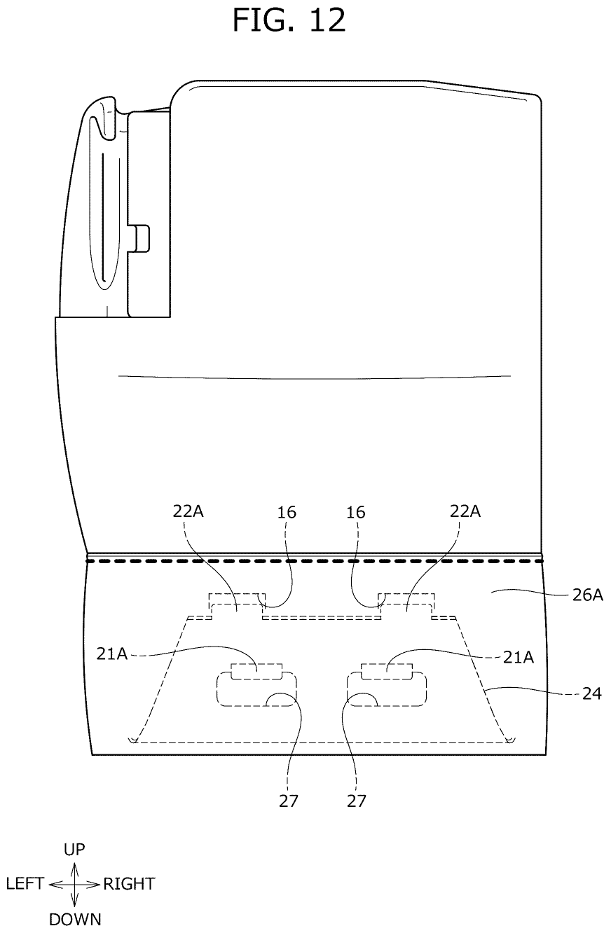

Next, a conveyance seat SA of a second example will be described with reference to FIGS. 9 to 12. FIG. 9 is a view showing a back frame 10A of the conveyance seat SA, and is a rear view showing a back surface of the back frame 10A. FIGS. 10 to 12 are description views for describing a procedure for attaching a skin material to the back frame 10A of the second example, and FIG. 10 is a view showing a state before a first engaging portion 21A and a second engaging portion 22A are engaged with a first hole portion 16 and a second hole portion 17. FIG. 11 is a view showing a state where the second engaging portion 22A is engaged with the first hole portion 16, and FIG. 12 is a view showing a state where the first engaging portion 21A is engaged with the second hole portion 17 and a hanging portion 26A is lowered.

The conveyance seat SA of the second example is different from the conveyance seat S of the first example in the positions of the hole portions formed in the back frame 10A or the positions where the first engaging portion and the second engaging portion hook onto the hole portions. Since the other configurations are the same, the other configurations are denoted by the same reference signs, and detailed descriptions will be omitted.

As shown in FIG. 9, the first hole portion 16 and the second hole portion 17 serving as engaged portions are formed in the back frame 10A. Two first hole portions 16 are formed side by side at a predetermined interval at positions overlapping the seat fixing portions 14 in the seat width direction. Two second hole portions 17 are formed side by side at a predetermined interval in the seat width direction at a lower end of the back frame 10A. The first hole portions 16 and the second hole portions 17 are hole portions formed in a rectangular shape in the back frame 10A.

A skin material 20A that covers the back frame 10A will be described. As shown in FIG. 10, the first engaging portions 21A that engage with the second hole portions 17 are provided at a first end portion 20Aa of the skin material 20A. In addition, the second engaging portions 22A that engage with the first hole portions 16 are provided at a second end portion 20Ab of the skin material 20A.

In more detail, a second extending portion 24A formed in a trapezoidal shape is provided at the second end portion 20Ab of the skin material 20A, and two second engaging portions 22A are provided at a predetermined interval at a tip 24Aa of the second extending portion 24A.

Two opening portions 27 are formed side by side in the second extending portion 24A in the seat width direction. The opening portions 27 are disposed at positions overlapping the second hole portions 17 when the second extending portion 24A is rotated as shown by arrow D in FIG. 10 and the second engaging portions 22A are engaged with the first hole portions 16 as shown in FIG. 11. By forming the opening portions 27 at positions overlapping the second hole portions 17, the first engaging portions 21A are movable as shown by arrow E in FIG. 11, and the first engaging portions 21A can be engaged with the second hole portions 17 through the opening portions 27 as shown in FIG. 12. With such a configuration, the skin material 20A can be attached to the back frame 10A. After the first engaging portions 21A are attached, the portions to which the skin material 20A is fixed are hidden by lowering the hanging portion 26A.

Incidentally, in the second example, the first engaging portions 21A and the second engaging portions 22A are configured as J-hooks; however, such a configuration is one example, and the first engaging portions 21A and the second engaging portions 22A may be configured as projections or through-holes. In that case, engaged portions may be configured as wires or projections depending on the first engaging portions and the second engaging portions.

In addition, in the present example, the two first hole portions 16 and the two second hole portions are formed, and the second engaging portions and the first engaging portions are engaged therewith; however, such a configuration is one example, and the number of the first hole portions 16 and the second hole portions may be one, or three or more first hole portions 16 and second hole portions may be provided.

The conveyance seat according to the present embodiment has been described above with reference to the drawings. In the above-described examples, the back frames 10 and 10A and the skin materials 20 and 20A used in the seat back 1 have been described as examples; however, such an application is one example, and the present invention may be applied to the seat cushion 2. For example, the first engaging portion and the second engaging portion may be provided in the skin material that covers the cushion pad and the cushion frame of the seat cushion 2, the hole portion may be formed in the cushion frame, and the skin material may be attached. The position where the first engaging portion and the second engaging portion are attached becomes clear, and attachment workability when the seat cushion is assembled is improved.

### Second Embodiment

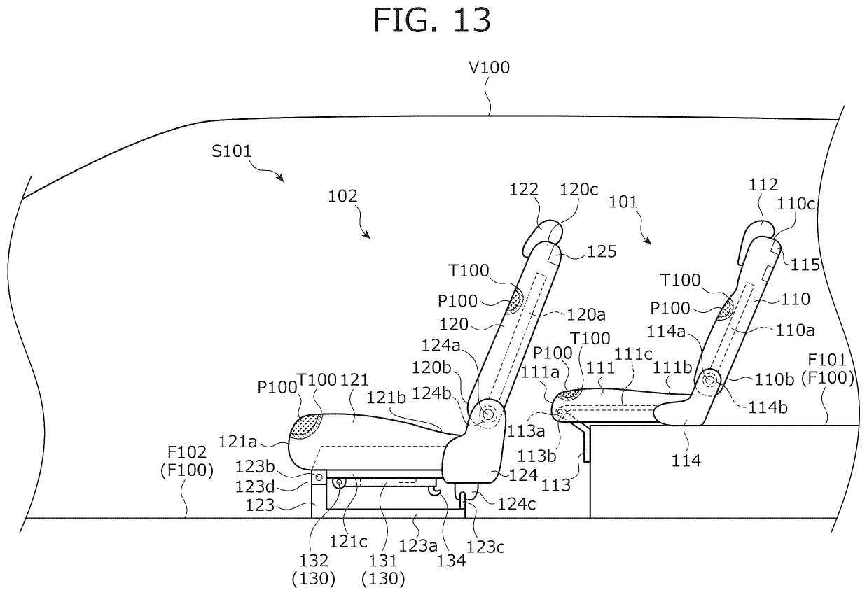

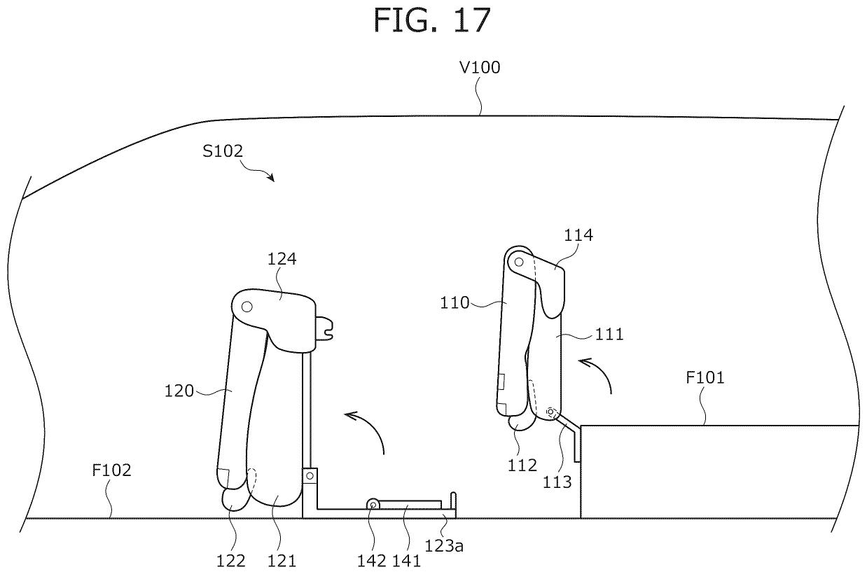

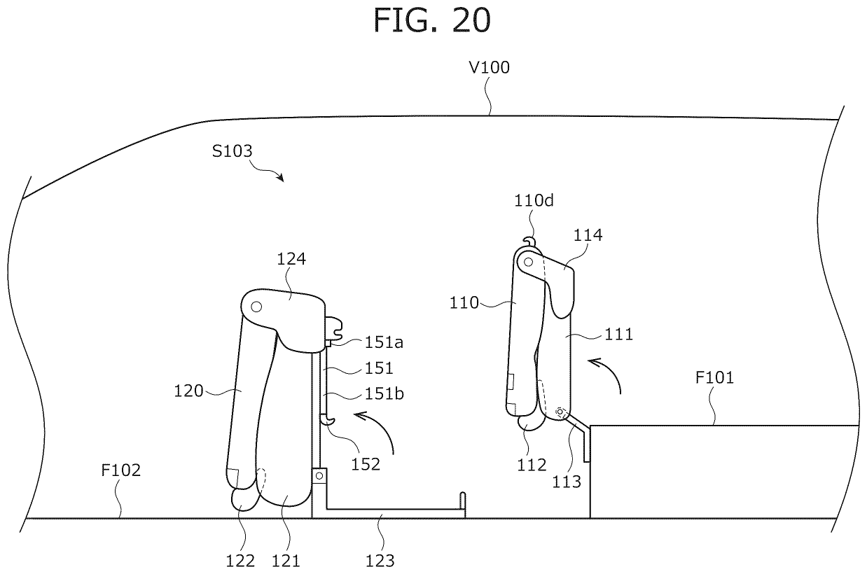

Hereinafter, a second embodiment of the present invention will be described with reference to FIGS. 13 to 25.

The second embodiment relates to a vehicle seat device and a vehicle, particularly to a vehicle seat device including a first vehicle seat and a second vehicle seat disposed in front of or behind the first vehicle seat in a vehicle front to rear direction, and a vehicle including the vehicle seat device.

### BACKGROUND ART

In recent years, as a vehicle seat, there has been known a dive-down seat in which a seat back and a seat cushion are folded to overlap each other, and the seat back and the seat cushion are moved downward and toward the front side and are stored.

For example, a vehicle seat disclosed in JP 2021-115871 A is a dive-down seat in which a seat back and a seat cushion are folded to overlap each other, are moved downward and toward the front side, and are stored. In more detail, the vehicle seat is attached to an upper step portion of a vehicle body floor, and is folded by rotating the seat cushion to become upright such that the seat back and the seat cushion overlap each other. Furthermore, the vehicle seat is stored on the lower step portion of the vehicle body floor by moving the seat back and the seat cushion downward and toward the front side.

In such a manner, the space inside a passenger compartment can be widened by storing the vehicle seat downward and toward the front side.

### SUMMARY OF INVENTION

### Technical Problem

However, in JP 2021-115871 A, the vehicle seat is not supported when the vehicle seat is in a stored state where the vehicle seat is moved downward and stored. For that reason, the vehicle seat moves further downward from the position in the stored state, and the vehicle seat comes off from the vehicle body floor, which is a risk.

In addition, when the vehicle seat to be stored is directly supported by the vehicle body floor, it is necessary to improve the support strength of the vehicle body floor. In addition, the vehicle seat cannot be also supported at an appropriate position, which is a risk.

The present invention has been made in view of the above-described problems, and an object of the present invention is to provide a vehicle seat device and a vehicle in which a stored vehicle seat can be supported with a simple configuration.

### Solution to Problem

The above-described problems are solved by a vehicle seat device and a vehicle including the vehicle seat device according to the present invention, the vehicle seat device including: a first vehicle seat; and a second vehicle seat disposed in front of or behind the first vehicle seat in a front to rear direction of a vehicle. The first vehicle seat includes a seat back and a seat cushion, and is switchable between a usage state where an occupant can be seated and a stored state where the seat back and the seat cushion are folded from the usage state to overlap each other, are moved downward while heading toward a second vehicle seat side, and are stored. The second vehicle seat includes a support member that supports the first vehicle seat. The support member is switchable between a stowed position where the support member is stowed on the second vehicle seat and a support position where the support member is deployed from the stowed position toward a first vehicle seat side to support the first vehicle seat. When the first vehicle seat is in the stored state, the support member supports the first vehicle seat so as to restrict a movement of the first vehicle seat by switching from the stowed position to the support position.

With the above-described configuration, it is possible to realize the vehicle seat device and the vehicle in which a stored vehicle seat can be supported with a simple configuration.

In detail, since the support member of the second vehicle seat supports the first vehicle seat, the movement of the second vehicle seat further downward from the stored state can be suppressed. Particularly, since the support member is provided in the second vehicle seat, the first vehicle seat can be supported at an appropriate position with a simple configuration without adding a member for improving support strength to the vehicle body floor.

In this case, it is preferable that the second vehicle seat includes a seat cushion, that the support member is attached to the seat cushion of the second vehicle seat, and that the support member is stowed on the seat cushion of the second vehicle seat when the support member is in the stowed position, and is deployed from the stowed position toward the first vehicle seat side to switch to the support position.

With the above-described configuration, since the support member is provided on the seat cushion of the second vehicle seat, the support member can be easily deployed. For that reason, when the first vehicle seat is moved to the stored state, the first vehicle seat can be supported with a simple configuration.

In this case, it is preferable that the second vehicle seat includes a seat body including a seat back and a seat cushion, and a foot member that is attached to the vehicle and that supports the seat body, that the support member is attached to the foot member of the second vehicle seat, and that the support member is stowed on the foot member when the support member is in the stowed position, and is deployed from the stowed position toward the first vehicle seat side to switch to the support position.

With the above-described configuration, since the support member is provided on the foot member of the second vehicle seat, the support member can be easily deployed. For that reason, when the first vehicle seat is moved to the stored state, the first vehicle seat can be supported with a simple configuration.

In this case, it is preferable that the second vehicle seat includes a seat body including a seat back and a seat cushion, that the support member is a string-shaped member, that one end portion of the support member is fixed to the seat body of the second vehicle seat, that an engaging portion for detachably engaging with an engaged portion provided in the first vehicle seat is provided at the other end portion of the support member, and that when the first vehicle seat is in the stored state, the engaging portion of the support member engages with the engaged portion of the first vehicle seat, so that the support member supports the first vehicle seat from above.

With the above-described configuration, since the support member is a string-shaped member, when the first vehicle seat is moved to the stored state, the first vehicle seat can be supported with a simpler configuration.

In this case, it is preferable that the support member is a plate-shaped member having a support surface, and supports the first vehicle seat from below via the support surface when the first vehicle seat is in the stored state.

With the above-described configuration, since the support member is a plate-shaped member, when the first vehicle seat is moved to the stored state, the first vehicle seat can be supported with a simpler configuration. In addition, when the first vehicle seat is in the usage state, the support member can be used as a table or a footrest.

In this case, it is preferable that a recess or a hole portion for storing an item to be stored is formed on the support surface.

With the above-described configuration, when the first vehicle seat is in the usage state, the support member can be used as a tray that stores an item to be stored such as a small item and a cup.

In this case, it is preferable that a hook portion for hooking luggage is formed at a tip portion of the support member.

With the above-described configuration, when the first vehicle seat is in the usage state, the support member can be used as a hook for hooking and holding luggage such as a sack.

In this case, it is preferable that the second vehicle seat includes a seat back and a seat cushion, is disposed in front of the first vehicle seat in the front to rear direction of the vehicle, and is switchable between a normal state where the occupant can be seated and a tumble state where the seat back is folded from the normal state to overlap the seat cushion and a rear end portion of the seat cushion is rotated toward a front side while being flipped and becomes upright.

With the above-described configuration, since a rear seat can be stored forward in a state where a front seat is upright in the tumble state, the space inside a passenger compartment can be further widened.

In this case, it is preferable that the first vehicle seat is disposed behind the second vehicle seat in the front to rear direction of the vehicle, and is switchable between the usage state and the stored state where the seat back is folded from the usage state to overlap the seat cushion, a rear end portion of the seat cushion is rotated toward a front side while being flipped, and the seat cushion is overlapped on the seat back.

With the above-described configuration, since the rear seat can be inverted and stored in a state where the seat back is disposed below the seat cushion, the space inside the passenger compartment can be further widened.

In this case, it is preferable that the first vehicle seat is disposed behind the second vehicle seat in the front to rear direction of the vehicle, and is switchable between the usage state and the stored state where the seat back and the seat cushion are folded from the usage state to overlap each other, are moved downward while heading forward in the folded posture, and are stored.

With the above-described configuration, since the seat back of the rear seat is tilted forward and folded and translated in the folded posture, the rear seat can be stored with a simple configuration.

### Advantageous Effects of Invention

According to the present invention, it is possible to realize the vehicle seat device and the vehicle in which a stored vehicle seat can be supported with a simple configuration.

In addition, according to the present invention, when the first vehicle seat is moved to the stored state, the first vehicle seat can be supported with a simple configuration.

In addition, according to the present invention, when the first vehicle seat is moved to the stored state, the first vehicle seat can be supported with a simpler configuration.

In addition, according to the present invention, when the first vehicle seat is in the usage state, the support member can be used as a table or a footrest.

In addition, according to the present invention, when the first vehicle seat is in the usage state, the support member can be used as a tray that stores an item such as a small item and a cup.

In addition, according to the present invention, when the first vehicle seat is in the usage state, the support member can be used as a hook for hooking and holding an item such as a sack.

In addition, according to the present invention, the space inside the passenger compartment can be further widened.

In addition, according to the present invention, the rear seat can be stored with a simple structure.

### DESCRIPTION OF EMBODIMENTS

### First Example

A vehicle V100 of a first example according to the second embodiment will be described with reference to FIGS. 13 to 15.

The vehicle V100 of the first example includes a vehicle seat device S101. As shown in FIG. 13, the vehicle seat device S101 includes, for example, a plurality of vehicle seats disposed side by side in a front to rear direction.

Incidentally, the vehicle seat may be, for example, a seat installed in a ship, an aircraft, or the like.

Incidentally, in the following description, the “front to rear direction” is a front to rear direction of the vehicle seat, and is a direction coinciding with a traveling direction when the vehicle V100 travels. In addition, the “seat width direction” is a width direction of the vehicle seat, and is a direction coinciding with a right to left direction when viewed from an occupant (seated occupant) seated in the vehicle seat. In addition, the “up to down direction” is an up to down direction of the vehicle seat, and is a direction coinciding with a vertical direction when the vehicle V100 travels on a horizontal surface.

### <<Configuration of Vehicle Seat Device>>

As shown in FIG. 13, the vehicle seat device S101 includes a rear seat 101 (first vehicle seat) disposed on a rear side in the front to rear direction of the vehicle V100, and a front seat 102 (second vehicle seat) disposed in front of the rear seat 101. Incidentally, the number of vehicle seats is not limited thereto, and the vehicle may include, for example, a front seat, a middle seat, and a rear seat as in a three-row seat arrangement.

As shown in FIG. 13, a step is formed on a vehicle body floor F100 of the vehicle V100. An upper step portion F101 is formed on the rear side of the vehicle V100, and a lower step portion F102 is formed on a front side of the vehicle V100. The rear seat 101 is disposed on the upper step portion F101 of the vehicle body floor F100, and the front seat 102 is disposed on the lower step portion F102 of the vehicle body floor F100.

Incidentally, the vehicle body floor F100 on which the vehicle seats are disposed may be a flat floor on which no step is formed.

### <<Rear Seat (First Vehicle Seat)>>

The rear seat 101 includes a seat body including a seat back 110, a seat cushion 111, and a headrest 112; a base member 113 for attaching the seat body to the vehicle body floor F100; a rotation lock member 114 that rotatably connects the seat back 110 to the seat cushion 111; and an operating portion 115 that releases the lock of the rotation lock member 114.

Incidentally, a pair of the base members 113 are provided in the seat width direction, and are disposed on both respective end portion sides of the seat back 110 and the seat cushion 111.

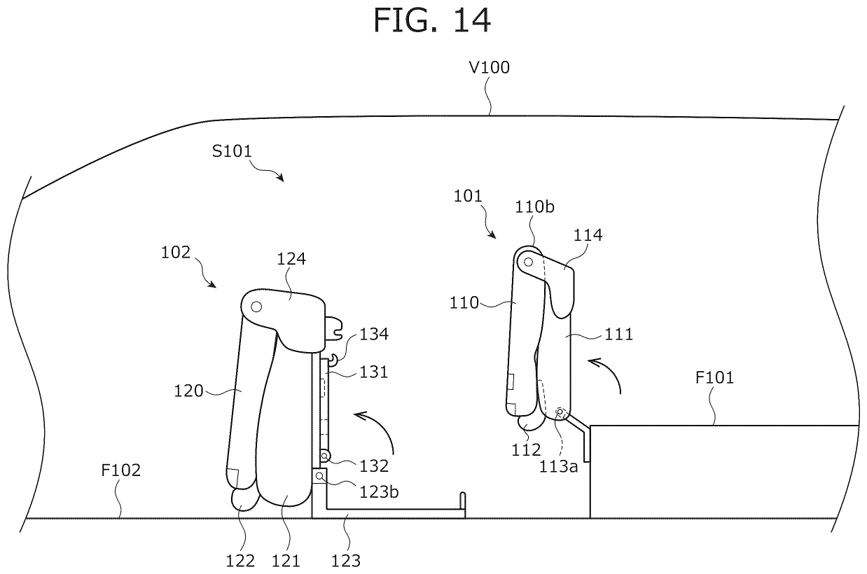

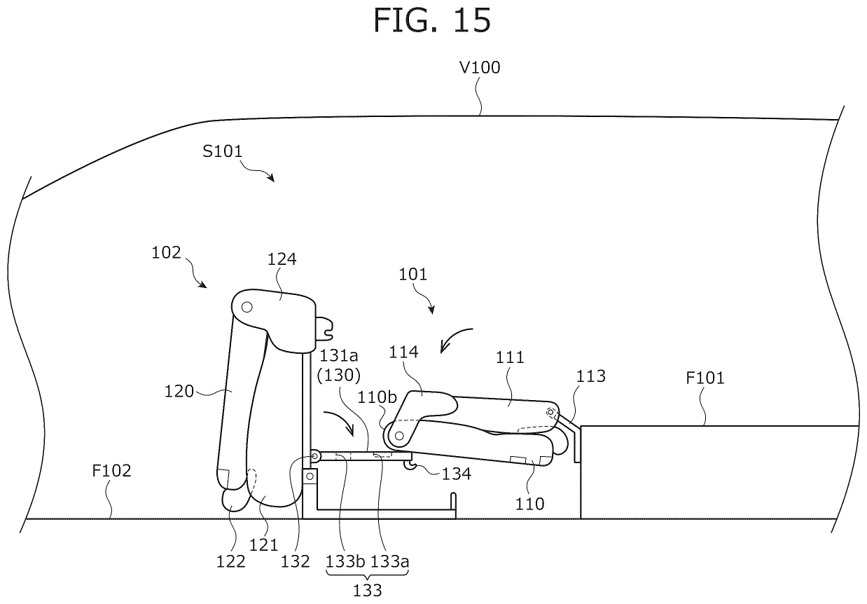

The rear seat 101 is switchable between a usage state shown in FIG. 13, an upright state shown in FIG. 14, and a stored state shown in FIG. 15.

As shown in FIG. 13, the usage state is a state where the occupant can be seated, and is a state where the seat back 110 is in an upright position.

As shown in FIG. 14, the upright state is a state where the seat back 110 is tilted forward and folded from the usage state to overlap the seat cushion 111 and a rear end portion 111b of the seat cushion 111 is rotated upward about a front end portion 111a of the seat cushion 111 to become upright.

As shown in FIG. 15, the stored state is a state where the seat back 110 and the seat cushion 111 are folded from the upright state to overlap each other, the rear end portion 111b of the seat cushion 111 is rotated further forward about the front end portion 111a of the seat cushion 111, and the seat back 110 and the seat cushion 111 are moved downward while heading forward and are stored on a lower step portion F102 side of the vehicle body floor F100.

In other words, the stored state is a state where the seat back 110 and the seat cushion 111 are folded from the usage state to overlap each other, are moved downward while heading toward a front seat 102 side, and are stored.

The seat back 110 is a backrest portion that supports the back of the seated occupant from the rear, and is configured by placing a pad material P100 on a back frame 110a serving as a skeleton, and covering the pad material P100 and the back frame 110a with a skin material T100.

The seat cushion 111 is a seating portion that supports the seated occupant from below, and is configured by placing the pad material P100 on a cushion frame 111c serving as a skeleton, and covering the pad material P100 and the cushion frame 111c with the skin material T100.

The headrest 112 is a head portion that supports the head of the seated occupant from the rear, and is configured by placing a pad material on a headrest pillar (not illustrated) serving as a core, and covering the pad material and the headrest pillar with a skin material.

As shown in FIG. 13, the base member 113 is fixed to the upper step portion F101 of the vehicle body floor F100, and rotatably supports the cushion frame 111c of the seat cushion 111. Specifically, the base member 113 is fixed to an upper portion of a front portion of the upper step portion F101. A rotating shaft 113a is provided at an upper end portion of the base member 113.

The base member 113 is connected to the cushion frame 111c via the rotating shaft 113a. The occupant can switch the seat body between the usage state and the stored state by inverting the seat body around the rotating shaft 113a of the base member 113.

Incidentally, the base member 113 includes a lock mechanism (not illustrated) for maintaining the rear seat 101 in each of the usage state, the upright state, and the stored state.

The base member 113 is provided with a biasing mechanism 113b that assists in the switching operation of the seat body between the usage state and the stored state.

When the seat body is rotated from the usage state to the upright state, the biasing mechanism 113b assists in the rotational operation of the seat body against the weight of the seat body. When the seat body is rotated from the upright state to the stored state, the biasing mechanism 113b applies a resistance force to the seat body to cause the seat body to slowly rotate to the stored state.

In addition, when the seat body is rotated from the stored state to the usage state, the biasing mechanism 113b assists in the rotational operation against the weight of the seat body. When the seat body is rotated from the upright state to the usage state, the biasing mechanism 113b applies a resistance force to the seat body to cause the seat body to slowly rotate to the usage state.

The rotation lock member 114 rotatably connects a lower end portion 110b of the seat back 110 and the rear end portion 111b of the seat cushion 111. The seat back 110 is tilted forward about a tilt shaft 114a of the rotation lock member 114 with respect to the seat cushion 111 to overlap the seat cushion 111. The rotation lock member 114 includes a lock mechanism 114b thereinside.

The rotation lock member 114 switches the seat back 110 between an upright position where the seat back 110 is upright with respect to the seat cushion 111 and a forward tilted position where the seat back 110 overlaps the seat cushion 111. The seat back 110 is restricted in the rotational operation by the lock mechanism 114b, and is locked in the upright position or the forward tilted position. Incidentally, the seat back 110 may be locked in a position other than the upright position or the forward tilted position.

The operating portion 115 is an operating lever for releasing the lock of the rotation lock member 114, and is provided at an upper end portion 110c of the seat back 110.

When the occupant operates the operating portion 115, the lock mechanism 114b transitions from a locked state to an unlocked state. Furthermore, when the lock mechanism 114b transitions to the unlocked state, the seat back 110 is rotatable in a forward tilting direction. The degree of recline of the seat back 110 (angle formed by the seat back 110 and the seat cushion 111) is changed by the rotational operation of the seat back 110.

Incidentally, in the first example, the seat back 110 is rotated to tilt forward, but may be rotated to tilt rearward.

In addition, in the first example, as the seat back 110 is tilted forward and folded, the rear seat 101 switches from the usage state to the stored state; however, the rear seat 101 may be configured to switch from the usage state to the stored state as the seat cushion 111 flips rearward.

### <<Front Seat (Second Vehicle Seat)>>

The front seat 102 includes a seat body including a seat back 120, a seat cushion 121, and a headrest 122; a foot member 123 for attaching the seat body to the vehicle body floor F100; a rotation lock member 124 that rotatably connects the seat back 120 to the seat cushion 121; an operating portion 125 that releases the lock of the rotation lock member 124; and a support member 130 that supports the rear seat 101.

The front seat 102 is switchable between a normal state shown in FIG. 13 and a tumble state shown in FIG. 14.

As shown in FIG. 13, the normal state is a state where the occupant can be seated, and is a state where the seat back 120 is in an upright position.

As shown in FIGS. 14 and 15, the tumble state is a state where the seat back 120 is tilted forward and folded from the normal state to overlap the seat cushion 121 and a rear end portion 121b of the seat cushion 121 is rotated upward about a front end portion 121a of the seat cushion 121 to become upright.

The seat back 120 is a backrest portion that supports the back of the seated occupant from the rear, and is configured by placing the pad material P100 on a back frame 120a serving as a skeleton, and covering the pad material P100 and the back frame 120a with the skin material T100.

The seat cushion 121 is a seating portion that supports the seated occupant from below, and is configured by placing the pad material P100 on a cushion frame 121c serving as a skeleton, and covering the pad material P100 and the cushion frame 121c with the skin material T100.

The headrest 122 is a head portion that supports the head of the seated occupant from the rear, and is configured by placing a pad material on a headrest pillar (not illustrated) serving as a core, and covering the pad material and the headrest pillar with a skin material.

As shown in FIG. 13, the foot member 123 is fixed to the lower step portion F102 of the vehicle body floor F100, and rotatably supports the cushion frame 121c of the seat cushion 121. The foot member 123 is fixed onto the lower step portion F102 by a pair of leg portions 123a provided in the seat width direction. A support shaft 123b is provided at an upper end portion on the front side of the foot member 123. A holding portion 123c that holds a held portion 124c provided at a lower end portion of the rotation lock member 124 is provided at an upper end portion on the rear side of the foot member 123.

The foot member 123 is connected to the cushion frame 121c via the support shaft 123b. For that reason, the foot member 123 allows the seat body to be switched between the normal state and the tumble state by causing the seat body to flip around the support shaft 123b.

Incidentally, the foot member 123 is provided with a biasing mechanism 123d that assists in the switching operation of the seat body between the normal state and the tumble state.

When the seat body is rotated from the normal state to the tumble state, the biasing mechanism 123d assists in the rotational operation of the seat body against the weight of the seat body.

In addition, when the seat body is rotated from the tumble state to the normal state, the biasing mechanism 123d applies a resistance force to the seat body to cause the seat body to slowly rotate to the normal state.

The rotation lock member 124 rotatably connects a lower end portion 120b of the seat back 120 and the rear end portion 121b of the seat cushion 121. The seat back 120 is tilted forward about a tilt shaft 124a of the rotation lock member 124 with respect to the seat cushion 121 to overlap the seat cushion 121. The rotation lock member 124 includes a lock mechanism 124b thereinside. In addition, the held portion 124c that is held by the holding portion 123c is formed at the lower end portion of the rotation lock member 124.

The rotation lock member 124 switches the seat back 120 between an upright position where the seat back 120 is upright with respect to the seat cushion 121 and a forward tilted position where the seat back 120 overlaps the seat cushion 121. The seat back 120 is restricted in the rotational operation by the lock mechanism 124b, and is locked in the upright position or the forward tilted position. Incidentally, the seat back 120 may be locked in a position other than the upright position or the forward tilted position.

The operating portion 125 is an operating lever for releasing the lock of the rotation lock member 124, and is provided at an upper end portion 120c of the seat back 120.

When the occupant operates the operating portion 125, the lock mechanism 124b transitions from a locked state to an unlocked state. Then, when the lock mechanism 124b transitions to the unlocked state, the seat back 120 is rotatable in a forward tilting direction. The degree of recline of the seat back 120 (angle formed by the seat back 120 and the seat cushion 121) is changed by the rotational operation of the seat back 120.

Incidentally, in the first example, the seat back 120 is rotated to tilt forward, but may be rotated to tilt rearward.

In addition, in the first example, as the seat back 120 is tilted forward and folded, the front seat 102 switches from the normal state to the tumble state; however, the front seat 102 may be configured to switch from the normal state to the tumble state as the seat cushion 121 flips rearward.

As shown in FIGS. 13 to 15, the support member 130 is switchable between a stowed position where the support member 130 is stowed on the front seat 102 and a support position where the support member 130 is deployed rearward from the stowed position toward a rear seat 101 side to support the rear seat 101.

The stowed position shown in FIG. 13 is a position where the support member 130 is stowed below the seat cushion 121 when the front seat 102 is in the normal state. The support position shown in FIG. 15 is a position where the support member 130 supports the rear seat 101 from below when the front seat 102 is in the tumble state and the rear seat 101 is in the stored state.

The support member 130 is attached to the seat cushion 121 of the front seat 102, and supports the rear seat 101 so as to restrict the movement of the rear seat 101 by switching from the stowed position to the support position when the rear seat 101 is in the stored state. In other words, when the rear seat 101 is in the stored state, the rear seat 101 is supported from below by the support member 130. For that reason, the movement of the rear seat 101 further downward from the stored state can be suppressed.

As shown in FIG. 13, the support member 130 includes a plate-shaped member 131 having a support surface 311a; a rotating shaft 132 that rotatably attaches the plate-shaped member 131 to the cushion frame 121c; a storage portion 133 for storing an item to be stored; and a hook portion 134 for hooking luggage.

The plate-shaped member 131 is, for example, a table having the support surface 131a, and is rotatably attached to the cushion frame 121c by the rotating shaft 132. The support member 130 is deployed by the occupant when the rear seat 101 is in the stored state, and supports the rear seat 101 from below via the support surface 131a.

The plate-shaped member 131 is switched from the stowed position to the support position by rotating downward and rearward via the rotating shaft 132. When the plate-shaped member 131 is rotated downward to switch to the support position, the rotation angle of the plate-shaped member 131 in the support position is restricted.

Incidentally, the plate-shaped member 131 is rotated downward and rearward by the rotating shaft 132, but may be rotated upward and rearward to switch to the support position. In this case, it is preferable that a lock mechanism for restricting the rotation angle in the support position is provided.

The storage portion 133 is formed on the support surface 131a to store an item to be stored such as a small item or a cup. For example, a recess 133a for storing a small item and a hole portion 133b for storing a cup are formed in the plate-shaped member 131.

The hook portion 134 is formed at a tip portion of the plate-shaped member 131 to hook luggage such as a bag or a sack. For example, the hook portion 134, the recess 133a for storing a small item, and the hole portion 133b for storing a cup are formed in the plate-shaped member 131.

When the rear seat 101 is in the usage state, the occupant can use the support member 130 as a table by deploying the support member 130 rearward. In addition, since the recess 133a, the hole portion 133b, and the hook portion 134 are formed in the plate-shaped member 131, occupant's belongings such as a small item, a cup, and luggage can be stored.

Incidentally, the support member 130 may be used as a footrest for an occupant who is seated in the rear seat 101 when the rear seat 101 is in the usage state.

In such a manner, by providing the support member 130 for supporting the rear seat 101 on the front seat 102, the movement of the rear seat 101 further downward from the stored state can be suppressed. Particularly, since the support member 130 is provided in the front seat 102, the rear seat 101 can be supported with a simple configuration without changing the design of the vehicle body floor F100.

Incidentally, in the present embodiment, the configuration in which the rear seat 101 is stored downward and forward and the rear seat 101 is supported by the support member 130 of the front seat 102 is adopted. However, the present invention is not limited to the configuration, and a configuration in which a support member is provided in the rear seat 101, the front seat 102 is stored downward and rearward, and the front seat 102 is supported by the support member of the rear seat 101 may be adopted.

In addition, in the present embodiment, the configuration in which the seat back 110 of the rear seat 101 is tilted forward and folded to overlap the seat cushion 111 is adopted. However, the present invention is not limited to the configuration, and a configuration in which the seat cushion 111 is flipped rearward and folded to overlap the seat back 110 may be adopted.

Further, in the present embodiment, the configuration in which the front seat 102 is switchable between the normal state and the tumble state is adopted. However, the present invention is not limited to the configuration, and a configuration in which, similarly to the rear seat 101, the front seat 102 is rotated further forward from the tumble state, is moved downward while heading forward, and is stored on the lower step portion F102 side of the vehicle body floor F100 may be adopted.

### Second Example

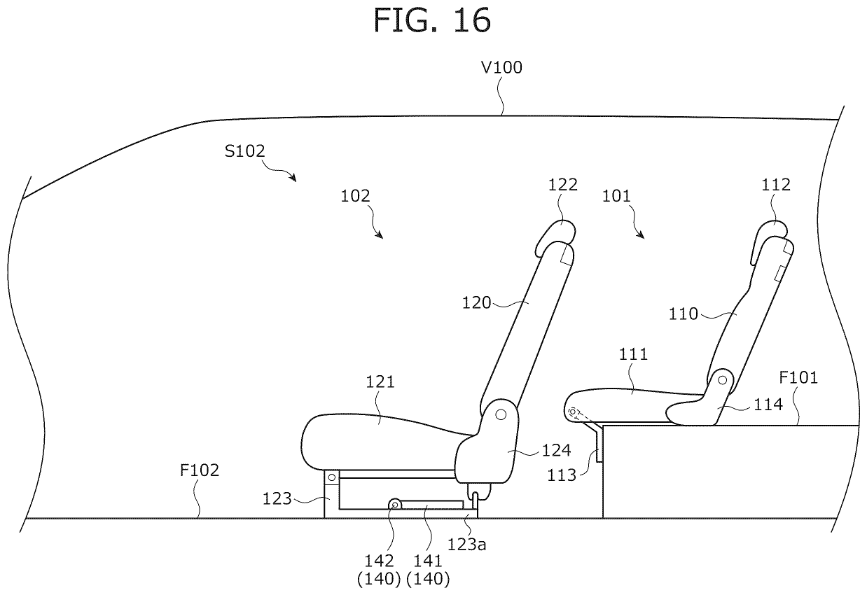

Next, a vehicle seat device S102 of the vehicle V100, which is a second example of the present embodiment, will be described based on FIGS. 16 to 18.

Incidentally, the description of contents that overlap with those of the vehicle seat device S101 described above will be omitted.

The vehicle seat device S102 of the second example is different from the vehicle seat device S101 mainly in a configuration of a support member 140.

As shown in FIGS. 16 to 18, the support member 140 is switchable between a stowed position where the support member 140 is stowed on the front seat 102 and a support position where the support member 140 is deployed forward from the stowed position toward the rear seat 101 side to support the rear seat 101.

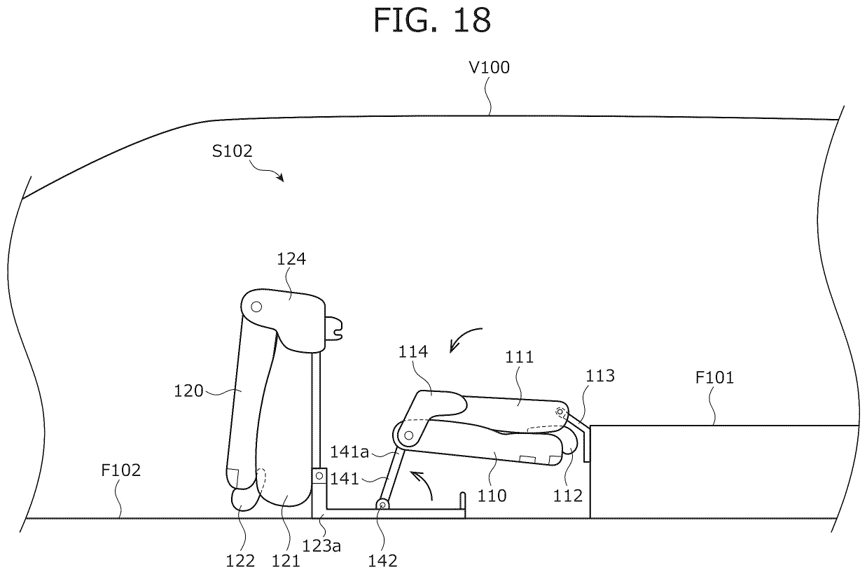

The stowed position shown in FIG. 16 is a position where the support member 140 is stowed below the seat cushion 121 when the front seat 102 is in the normal state, and is a position where the support member 140 is attached to the foot member 123 to extend along the front to rear direction in which the foot member 123 extends. The support position shown in FIG. 18 is a position where the support member 140 supports the rear seat 101 from below when the front seat 102 is in the tumble state and the rear seat 101 is in the stored state.

The support member 140 is attached to the foot member 123 of the front seat 102, and supports the rear seat 101 so as to restrict the movement of the rear seat 101 by switching from the stowed position to the support position when the rear seat 101 is in the stored state. In other words, when the rear seat 101 is in the stored state, the rear seat 101 is supported from below by the support member 140. For that reason, the movement of the rear seat 101 further downward from the stored state can be suppressed.

As shown in FIG. 16, the support member 140 includes a pipe member 141 including a support portion 141a, and a pipe rotating shaft 142 that rotatably attaches the pipe member 141 to the foot member 123.

Incidentally, the support member 140 is not limited to being the pipe member 141 having a rod shape, and may be a plate-shaped member (for example, a footrest).

The pipe member 141 is a rod-shaped member that is bent into an inverted U-shape when viewed from the front, and that includes the support portion 141a. The pipe member 141 is rotatably attached to the pair of leg portions 123a by the pipe rotating shaft 142. The support member 140 is deployed by the occupant when the rear seat 101 is in the stored state, and supports the rear seat 101 from below via the support portion 141a.

The pipe rotating shaft 142 is switched from the stowed position to the support position to rotate the pipe member 141 upward and forward. Incidentally, the pipe rotating shaft 142 includes a lock mechanism (not illustrated) for restricting the rotation angle in the support position.

In such a manner, since the support member 140 is attached to the foot member 123 of the front seat 102, space can be saved when the support member 140 is stowed. In addition, since the support member 140 is formed in a rod shape, space can be further saved when the support member 140 is stowed.

### Third Example

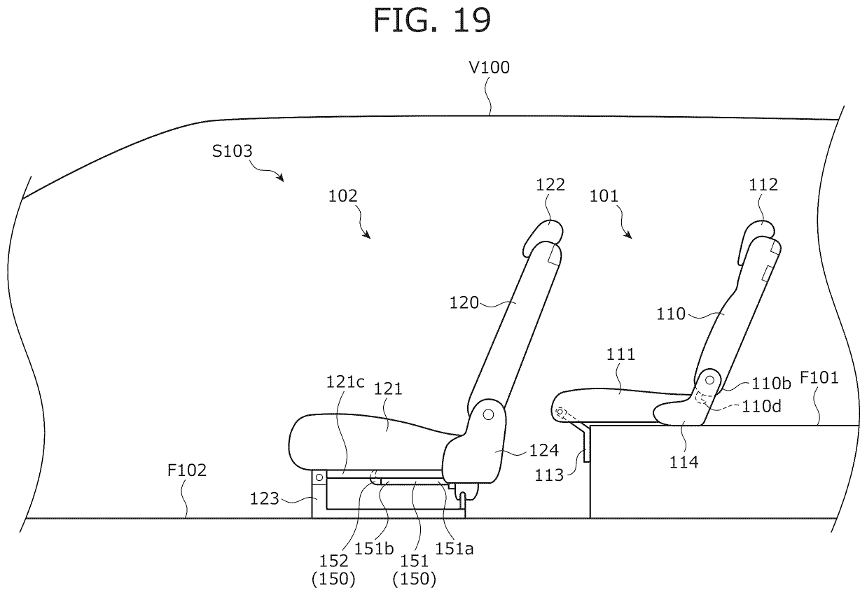

Next, a vehicle seat device S103 of the vehicle V100 of a third example will be described based on FIGS. 19 to 21.

Incidentally, the description of contents that overlap with those of the vehicle seat devices S101 and S102 described above will be omitted.

The vehicle seat device S103 of the third example is different from the vehicle seat devices S101 and S102 mainly in a configuration of a support member 150.

As shown in FIGS. 19 to 21, the support member 150 is switchable between a stowed position where the support member 150 is stowed on the front seat 102 and a support position where the support member 150 is deployed rearward from the stowed position toward the rear seat 101 side to support the rear seat 101.

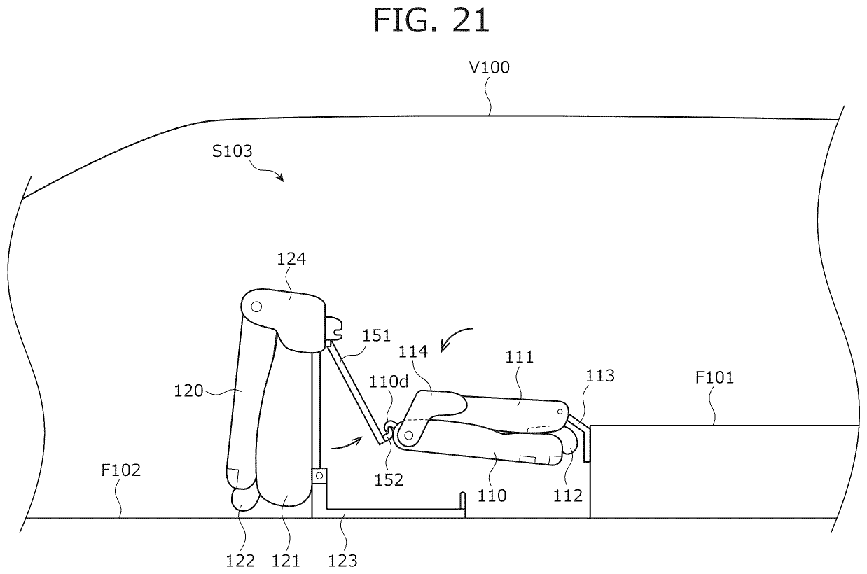

The stowed position shown in FIG. 19 is a position where the support member 150 is stowed below the seat cushion 121 when the front seat 102 is in the normal state. The support position shown in FIG. 21 is a position where the support member 150 supports the rear seat 101 from below when the front seat 102 is in the tumble state and the rear seat 101 is in the stored state.

The support member 150 is attached to the seat cushion 121 of the front seat 102, and supports the rear seat 101 so as to restrict the movement of the rear seat 101 by switching from the stowed position to the support position when the rear seat 101 is in the stored state. In other words, when the rear seat 101 is in the stored state, the rear seat 101 is supported from above by the support member 150. For that reason, the movement of the rear seat 101 further downward from the stored state can be suppressed.

As shown in FIG. 19, the support member 150 includes a string-shaped member 151 and an engaging portion 152 for engaging with the rear seat 101.

The string-shaped member 151 is, for example, a sling or a wire. When the front seat 102 is in the normal state, one end portion 151a of the string-shaped member 151 is fixed to a lower surface of the rear side of the seat cushion 121. The engaging portion 152 is provided at the other end portion 151b of the string-shaped member 151.

The engaging portion 152 is provided at the other end portion 151b of the string-shaped member 151, and is detachably attached to a lower surface of the front side of the seat cushion 121. As shown in FIG. 19, when the front seat 102 is in the normal state, the engaging portion 152 is detachably attached to the lower surface of the front side of the seat cushion 121.

As shown in FIG. 21, when the front seat 102 is in the tumble state, and the rear seat 101 is in the stored state, the one end portion 151a of the string-shaped member 151 is located above an engaged portion 110d of the rear seat 101, and is fixed to a rear surface of the front seat 102 (lower surface of the seat cushion 121). In addition, when the front seat 102 is in the tumble state, and the rear seat 101 is in the stored state, the engaging portion 152 provided at the other end portion 151b of the string-shaped member 151 is detachably attached to the rear surface of the front seat 102.

The engaging portion 152 of the support member 150 is detached from the seat cushion 121, is deployed rearward, and engages with the engaged portion 110d provided at the lower end portion (front end portion when the rear seat 101 is in the stored state) of the seat back 110 of the rear seat 101.

Therefore, the support member 150 is deployed by the occupant when the rear seat 101 is in the stored state, and supports the rear seat 101 from above via the engaging portion 152.

In such a manner, since the support member 150 is attached to the seat cushion 121 of the front seat 102, space can be saved when the support member 150 is stowed. In addition, since the support member 150 is formed in a string shape, the rear seat 101 can be supported with a simple configuration. Incidentally, the support member 140 is not limited to having a string shape, and may have a rod shape.

### Fourth Example

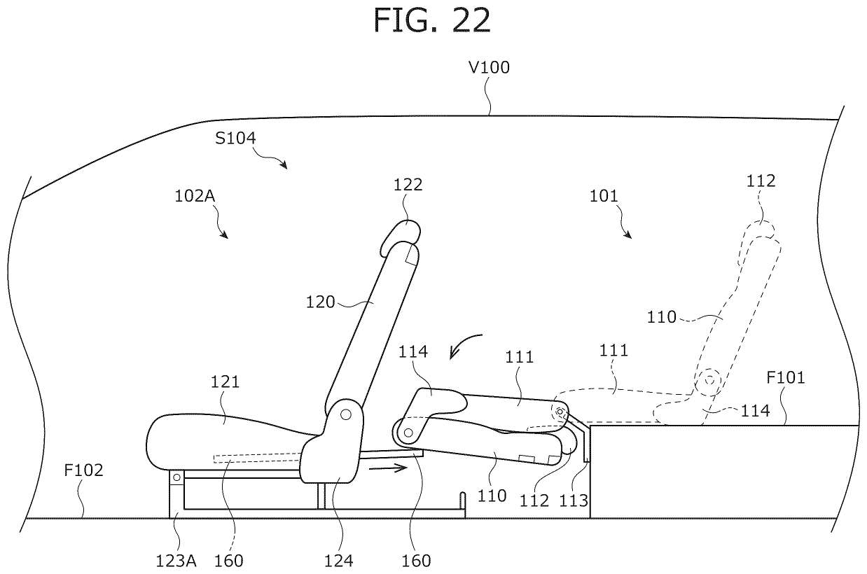

Next, a vehicle seat device S104 of the vehicle V100 of a fourth example will be described based on FIG. 22.

Incidentally, the description of contents that overlap with those of the vehicle seat devices S101 to S103 described above will be omitted.

The vehicle seat device S104 of the fourth example is different from the vehicle seat devices S101 to S103 mainly in configurations of a front seat 102A and a support member 160.

The front seat 102A includes the seat body including the seat back 120, the seat cushion 121, and the headrest 122; a foot member 123A for attaching the seat body to the vehicle body floor F100; and the support member 160 that supports the rear seat 101.

Incidentally, the front seat 102A is fixed to the vehicle body floor F100 by the foot member 123A. However, the present invention is not limited thereto, and the front seat 102A may be switchable to the tumble state.

The support member 160 is switchable between a stowed position where the support member 160 is stowed on the front seat 102A (illustrated by a dashed line in FIG. 22) and a support position where the support member 160 is deployed rearward from the stowed position toward the rear seat 101 side to support the rear seat 101.

The stowed position is a position where the support member 160 is stowed inside the seat cushion 121. The support position is a position where the support member 160 is moved in a sliding manner rearward from the front seat 102A with respect to the seat cushion 121, and supports the rear seat 101 from below when the rear seat 101 is in the stored state.

The support member 160 is, for example, a plate-shaped table member, and is attached to the seat cushion 121 of the front seat 102A. Incidentally, the support member 160 includes a lock mechanism (not illustrated) for restricting the sliding position in the support position.

When the rear seat 101 is in the stored state, the support member 160 is deployed by the occupant to switch from the stowed position to the support position, thereby supporting the rear seat 101 so as to restrict the movement of the rear seat 101. In other words, when the rear seat 101 is in the stored state, the rear seat 101 is supported from below by the support member 160. For that reason, the movement of the rear seat 101 further downward from the stored state can be suppressed.

In such a manner, since the support member 160 is attached to the seat cushion 121 of the front seat 102A, space can be saved when the support member 160 is stowed. Incidentally, the support member 160 is not limited to having a plate shape, and may have a rod shape.

### Fifth Example

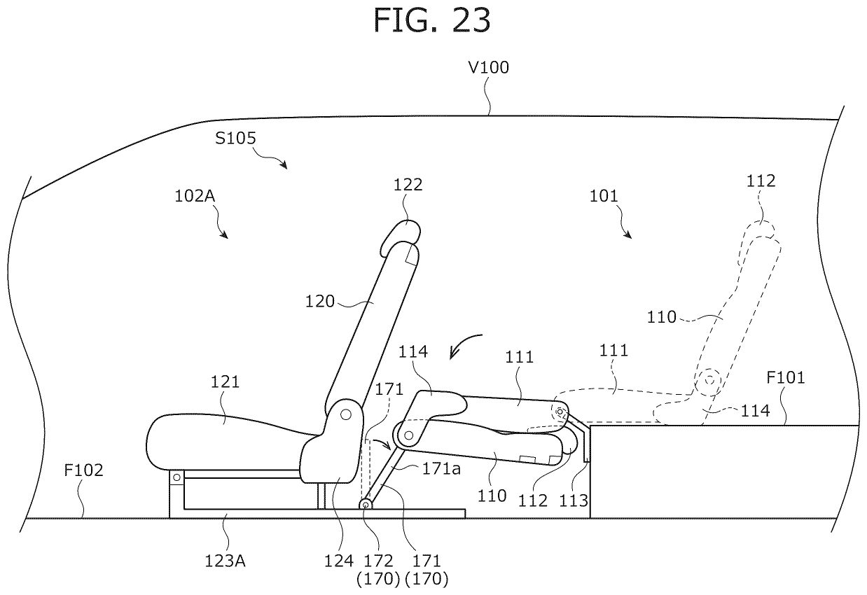

Next, a vehicle seat device S105 of the vehicle V100 of a fifth example will be described based on FIG. 23.

Incidentally, the description of contents that overlap with those of the vehicle seat devices S101 to S104 described above will be omitted.

The vehicle seat device S105 of the fifth example is different from the vehicle seat devices S101 to S104 mainly in a configuration of a support member 170.

The support member 170 is switchable between a stowed position where the support member 170 is stowed on the front seat 102A (illustrated by a dashed line in FIG. 23) and a support position where the support member 170 is deployed downward from the stowed position toward the rear seat 101 side to support the rear seat 101.

The stowed position is a position where the support member 170 is attached to the foot member 123 to extend in the up to down direction along the rear surface of the seat body when the front seat 102 is in the normal state. The support position is a position where the support member 170 is rotated downward and rearward from the stowed position, and supports the rear seat 101 from below when the rear seat 101 is in the stored state.

As shown in FIG. 23, the support member 170 includes a pipe member 171 and a pipe rotating shaft 172 that rotatably attaches the pipe member 171 to the foot member 123A.

Incidentally, the support member 170 is not limited to being the pipe member 171 having a rod shape, and may be a plate-shaped member (for example, a footrest).

The pipe member 171 is a rod-shaped member that is bent into an inverted U-shape when viewed from the front, and that includes a support portion 171a. The pipe member 171 is rotatably attached to a pair of leg portions 123Aa by the pipe rotating shaft 172. The support member 170 is deployed rearward by the occupant when the rear seat 101 is in stored state, and supports the rear seat 101 from below via the support portion 171a.

The pipe rotating shaft 172 is switched from the stowed position to the support position to rotate the pipe member 171 downward and rearward. Incidentally, the pipe rotating shaft 172 includes a lock mechanism (not illustrated) for restricting the rotation angle in the support position.

In such a manner, since the support member 170 is attached to the foot member 123A of the front seat 102A, space can be saved when the support member 170 is stowed. In addition, since the support member 170 is formed in a rod shape, space can be further saved when the support member 170 is stowed.

### Sixth Example

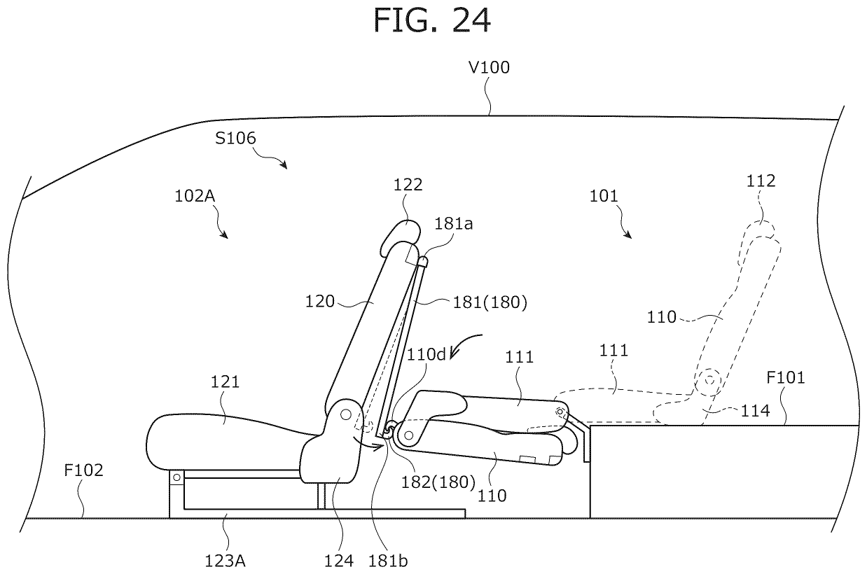

Next, a vehicle seat device S106 of the vehicle V100 of a sixth example will be described based on FIG. 24.

Incidentally, the description of contents that overlap with those of the vehicle seat devices S101 to S105 described above will be omitted.

The vehicle seat device S106 of the sixth example is different from the vehicle seat devices S101 to S105 mainly in a configuration of a support member 180.

The support member 180 is switchable between a stowed position where the support member 180 is stowed on the front seat 102A (illustrated by a dashed line in FIG. 24) and a support position where the support member 180 is deployed rearward from the stowed position toward the rear seat 101 side to support the rear seat 101.

The stowed position is a position where the support member 180 is stowed on the rear surface of the seat back 120. The support position is a position where the support member 180 supports the rear seat 101 from above when the rear seat 101 is in the stored state.

The support member 180 is attached to the seat cushion 121 of the front seat 102A, and supports the rear seat 101 so as to restrict the movement of the rear seat 101 by switching from the stowed position to the support position when the rear seat 101 is in the stored state. In other words, when the rear seat 101 is in the stored state, the rear seat 101 is supported from above by the support member 180. For that reason, the movement of the rear seat 101 further downward from the stored state can be suppressed.

As shown in FIG. 24, the support member 180 includes a string-shaped member 181 and an engaging portion 182 for engaging with the rear seat 101.

The string-shaped member 181 is, for example, a sling or a wire. One end portion 181a of the string-shaped member 181 is fixed to the rear surface of the seat back 120. The engaging portion 182 is provided at the other end portion 181b of the string-shaped member 181.

The engaging portion 182 is provided at the other end portion 181b of the string-shaped member 181, and is detachably attached to the rear surface of the seat cushion 121. The engaging portion 182 is attached to the rear surface of the seat cushion 121 as shown by a dashed line in FIG. 24. When the support member 180 is deployed rearward, the engaging portion 182 engages with the engaged portion 110d provided at the lower end portion of the seat back 110 of the rear seat 101.

Therefore, the support member 180 is deployed by the occupant when the rear seat 101 is in the stored state, and supports the rear seat 101 from above via the engaging portion 182.

In such a manner, since the support member 180 is attached to the seat back 120 of the front seat 102A, space can be saved when the support member 180 is stowed. In addition, since the support member 180 is formed in a string shape, the rear seat 101 can be supported with a simple configuration. Incidentally, the support member 140 is not limited to having a string shape, and may have a rod shape.

### Seventh Example

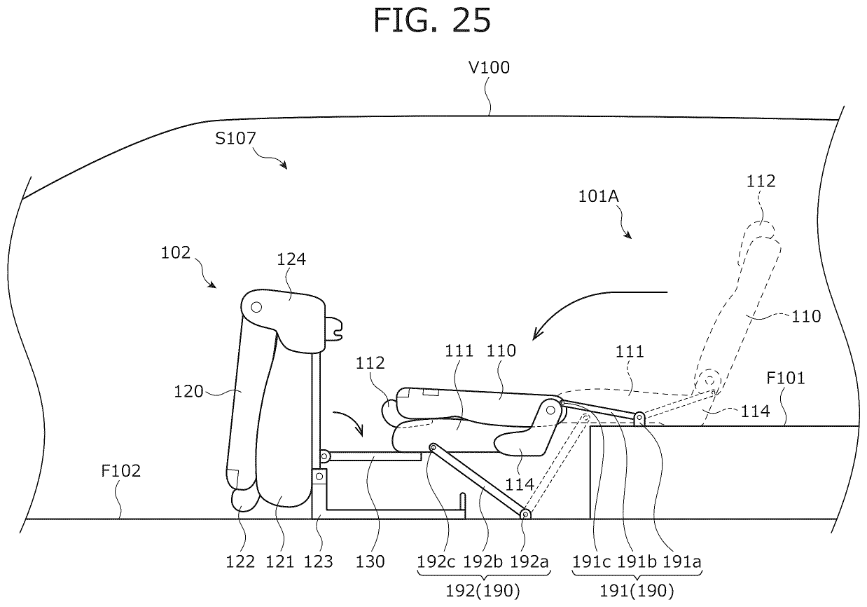

Next, a vehicle seat device S107 of the vehicle V100 of a seventh example will be described based on FIG. 25.

Incidentally, the description of contents that overlap with those of the vehicle seat devices S101 to S106 described above will be omitted.

The vehicle seat device S107 of the seventh example is different from the vehicle seat devices S101 to S106 mainly in a configuration of a rear seat 101A.

The rear seat 101A includes the seat body including the seat back 110, the seat cushion 111, and the headrest 112; a rotating member 190 for attaching the seat body to the vehicle body floor F100; the rotation lock member 114 that rotatably connects the seat back 110 to the seat cushion 111; and the operating portion 115 that releases the lock of the rotation lock member 114.

The rear seat 101 is switchable between a usage state shown by a dashed line and a stored state shown by a solid line in FIG. 25.

The usage state is a state where the occupant can be seated, and is a state where the seat back 110 is in the upright position. The stored state is a state where the seat back 110 and the seat cushion 111 are folded from the usage state to overlap each other, and the seat back 110 and the seat cushion 111 are translated forward, are moved downward while heading forward, and are stored on the lower step portion F102 side of the vehicle body floor F100.

As shown in FIG. 25, the rotating member 190 includes an upper rotating portion 191 fixed to the upper step portion F101 of the vehicle body floor F100, and a lower rotating portion 192 fixed to the lower step portion F102 of the vehicle body floor F100. The upper rotating portion 191 rotatably supports the seat back 110. The lower rotating portion 192 rotatably supports the seat cushion 111.

Incidentally, a pair of the rotating members 190 are provided in the seat width direction, and are disposed on both respective end sides of the seat back 110 and the seat cushion 111.

The upper rotating portion 191 includes an upper fixing portion 191a fixed to the upper portion of the front portion of the upper step portion F101; an upper arm portion 191b that is rotatably supported by the upper fixing portion 191a; and an upper connecting portion 191c that rotatably connects the upper arm portion 191b and the seat back 110.

The lower rotating portion 192 includes a lower fixing portion 192a fixed onto the lower step portion F102; a lower arm portion 192b that is rotatably supported by the lower fixing portion 192a; and a lower connecting portion 192c that rotatably connects the lower arm portion 192b and the seat cushion 111.

The upper arm portion 191b rotates around a shaft provided in the upper fixing portion 191a. The lower arm portion 192b rotates around a shaft provided in the lower fixing portion 192a.

The seat back 110 is rotatably attached to the upper arm portion 191b via the upper connecting portion 191c, and the seat cushion 111 is rotatably attached to the lower arm portion 192b via the lower connecting portion 192c. For that reason, the rear seat 101A is folded from the usage state such that the seat back 110 overlaps the seat cushion 111, and is moved downward and toward the front side while remaining in the folded posture.

In such a manner, the rotating member 190 is switchable between the usage state and the stored state such that the seat body is translated.

Incidentally, the rotating member 190 may be provided with a biasing mechanism that assists in the switching operation of the seat body between the usage state and the stored state.

The support member 130 is attached to the seat cushion 121 of the front seat 102 as shown in FIG. 25, and supports the rear seat 101A so as to restrict the movement of the rear seat 101A by switching from the stowed position to the support position when the rear seat 101A is in the stored state. In other words, when the rear seat 101A is in the stored state, the rear seat 101A is supported from below by the support member 130. For that reason, the movement of the rear seat 101A further downward from the stored state can be suppressed.

In such a manner, the seat back 110 of the rear seat 101A is tilted forward and folded, and the seat back 110 and the seat cushion 111 are moved while remaining in the overlapped state, so that the rear seat 101A can be stored with a simple configuration. Furthermore, since the seat cushion 111 (cushion frame 111c) of the rear seat 101A is supported from below by the support member 130, the support strength can be improved.

### Third Embodiment

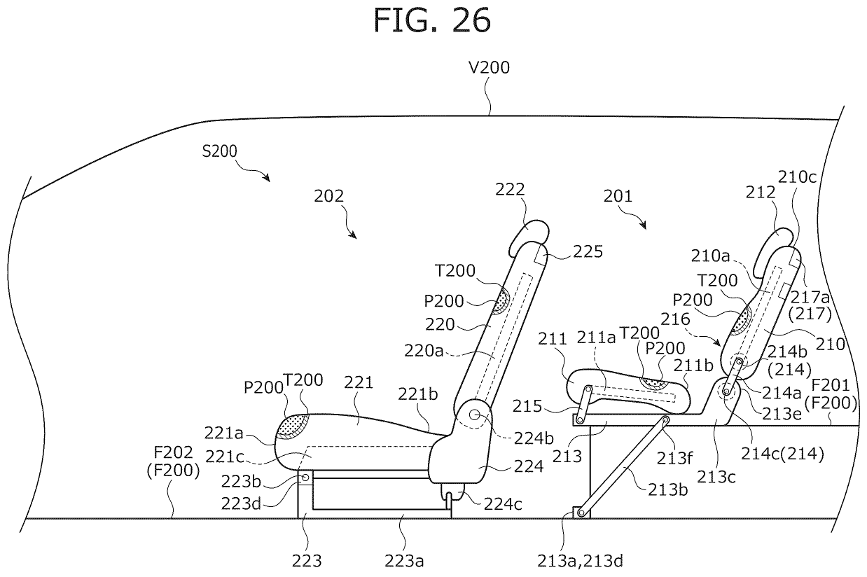

Hereinafter, a third embodiment of the present invention will be described with reference to FIGS. 26 to 32C.

The third embodiment relates to a vehicle seat and a vehicle, particularly to a vehicle seat including a seat back and a seat cushion, and a vehicle.

### BACKGROUND ART

In recent years, as a vehicle seat, there has been known a seat that is switchable between a usage state where an occupant can be seated and a folded state where a rear end portion of a seat cushion is flipped forward from the usage state to cause the seat cushion to become upright, and a seat back is tilted forward and folded at a position behind the seat cushion that is upright.

For example, in a vehicle seat described in JP 2013-226860 A, a seat back and a seat cushion are rotatably attached to a bottom cover (base member). Furthermore, the vehicle seat is switched from a usage state to a folded state where a rear end portion of the seat cushion is flipped forward to cause the seat cushion to become upright, and the seat back is tilted forward and folded at a position behind the seat cushion that is upright.

In such a vehicle seat, the space inside a passenger compartment can be widened by causing the seat cushion to become upright and tilting the seat back forward.

### SUMMARY OF INVENTION

### Technical Problem

However, in JP 2013-226860 A, when an attempt is made to tilt the seat back forward from the usage state and fold the seat back on the seat cushion, the seat back interferes with the rear end portion of the seat cushion. For that reason, the seat back cannot be folded such that a rear surface of the seat back is substantially horizontal, and the space inside the passenger compartment cannot be sufficiently widened.

The present invention has been made in view of the above-described problems, and an object of the present invention is to provide a vehicle seat and a vehicle capable of further widening the space inside a passenger compartment.

### Solution to Problem

The above-described problems are solved by a vehicle seat and a vehicle including the vehicle seat according to the present invention, the vehicle seat including: a seat back; a seat cushion; the vehicle seat being switchable between a usage state where an occupant can be seated, a first folded state where the seat back is folded from the usage state toward the seat cushion, and a second folded state where a rear end portion of the seat cushion is flipped forward from the usage state to cause the seat cushion to become upright, and the seat back is folded toward a vehicle body floor at a position behind the seat cushion that is upright, a first rotating shaft for rotating the seat back with respect to the vehicle body floor when the vehicle seat is switched from the usage state to the first folded state; and a second rotating shaft for rotating the seat back with respect to the vehicle body floor when the vehicle seat is switched from the usage state to the second folded state. The first rotating shaft and the second rotating shaft are disposed at different positions in a side view of the vehicle seat.

With the above-described configuration, it is possible to realize the vehicle seat and the vehicle capable of further widening the space inside a passenger compartment. In detail, since the vehicle seat includes two different rotating shafts, the vehicle seat is switchable between a state where the seat back is tilted forward and folded on the seat cushion from the usage state and a state where the rear end portion of the seat cushion is flipped forward from the usage state to cause the seat cushion to become upright and the seat back is tilted forward and folded.

Therefore, the vehicle seat can be arranged in various modes, and the space inside the passenger compartment can be sufficiently widened.

In this case, it is preferable that when the vehicle seat is in the usage state, the first rotating shaft is disposed above the second rotating shaft, and that the first rotating shaft and the second rotating shaft are separated from each other in an up to down direction by a distance larger than a thickness of the seat cushion.

With the above-described configuration, since the vehicle seat includes the two different rotating shafts separated from each other up and down, the seat back can be tilted forward with a simple configuration.

In this case, it is preferable that the vehicle seat further includes a base member movably attached to the vehicle body floor, that the seat back is rotatably attached to the base member. It is preferable that the seat cushion is rotatably attached to the base member, and that the vehicle seat is switchable between the usage state, the first folded state, and a stored state where the base member, together with the seat back and the seat cushion, is moved downward from the first folded state while heading toward a front side and is stored.

With the above-described configuration, since the vehicle seat can be moved downward and toward the front side and can be stored in a state where the seat back is tilted forward and folded to overlap the seat cushion, the space inside the passenger compartment can be even further widened.

In this case, it is preferable that the vehicle seat further includes a link member that rotates the seat back with respect to the base member. It is preferable that the link member includes a link portion that is long, that the first rotating shaft is attached to one end portion of the link portion, and the second rotating shaft is attached to the other end portion of the link portion, that the seat back is attached to the link member to be rotatable about the first rotating shaft, and that the link member is attached to a rear end portion of the base member to be rotatable about the second rotating shaft.

With the above-described configuration, since the seat back is tilted forward and rotated via the link member, the seat back can be tilted forward with a simple configuration.

In this case, it is preferable that the vehicle seat is switchable between the usage state, the first folded state, and an upright state where a rear end portion of the base member is flipped from the first folded state, and the base member, together with the seat back and the seat cushion, is rotated toward the front side to become upright.

With the above-described configuration, since the vehicle seat can be made upright and stored in a state where the seat back is tilted forward and folded to overlap the seat cushion, the space inside the passenger compartment can be even further widened.

In this case, it is preferable that the vehicle seat is switchable between the usage state, the first folded state, and the stored state where the base member, together with the seat back and the seat cushion, is moved downward from the first folded state while heading toward the front side in the posture where the seat back is folded on the seat cushion, and is stored.

With the above-described configuration, since the seat back can be tilted forward and folded to overlap the seat cushion and the vehicle seat can be moved downward and toward the front side while remaining in the folded posture, and can be stored, the space inside the passenger compartment can be even further widened.

In this case, it is preferable that the vehicle seat further includes a first lock member for locking the first rotating shaft; a second lock member for locking the second rotating shaft; and an operating member that releases a locked state of the first lock member and a locked state of the second lock member. It is preferable that the operating member includes an operating lever that is operated by the occupant, and a cable that connects the operating lever to the first lock member and the second lock member, that the first lock member is caused to transition from a locked position to an unlocked position by pulling the cable from a normal position to a first release position via the operating lever, and that the second lock member is caused to transition from a locked position to an unlocked position by further pulling the cable from the first release position to a second release position via the operating lever.

With the above-described configuration, when the operating lever is operated, the locks of two lock members can be released via one cable by using the pull stroke of the cable. For that reason, with a simple configuration, the locks of the two rotating shafts can be released.

### Advantageous Effects of Invention

According to the present invention, it is possible to realize the vehicle seat and the vehicle capable of further widening the space inside the passenger compartment.

In addition, according to the present invention, the seat back can be tilted forward with a simple configuration.

In addition, according to the present invention, the space inside the passenger compartment can be even further widened.

In addition, according to the present invention, with a simple configuration, the locks of the two rotating shafts can be released.

### DESCRIPTION OF EMBODIMENTS

A vehicle V200 of a third embodiment will be described with reference to FIGS. 26 to 32C.

The vehicle V200 of the third embodiment includes a vehicle seat device S200. As shown in FIG. 26, the vehicle seat device S200 includes, for example, a plurality of vehicle seats disposed side by side in a front to rear direction.

Incidentally, the vehicle seat may be, for example, a seat installed in a ship, an aircraft, or the like.

Incidentally, in the following description, the “front to rear direction” is a front to rear direction of the vehicle seat, and is a direction coinciding with a traveling direction when the vehicle V200 travels. In addition, the “seat width direction” is a width direction of the vehicle seat, and is a direction coinciding with a right to left direction when viewed from an occupant (seated occupant) seated in the vehicle seat. In addition, the “up to down direction” is an up to down direction of the vehicle seat, and is a direction coinciding with a vertical direction when the vehicle V200 travels on a horizontal surface.

### <Configuration of Vehicle Seat Device>

As shown in FIG. 26, the vehicle seat device S200 includes a rear seat 201 (vehicle seat) disposed on a rear side in the front to rear direction of the vehicle V200, and a front seat 202 disposed in front of the rear seat 201. Incidentally, the number of vehicle seats is not limited thereto, and the vehicle may include, for example, a front seat, a middle seat, and a rear seat as in a three-row seat arrangement.

As shown in FIG. 26, a step is formed on a vehicle body floor F200 of the vehicle V200. An upper step portion F201 is formed on the rear side of the vehicle V200, and a lower step portion F202 is formed on a front side of the vehicle V200. The rear seat 201 is disposed on the upper step portion F201 of the vehicle body floor F200, and the front seat 202 is disposed on the lower step portion F202 of the vehicle body floor F200.

Incidentally, the vehicle body floor F200 on which the vehicle seats are disposed may be a flat floor on which no step is formed.

### <Rear Seat (Vehicle Seat)>

The rear seat 201 includes a seat body including a seat back 210, a seat cushion 211, and a headrest 212; a base member 213 that is attached to the vehicle body floor F200; a rear link member 214 that rotates the seat back 210 with respect to the base member 213; a front link member 215 that rotates the seat cushion 211 with respect to the base member 213; a lock device 216 that restricts the rotation of the rear link member 214; and an operating member 217 that releases the locked state of the lock device 216.

Incidentally, a pair of the base members 213, the rear link members 214, and the front link members 215 are provided in the seat width direction, and are disposed on both respective end portion sides of the seat back 210 and the seat cushion 211.

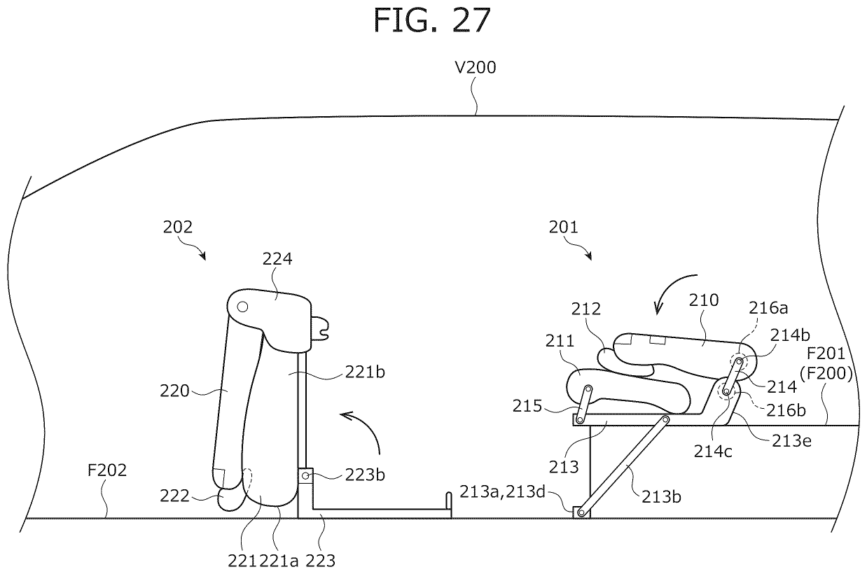

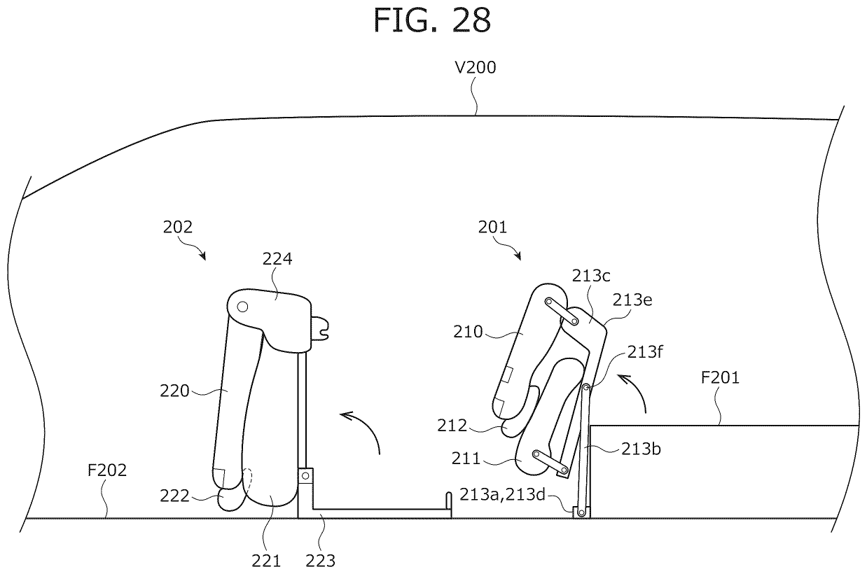

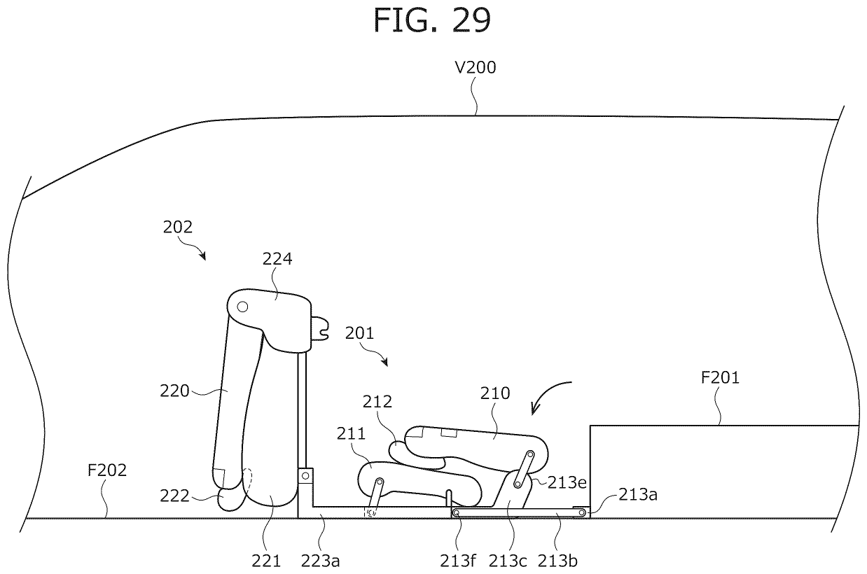

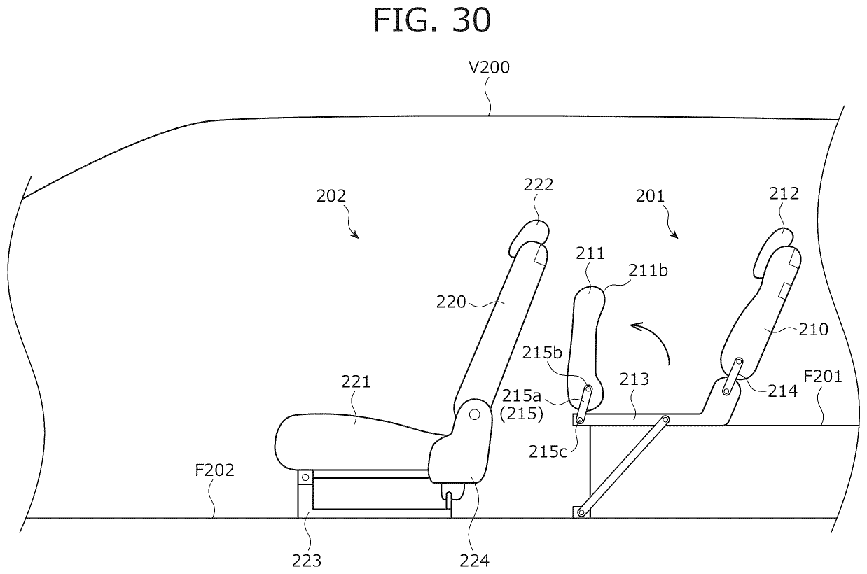

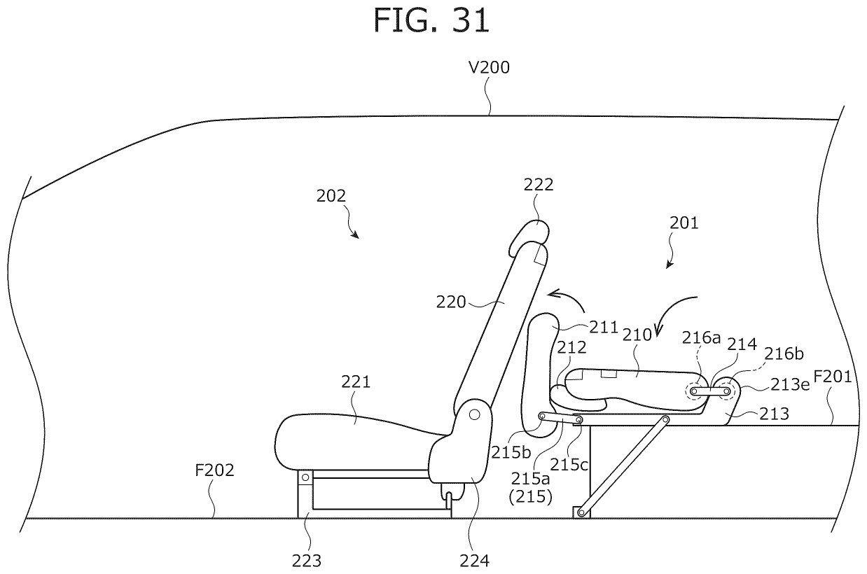

The rear seat 201 is switchable between a usage state shown in FIG. 26, a first folded state shown in FIG. 27, an upright state shown in FIG. 28, a stored state shown in FIG. 29, a flipped state shown in FIG. 30, and a second folded state shown in FIG. 31.

As shown in FIG. 26, the usage state is a state where the occupant can be seated, and is a state where the seat back 210 is in an upright position and the seat cushion 211 is in a laid-down position.

As shown in FIG. 27, the first folded state is a state where the seat back 210 is in a forward tilted position and the seat cushion 211 is in the laid-down position.

In other words, the first folded state is a state where the seat back 210 is rotated from the usage state via the rear link member 214 and is tilted forward and folded to overlap toward the seat cushion 211 on the upper step portion F201 of the vehicle body floor F200.

As shown in FIG. 28, the upright state is a state where a rear end portion (rear end portion 213e) of the base member 213 is flipped from the first folded state, and the base member 213, together with the seat back 210 and the seat cushion 211, is rotated about a central portion (pivot shaft 213f) of the base member 213 toward the front side to become upright.

As shown in FIG. 29, the stored state is a state where the base member 213, together with the seat body, is moved downward from the upright state while heading toward the front and is stored such that the base member 213 becomes parallel to the lower step portion F202 of the vehicle body floor F200.

In other words, the stored state is a state where the base member 213, together with the seat back 210 and the seat cushion 211, is moved downward from the first folded state while heading toward the front side in the posture where the seat back 210 is folded on the seat cushion 211, and is stored on the lower step portion F202.

As shown in FIG. 30, the flipped state is a state where the seat back 210 is in the upright position and the seat cushion 211 is in an upright position.

In other words, the flipped state is a state where the seat cushion 211 is rotated about a front end portion of the seat cushion 211 from the usage state via the front link member 215 and becomes upright with respect to the base member 213 on the upper step portion F201 of the vehicle body floor F200.

As shown in FIG. 31, the second folded state is a state where the seat back 210 is in the forward tilted position and the seat cushion 211 is in the upright position. In detail, in the second folded state, on the upper step portion F201 of the vehicle body floor F200, the seat cushion 211 is in a position where the seat cushion 211 is moved forward via the front link member 215 while remaining in the posture upright from the flipped state, and the seat back 210 is in a position where the seat back 210 is rotated via the rear link member 214 and is tilted forward to overlap the base member 213.

In other words, the second folded state is a state where a rotating end portion 211b of the seat cushion 211 is flipped forward from the usage state to cause the seat cushion 211 to become upright, and the seat back 210 is folded toward the base member 213 on the upper step portion F201 of the vehicle body floor F200 at a position behind the seat cushion 211 that is upright.

The seat back 210 is a backrest portion that supports the back of the seated occupant from the rear, and is configured by placing a pad material P200 on a back frame 210a serving as a skeleton, and covering the pad material P200 and the back frame 210a with a skin material T200.

The seat cushion 211 is a seating portion that supports the seated occupant from below, and is configured by placing the pad material P200 on a cushion frame 211a serving as a skeleton, and covering the pad material P200 and the cushion frame 211a with the skin material T200.

The headrest 212 is a head portion that supports the head of the seated occupant from the rear, and is configured by placing a pad material on a headrest pillar (not illustrated) serving as a core, and covering the pad material and the headrest pillar with a skin material.

As shown in FIG. 26, the base member 213 is attached to the vehicle body floor F200, and rotatably supports the seat back 210 and the seat cushion 211. The base member 213 includes a fixing portion 213a fixed to the lower step portion F202 of the vehicle body floor F200; an arm portion 213b that is rotatably attached to the fixing portion 213a; a bracket 213c that is attached to the arm portion 213b to be rotatable about the pivot shaft 213f; and a biasing mechanism 213d that assists in the switching operation of the rear seat 201 between the usage state and the stored state.

Incidentally, the base member 213 includes a lock mechanism (not illustrated) for maintaining the rear seat 201 in each of the usage state, the first folded state, the upright state, the stored state, the flipped state, and the second folded state.

The fixing portion 213a is fixed to the lower step portion F202 of the vehicle body floor F200, and rotatably supports the arm portion 213b. The biasing mechanism 213d is provided inside the fixing portion 213a.

The arm portion 213b is a long member, and supports the bracket 213c so as to be rotatable with respect to the vehicle body floor F200. A lower end portion of the arm portion 213b is rotatably attached to the fixing portion 213a. An upper end portion of the arm portion 213b is rotatably attached to the bracket 213c.

As shown in FIG. 26, the bracket 213c is a member having an L-shape in a side view and extending in the front to rear direction, and is provided on the upper step portion F201 of the vehicle body floor F200. The bracket 213c rotatably supports the seat back 210 and the seat cushion 211 via the rear link member 214 and the front link member 215.

In detail, the arm portion 213b is rotatably attached to a central portion of the bracket 213c. The rear link member 214 is rotatably attached to a rear end portion (rear end portion 213e) of the bracket 213c. The front link member 215 is rotatably attached to a front end portion of the bracket 213c.

When the rear seat 201 is in the usage state shown in FIG. 26, the first folded state shown in FIG. 27, the flipped state shown in FIG. 30, or the second folded state shown in FIG. 31, the bracket 213c is placed on the upper step portion F201 of the vehicle body floor F200.

When the rear seat 201 is in the stored state shown in FIG. 29, the bracket 213c is placed on the lower step portion F202 of the vehicle body floor F200.

Incidentally, when the rear seat 201 is in the upright state shown in FIG. 28, the bracket 213c is in the upright position with respect to the vehicle body floor F200.

When the rear seat 201 is rotated from the usage state to the upright state, the biasing mechanism 213d assists in the rotational operation of the seat body and the base member 213 against the weights of the seat body and the base member 213. When the rear seat 201 is rotated from the upright state to the stored state, the biasing mechanism 213d applies a resistance force to the seat body and the base member 213 to cause the seat body and the base member 213 to slowly rotate to the stored state.

In addition, when the rear seat 201 is rotated from the stored state to the usage state, the biasing mechanism 213d assists in the rotational operation against the weights of the seat body and the base member 213. When the rear seat 201 is rotated from the upright state to the usage state, the biasing mechanism 213d applies a resistance force to the seat body to cause the seat body to slowly rotate to the usage state.

As the arm portion 213b of the base member 213 rotates, the rear seat 201 switches from the first folded state (FIG. 27) to the upright state (FIG. 28) where the rear end portion 213e of the base member 213 is rotated toward the front side while being flipped and becomes upright. Then, the rear seat 201 switches from the upright state to the stored state (FIG. 29) where the rear end portion 213e of the base member 213 is rotated toward the lower side, and the seat body and base member 213 are moved downward while heading toward the front side and are stored.

In such a manner, the rear seat 201 switches from the usage state to the stored state where the seat back 210 is folded to overlap the seat cushion 211, is made upright while remaining in the folded posture, and is moved downward and toward the front side. Therefore, the base member 213 is switchable between the usage state and the stored state such that the seat body is translated.

Incidentally, in the present embodiment, the configuration in which the rear seat 201 is switched from the usage state to the stored state such that the seat body is translated is adopted; however, a configuration in which the rear seat 201 is switched from the usage state to the stored state such that the seat body is inverted may be adopted. In this case, the rear seat 201 is switched from the upright state to the stored state where the rear end portion 213e of the base member 213 is rotated further toward the front side, and the seat body and the base member 213 are moved downward while heading toward the front side in an inverted state and are stored such that the seat cushion 211 is disposed above the seat back 210.

In addition, in the present embodiment, the rear seat 201 is rotated toward the front side from the first folded state shown in FIG. 27, and is locked in the upright state shown in FIG. 28 by a lock mechanism (not illustrated). Then, the rear seat 201 is switched from the upright state to the first folded state shown in FIG. 28. However, the present invention is not limited thereto, and the rear seat 201 may be switched from the first folded state to the stored position without transitioning to the upright state.

In addition, in the present embodiment, the rear seat 201 is configured to be switched from the first folded state shown in FIG. 27 to the stored state, but may be configured to be switched from the second folded state shown in FIG. 31 to the stored state. In this case, the rear seat 201 may be switched to the upright state where the rear end portion 213e of the base member 213 is rotated toward the front side while being flipped and becomes upright.

Then, the rear seat 201 may be switched from the upright state to the stored state where the rear end portion 213e of the base member 213 is rotated toward the lower side, and the seat body and base member 213 are moved downward while heading toward the front side and are stored. Further, the rear seat 201 may be switched from the upright state to the stored state where the rear end portion 213e of the base member 213 is rotated further toward the front side, and the seat body and the base member 213 are moved downward while heading toward the front side and are stored such that the seat cushion 211 is disposed above the seat back 210.

As shown in FIG. 26, the rear link member 214 is a member that rotatably connects the base member 213 and the seat back 210. The seat back 210 is rotated by the rear link member 214 to tilt forward with respect to the base member 213.

The rear link member 214 includes a link portion 214a that is long and that extends in the up to down direction; a first rotating shaft 214b provided at an upper end portion of the link portion 214a; and a second rotating shaft 214c provided at a lower end portion of the link portion 214a.

When the rear seat 201 is in the usage state, the first rotating shaft 214b is disposed above the second rotating shaft 214c. In other words, the first rotating shaft 214b and the second rotating shaft 214c are disposed at different positions in a side view of the rear seat 201.

In addition, the first rotating shaft 214b and the second rotating shaft 214c are separated from each other in the up to down direction by a distance larger than a thickness of the rotating end portion 211b of the seat cushion 211.

The link portion 214a is a long rod-shaped member extending in the up to down direction. The first rotating shaft 214b is attached to the upper end portion (one end portion) of the link portion 214a, and the second rotating shaft 214c is attached to the lower end portion (the other end portion) of the link portion 214a.

The first rotating shaft 214b is attached to the upper end portion of the link portion 214a, and rotatably supports a lower end portion 210b of the seat back 210. The second rotating shaft 214c is attached to the rear end portion 213e of the base member 213, and rotatably supports the lower end portion of the link portion 214a.

In other words, the seat back 210 is attached to the link portion 214a to be rotatable about the first rotating shaft 214b, and the link portion 214a is attached to the rear end portion 213e of the base member 213 to be rotatable about the second rotating shaft 214c.

The rear seat 201 is switched between the usage state and the first folded state about the first rotating shaft 214b, and is switched between the usage state and the second folded state about the second rotating shaft 214c.

In such a manner, by providing two rotating shafts (the first rotating shaft 214b and the second rotating shaft 214c) separated from each other in the up to down direction, the rear seat 201 is switchable between a state where the seat back 210 is tilted forward and folded on the seat cushion 211 from the usage state and a state where the rotating end portion 211b of the seat cushion 211 is flipped forward from the usage state to cause the seat cushion 211 to become upright, and the seat back 210 is tilted forward and folded.

Therefore, with a simple configuration, the rear seat 201 can be arranged in various modes.

Incidentally, in the present embodiment, the seat back 210 is configured to rotate with respect to the base member 213 via the rear link member 214; however, a configuration in which the seat back 210 is directly rotatably provided on the base member 213 without providing the rear link member 214 may be adopted.

In this case, the first rotating shaft 214b and the second rotating shaft 214c rotatably connect the seat back 210 and the base member 213. When the occupant switches the rear seat 201 from the usage state to the first folded state, the occupant rotatably connects the seat back 210 and the base member 213 only via the first rotating shaft 214b, releases the connection of the second rotating shaft 214c, and folds the seat back 210. Then, when the occupant switches the rear seat 201 from the usage state to the second folded state, the occupant rotatably connects the seat back 210 and the base member 213 only via the second rotating shaft 214c, releases the connection of the first rotating shaft 214b, and folds the seat back 210.

In such a manner, by providing two rotating shafts that directly connect the base member 213 and the seat back 210, the rear seat 201 is switchable between the usage state, the first folded state, and the second folded state. Further, when both the rotating shafts connect the base member 213 and the seat back 210, the seat back 210 is in a locked state, and when the connection of one rotating shaft is released, the seat back 210 is in an unlocked state, so that with a simple configuration, the rear seat 201 is switchable between the usage state, the first folded state, and the second folded state.

As shown in FIG. 26, the front link member 215 is a member that rotatably connects the base member 213 and the seat cushion 211. As shown in FIG. 30, the seat cushion 211 is rotated by the front link member 215 such that the rotating end portion 211b is flipped with respect to the base member 213.

The front link member 215 includes a connecting portion 215a extending in the up to down direction; a third rotating shaft 215b provided at an upper end portion of the connecting portion 215a; and a fourth rotating shaft 215c provided at a lower end portion of the connecting portion 215a. When the rear seat 201 is in the usage state, the third rotating shaft 215b is disposed above the fourth rotating shaft 215c.

The rear seat 201 is switched between the usage state and the flipped state about the third rotating shaft 215b, and is switched between the flipped state and the second folded state about the fourth rotating shaft 215c.

Incidentally, the front link member 215 is provided with a lock device (not illustrated) that restricts the rotation of the front link member 215, and an operating member (not illustrated) that releases the lock of the lock device. The lock device provided in the front link member 215 may be the same lock mechanism as the lock device 216 of the rear link member 214 to be described later, or may be a different lock mechanism.

In such a manner, the rear seat 201 is switchable from the usage state to the upright state where the rotating end portion 211b of the seat cushion 211 is flipped forward about the third rotating shaft 215b. In addition, the rear seat 201 is switchable from the flipped state to the stored state where the seat cushion 211 is moved forward and the seat back 210 is tilted forward and folded while the seat cushion 211 remains in the upright posture.

Therefore, with a simple configuration, the rear seat 201 can be arranged in various modes.

As shown in FIG. 26, the lock device 216 is a lock mechanism that is provided inside the rear link member 214, and that restricts the rotation of the rear link member 214.

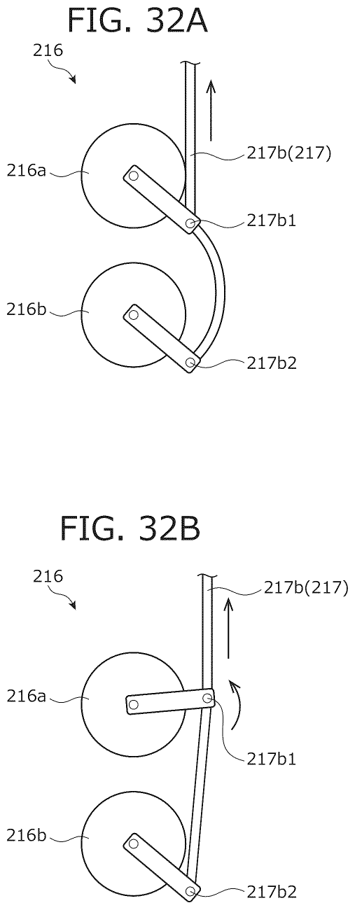

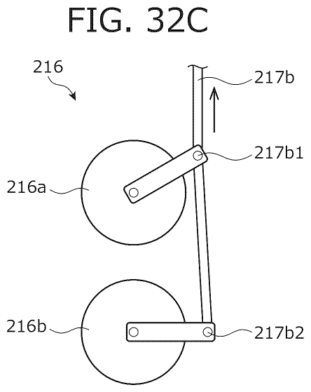

As shown in FIGS. 32A to 32C, the lock device 216 includes a first lock member 216a for locking the first rotating shaft 214b, and a second lock member 216b for locking the second rotating shaft 214c.

As shown in FIGS. 26 and 27, the seat back 210 is restricted in the rotational operation by the first lock member 216a, and is locked in the usage state (upright position) or the first folded state (forward tilted position). Incidentally, the seat back 210 may be locked in a position other than the upright position or the forward tilted position.

In addition, as shown in FIGS. 26 and 31, the seat back 210 is restricted in the rotational operation by the second lock member 216b, and is locked in the usage state (upright position) or the second folded state (forward tilted position). Incidentally, the seat back 210 may be locked in a position other than the upright position or the forward tilted position.

The operating member 217 includes an operating lever 217a that is operated by the occupant, and a cable 217b that connects the operating lever 217a and the lock device 216.

As shown in FIG. 26, the operating lever 217a is an operating portion for releasing the lock of the lock device 216, and is provided at an upper end portion 210c of the seat back 210.

As shown in FIGS. 32A to 32C, the cable 217b is a wire extending in the up to down direction, and is used to pull the first lock member 216a and the second lock member 216b. The first lock member 216a is connected to an intermediate portion 217b1 of the cable 217b. The second lock member 216b is connected to a lower end portion 217b2 of the cable 217b. Each of the first lock member 216a and the second lock member 216b is attached to the cable 217b such that there is slack between the intermediate portion 217b1 and the lower end portion 217b2 of the cable 217b.

Here, a lock operation of the lock device 216 and the operating member 217 will be described with reference to FIGS. 32A to 32C.

When the occupant pulls the operating lever 217a of the operating member 217 upward, the cable 217b is pulled upward, and the first lock member 216a connected to the intermediate portion 217b1 of the cable 217b transitions from a locked position (FIG. 32A) to an unlocked position (FIG. 32B). At this time, only the first lock member 216a is released due to slack in the cable 217b.

Then, when the occupant further pulls the operating lever 217a upward from the unlocked position of the first lock member 216a (FIG. 32B), the cable 217b is pulled further upward, and the second lock member 216b connected to the lower end portion 217b2 of the cable 217b transitions from a locked position (FIGS. 32A and 32B) to an unlocked position (FIG. 32C). At this time, both the first lock member 216a and the second lock member 216b are released by the cable 217b.

Namely, the first lock member 216a is caused to transition from the locked position to the unlocked position by pulling the cable 217b from a normal position shown in FIG. 32A to a first release position shown in FIG. 32B via the operating lever 217a.

The second lock member 216b is caused to transition from the locked position to the unlocked position by further pulling the cable 217b from the normal position shown in FIG. 32A or the first release position shown in FIG. 32B to a second release position shown in FIG. 32C via the operating lever 217a.

Incidentally, the normal position of the cable 217b shown in FIG. 32A refers to a position before the operating lever 217a is pulled by the occupant, and where the first lock member 216a and the second lock member 216b are in a locked state.

The first release position of the cable 217b shown in FIG. 32B refers to a position where the operating lever 217a is pulled upward by the occupant, and where the first lock member 216a is in an unlocked state and the second lock member 216b is in a locked state.

The second release position of the cable 217b shown in FIG. 32C refers to a position where the operating lever 217a is pulled further upward from the first release position by the occupant, and where the first lock member 216a is in an unlocked state and the second lock member 216b is in an unlocked state.

When the first lock member 216a transitions to the unlocked state, the seat back 210 is rotatable to tilt forward from the usage state to the first folded state.

When the second lock member 216b transitions to the unlocked state, the seat back 210 is rotatable to tilt forward from the usage state to the second folded state. At this time, since the first lock member 216a also transitions to the unlocked state, the seat back 210 is rotatable in forward tilt angle, and is also movable in the front to rear direction. Incidentally, the seat back 210 is positioned in the front to rear direction by bringing the headrest 212 into contact with the seat cushion 211.

In the present embodiment, the seat back 210 is rotated to tilt forward, but may be rotated to tilt rearward.

In addition, in the present embodiment, as the seat back 210 is tilted forward and folded, the rear seat 201 switches from the usage state to the stored state; however, the rear seat 201 may be configured to switch from the usage state to the stored state as the seat cushion 211 flips rearward.

In addition, the operating member 217 is configured to first release the lock of the first lock member 216a, and then to release the lock of the second lock member 216b. However, the present invention is not limited to the configuration, and the operating member 217 may be configured to first release the lock of the second lock member 216b, and then to release the lock of the first lock member 216a.

In addition, the operating member 217 is configured to first release one lock by using the pull stroke of one cable 217b (operating lever 217a). However, the present invention is not limited to the configuration, and a configuration in which two cables are connected to the first lock member 216a or the second lock member 216b, respectively, and one lock is released first by using the pull strokes of the two cables (operating levers) may be adopted.

Further, for example, a configuration in which a plate member that is pivotally supported by the rear link member 214 regardless of the pull stroke of the cable 217b is provided, and one lock is released first by using a difference between a separation distance between a connection position of the first lock member 216a and the plate member and a pivot position and a separation distance between a connection position of the second lock member 216b and the plate member and the pivot position may be adopted.

### <Front Seat>

The front seat 202 includes a seat body including a seat back 220, a seat cushion 221, and a headrest 222; a foot member 223 for attaching the seat body to the vehicle body floor F200; a rotation lock member 224 that rotatably connects the seat back 220 to the seat cushion 221; and an operating portion 225 that releases the lock of the rotation lock member 224.

The front seat 202 is switchable between a normal state shown in FIG. 26 and a tumble state shown in FIG. 27.

As shown in FIG. 26, the normal state is a state where the occupant can be seated, and is a state where the seat back 220 is in an upright position.

As shown in FIGS. 27 and 28, the tumble state is a state where the seat back 220 is tilted forward and folded from the normal state to overlap the seat cushion 221 and a rear end portion 221b of the seat cushion 221 is rotated upward about a front end portion 221a of the seat cushion 221 to become upright.

The seat back 220 is a backrest portion that supports the back of the seated occupant from the rear, and is configured by placing the pad material P200 on a back frame 220a serving as a skeleton, and covering the pad material P200 and the back frame 220a with the skin material T200.

The seat cushion 221 is a seating portion that supports the seated occupant from below, and is configured by placing the pad material P200 on a cushion frame 221c serving as a skeleton, and covering the pad material P200 and the cushion frame 221c with the skin material T200.

The headrest 222 is a head portion that supports the head of the seated occupant from the rear, and is configured by placing a pad material on a headrest pillar (not illustrated) serving as a core, and covering the pad material and the headrest pillar with a skin material.

As shown in FIG. 26, the foot member 223 is fixed to the lower step portion F202 of the vehicle body floor F200, and rotatably supports the cushion frame 221c of the seat cushion 221. The foot member 223 is fixed onto the lower step portion F202 by a pair of leg portions 223a provided in the seat width direction. A support shaft 223b is provided at an upper end portion on the front side of the foot member 223. A holding portion 223c that holds a held portion 224c provided at a lower end portion of the rotation lock member 224 is provided at an upper end portion on the rear side of the foot member 223.

The foot member 223 is connected to the cushion frame 221c via the support shaft 223b. For that reason, the foot member 223 allows the seat body to be switched between the normal state and the tumble state by causing the seat body to flip around the support shaft 223b.

Incidentally, the foot member 223 is provided with a biasing mechanism 223d that assists in the switching operation of the seat body between the normal state and the tumble state.

When the seat body is rotated from the normal state to the tumble state, the biasing mechanism 223d assists in the rotational operation of the seat body against the weight of the seat body.

In addition, when the seat body is rotated from the tumble state to the normal state, the biasing mechanism 223d applies a resistance force to the seat body to cause the seat body to slowly rotate to the normal state.

The rotation lock member 224 rotatably connects a lower end portion 220b of the seat back 220 and the rear end portion 221b of the seat cushion 221. The seat back 220 is tilted forward about a tilt shaft 224a of the rotation lock member 224 with respect to the seat cushion 221 to overlap the seat cushion 221. The rotation lock member 224 includes a lock mechanism 224b thereinside. In addition, the held portion 224c that is held by the holding portion 223c is formed at the lower end portion of the rotation lock member 224.

The rotation lock member 224 switches the seat back 220 between an upright position where the seat back 220 is upright with respect to the seat cushion 221 and a forward tilted position where the seat back 220 overlaps the seat cushion 221. The seat back 220 is restricted in the rotational operation by the lock mechanism 224b, and is locked in the upright position or the forward tilted position. Incidentally, the seat back 220 may be locked in a position other than the upright position or the forward tilted position.

The operating portion 225 is an operating lever for releasing the lock of the rotation lock member 224, and is provided at an upper end portion 220c of the seat back 220.

When the occupant operates the operating portion 225, the lock mechanism 224b transitions from a locked state to an unlocked state. Then, when the lock mechanism 224b transitions to the unlocked state, the seat back 220 is rotatable in a forward tilting direction. The degree of recline of the seat back 220 (angle formed by the seat back 220 and the seat cushion 221) is changed by the rotational operation of the seat back 220.

Incidentally, in the present embodiment, the seat back 220 is rotated to tilt forward, but may be rotated to tilt rearward.

In addition, in the present embodiment, as the seat back 220 is tilted forward and folded, the front seat 202 switches from the normal state to the tumble state; however, the front seat 202 may be configured to switch from the normal state to the tumble state as the seat cushion 221 flips rearward.

In the present embodiment, the configuration in which the rear seat 201 is switchable between the usage state, the first folded state, the upright state, the stored state, the flipped state, and the second folded state has been described. However, the present invention is not limited to the configuration, and the front seat 202 may be configured to be switchable between the usage state, the first folded state, the upright state, the stored state, the flipped state, and the second folded state.

### Fourth Embodiment

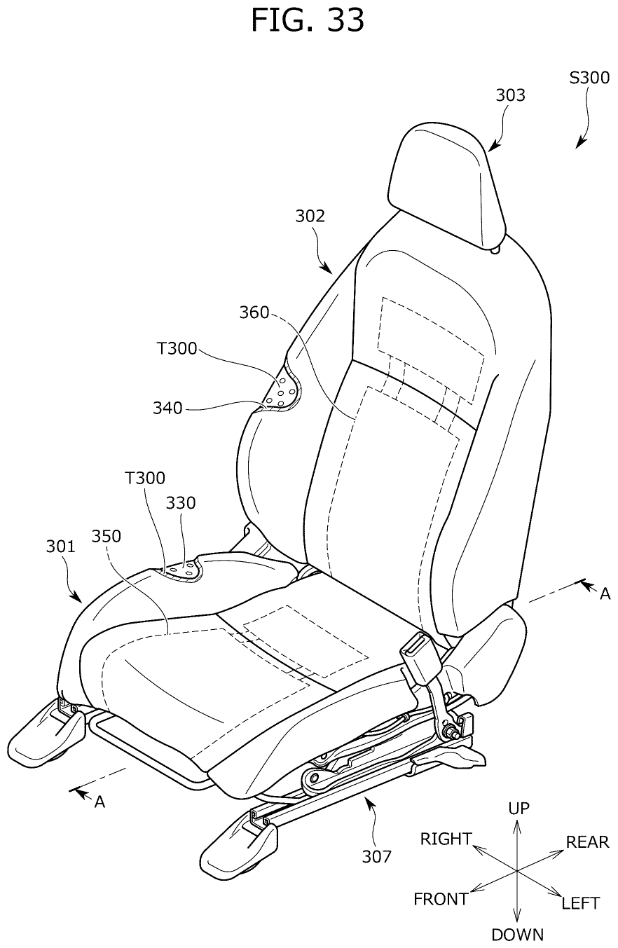

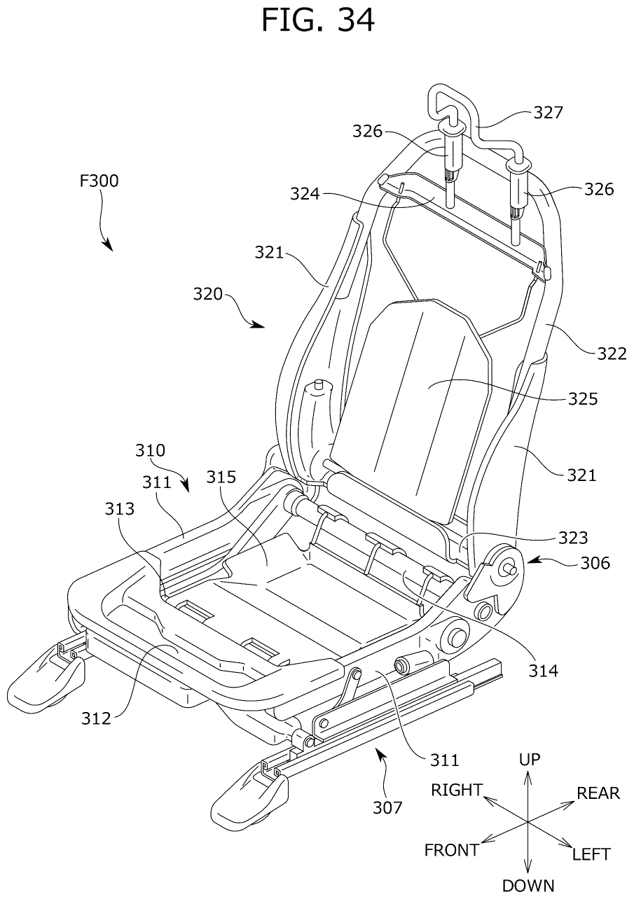

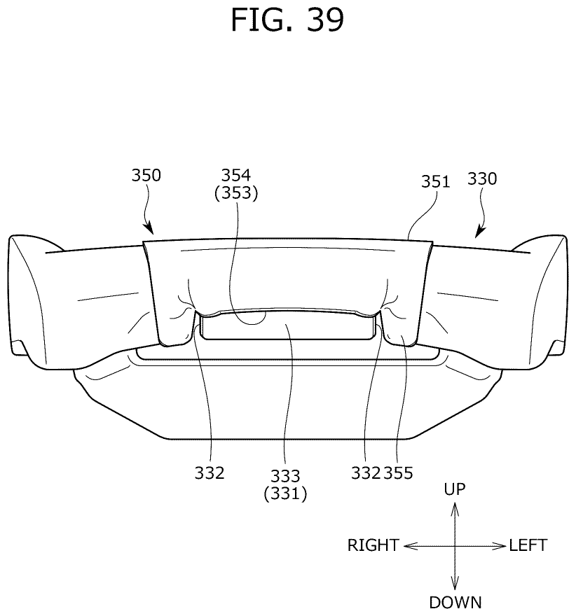

Hereinafter, a fourth embodiment of the present invention will be described with reference to FIGS. 33 to 45.

The fourth embodiment relates to a conveyance seat, particularly to a conveyance seat including a heater.

### BACKGROUND ART

As disclosed in JP 2014-36730 A, a conveyance seat in which a heater is provided on a pad has been known. Conventionally, as shown in FIG. 45, a cushion heater 3150 is affixed onto a cushion pad 3130 using a double-faced tape (adhesive member 3170).

### SUMMARY OF INVENTION

### Technical Problem

However, in the conventional method, since the adhesive members 3170 are applied to a plurality of regions on the cushion heater 3150 to fix the cushion heater 3150 onto the cushion pad 3130, costs or work man-hours increase, which is a problem.

The present invention has been made in view of the above-described problem, and an object of the present invention is to provide a conveyance seat including a heater, in which the amount of use of an adhesive member for fixing the heater to a pad is reduced.

### Solution to Problem

The above-described problem is solved by a conveyance seat of the present invention including: a frame; a pad disposed on the frame; and a heater disposed on the pad. The heater is composed of a heater base material and a heater wire provided on the heater base material. The heater base material is provided with an engaging portion that engages with the pad. The pad is provided with an engaged portion that engages with the engaging portion.

According to the conveyance seat of the present invention configured as described above, the heater can be fixed to the pad by engaging the engaging portion, which is provided in the heater base material, with the engaged portion provided in the pad. For that reason, the amount of use of an adhesive member that is conventionally used to fix the heater can be reduced. Namely, material costs can be reduced by reducing the number of double-faced tapes or the like that are adhesive members. In addition, for example, in the manufacturing process of the conveyance seat, the number of work steps related to the adhesive member, for example, the work step of affixing a double-faced tape to the heater or the work step of peeling a release paper from the double-faced tape, can be reduced.

In the above-described configuration, it is preferable that the engaging portion is an opening portion formed in the heater base material, and that the engaged portion is a protrusion formed in the pad to engage with the opening portion.

The heater can be easily fixed to the pad by forming the opening portion as the engaging portion, and forming the protrusion as the engaged portion.

In the above-described configuration, it is preferable that the protrusion is formed by slits made in the pad.

The protrusion is formed by making the slits in the pad, so that the engaged portion can be made compact, and no additional material is required, so that material costs can be reduced.

In the above-described configuration, it is preferable that the protrusion is provided at an end portion of the pad. The heater can be easily attached to the pad by providing the protrusion at the end portion of the pad.

In the above-described configuration, it is preferable that the frame is a cushion frame including a pan frame at a front of the cushion frame, that the pad is a cushion pad that supports buttocks of an occupant, and that at least parts of the slits forming the protrusion are disposed at positions overlapping the pan frame in a front view.

The rigidity of the cushion pad can be maintained by disposing parts of the slits so as to overlap the pan frame. In addition, the attachment state of the cushion pad can also be checked through the slits.

In the above-described configuration, it is preferable that the engaged portion is disposed at a center of the pad in a seat width direction.

The heater can be stably engaged by disposing the engaged portion at the center of the pad in the seat width direction.

In the above-described configuration, it is preferable that a length of the protrusion in a seat width direction is larger than a length of the opening portion in the seat width direction.

By making the length of the protrusion in the seat width direction larger than the length of the opening portion in the seat width direction, when the protrusion and the opening portion are engaged with each other, the heater base material around the opening portion is made to bite into the protrusion, and the opening portion is made less likely to come off from the protrusion.

In the above-described configuration, it is preferable that the opening portion before engaging with the protrusion is disposed slightly further inward in an extending direction of the heater than when the opening portion is engaged with the protrusion.

By disposing the opening portion further inward than when the opening portion is engaged with the protrusion, when the opening portion is engaged with the protrusion, tension is applied toward the inside in the extending direction of the heater, and the heater base material around the opening portion is made to bite into the protrusion. Therefore, the opening portion is less likely to come off from the protrusion.

In the above-described configuration, it is preferable that the engaging portion is provided at a position where the engaging portion avoids the heater wire, a breaker, and a thermistor included in the heater.

By providing the engaging portion at a position where the engaging portion avoids the heater wire, the breaker, and thermistor, the heater can be attached to the pad without affecting the function of the heater.

In the above-described configuration, it is preferable that the engaged portion is provided at a position where the engaged portion avoids a ventilation groove or a recessed portion for a seat belt reminder that are formed in the pad.

By disposing the engaged portion at a position where the engaged portion avoids the ventilation groove or the recessed portion for a seat belt reminder, the heater can be attached to the pad without affecting the function of the seat.

### Advantageous Effects of Invention

According to the conveyance seat of the present invention, the heater can be fixed to the pad by engaging the engaging portion, which is provided in the heater base material, with the engaged portion provided in the pad. For that reason, the amount of use of an adhesive member that is conventionally used to fix the heater can be reduced. Namely, material costs can be reduced by reducing the number of double-faced tapes or the like that are adhesive members. In addition, for example, in the manufacturing process of the conveyance seat, the number of work steps related to the adhesive member, for example, the work step of affixing a double-faced tape to the heater or the work step of peeling a release paper from the double-faced tape, can be reduced.

In addition, the heater can be easily fixed to the pad by forming the opening portion as the engaging portion, and forming the protrusion as the engaged portion.

The protrusion is formed by making the slits in the pad, so that the engaged portion can be made compact, and no additional material is required, so that material costs can be reduced.

The heater can be easily attached to the pad by providing the protrusion at the end portion of the pad.

The rigidity of the cushion pad can be maintained by disposing parts of the slits so as to overlap the pan frame. In addition, the attachment state of the cushion pad can also be checked through the slits.

The heater can be stably engaged by disposing the engaged portion at the center of the pad in the seat width direction.

By making the length of the protrusion in the seat width direction larger than the length of the opening portion in the seat width direction, when the protrusion and the opening portion are engaged with each other, the heater base material around the opening portion is made to bite into the protrusion, and the opening portion is made less likely to come off from the protrusion.

By disposing the opening portion further inward than when the opening portion is engaged with the protrusion, when the opening portion is engaged with the protrusion, tension is applied toward the inside in the extending direction of the heater, and the heater base material around the opening portion is made to bite into the protrusion. Therefore, the opening portion is less likely to come off from the protrusion.

By providing the engaging portion at a position where the engaging portion avoids the heater wire, the breaker, and thermistor, the heater can be attached to the pad without affecting the function of the heater.

By disposing the engaged portion at a position where the engaged portion avoids the ventilation groove or the recessed portion for a seat belt reminder, the heater can be attached to the pad without affecting the function of the seat.

### DESCRIPTION OF EMBODIMENTS

Hereinafter, a configuration of a conveyance seat according to a fourth embodiment of the present invention will be described with reference to the drawings. However, the embodiment to be described below is one example for easy understanding of the present invention, and does not limit the present invention. Namely, the present invention can be modified or improved without departing from the concept of the present invention, and it goes without saying that the present invention includes equivalents thereof.

Incidentally, hereinafter, a conveyance seat installed in a vehicle will be provided as one example of the conveyance seat, and a configuration example of the conveyance seat will be described. However, the present invention is not limited to conveyance seats installed in ground-traveling conveyances including wheels such as an automobile and a train, and may be applied to a seat installed in an aircraft, a ship, or the like that moves in environments other than the ground.

In addition, in the following description, the “front to rear direction” is a front to rear direction of the conveyance seat, and is a direction coinciding with a traveling direction when the vehicle travels. In addition, the “seat width direction” is a width direction of the conveyance seat, and is a direction coinciding with a right to left direction when viewed from an occupant seated in the conveyance seat. In addition, the “up to down direction” is an up to down direction of the conveyance seat, and is a direction coinciding with a vertical direction when the vehicle travels on a horizontal surface.

In addition, in the following description, when various directions are described with the term “seat” added, such as “seat width direction” and “seat height direction”, the various directions refer to the directions with respect to the conveyance seat, and when directions are described with the term “vehicle” added, such as “vehicle inside” and “vehicle outside”, the directions refer to the directions with respect to the vehicle.

In addition, in the following description, unless otherwise specified, the shape, the position, the posture, and the like of each portion of the conveyance seat will be described based on the assumption that the conveyance seat is in a seated state.

### <Basic Configuration of Conveyance Seat S300>

A basic configuration of the conveyance seat according to the present embodiment (hereinafter, a conveyance seat S300) will be described with reference to FIGS. 33 and 34. FIG. 33 is a perspective view of the conveyance seat S300. In FIG. 33, for convenience of illustration, a part of the conveyance seat S300 is illustrated with a skin T300 removed.

The conveyance seat S300 is a seat which is placed on a vehicle body floor and in which the occupant of the vehicle is seated. In the present embodiment, the conveyance seat S300 is used as a front seat corresponding to a front seat of the vehicle. However, the conveyance seat S300 is not limited to the front seat, and the conveyance seat S300 may be a rear seat of the vehicle, and can also be used as a middle seat in a second row or a rear seat in a third row of a vehicle including three rows of seats in the front to rear direction.

As shown in FIG. 33, the conveyance seat S300 includes, as main components, a seat cushion 301 serving as a seating portion that supports the buttocks of the seated occupant; a seat back 302 serving as a backrest portion that supports the back of the seated occupant; and a headrest 303 that is disposed on an upper portion of the seat back 302 and that supports the head of the seated occupant.

The seat cushion 301 and the seat back 302 are connected to each other with a reclining device 306 (refer to FIG. 34) therebetween. In addition, a slide device 307 is installed under the seat cushion 301, and the conveyance seat S300 is placed on the vehicle body floor in a state where the conveyance seat S300 is movable in a sliding manner in the front to rear direction by the slide device 307.

A frame F300 shown in FIG. 34 is provided inside the conveyance seat S300, and the frame F300 is mainly composed of a cushion frame 310 and a back frame 320. The cushion frame 310 forms the skeleton of the seat cushion 301, and the back frame 320 forms the skeleton of the seat back 302.

A rear end portion of the seat cushion 301 is connected to a lower end portion of the seat back 302. In addition, the seat cushion 301 is configured by placing a cushion pad 330 on the cushion frame 310, and further covering the cushion pad 330 with the skin T300 for the cushion. The seat back 302 is configured by placing a back pad 340 on the back frame 320, and further covering the back pad 340 with the skin T300 for the back. Incidentally, the cushion pad 330 and the back pad 340 correspond to pads of the present invention.

The conveyance seat S300 of the present embodiment includes a cushion heater 350 on the cushion pad 330. In more detail, the cushion heater 350 is provided between the cushion pad 330 and the skin T300. In addition, the conveyance seat S300 includes a back heater 360 on a seating surface of the back pad 340. In more detail, the back heater 360 is provided between the back pad 340 and the skin T300. The cushion heater 350 and the back heater 360 correspond to heaters of the present invention. Configurations of the cushion heater 350 and the back heater 360 will be described later.

The cushion pad 330 and the back pad 340 are, for example, urethane base materials molded by foam molding using a urethane foaming agent. The skin T300 is made of fabric, film, cloth, leather, sheet, or the like. In addition, the skin T300 is attached to cover the cushion pad 330 and the back pad 340 in a stretched state where a predetermined tension is applied to the skin T300.

A pull-in groove 335 for pulling in the skin T300 is formed in the cushion pad 330. In addition, a pull-in groove 345 for pulling in the skin T300 is formed in the back pad 340.

### <Cushion Frame 310>

As shown in FIG. 34, the cushion frame 310 of the frame F300 has a substantially rectangular frame-shaped outer shape. Furthermore, the cushion frame 310 includes, main components, a pair of cushion side frames 311 and 311 constituting right and left end portions of the cushion frame 310 in the seat width direction, respectively; a pan frame 312 constituting a front end portion of the cushion frame 310; and a pressure receiving plate 315.

The pair of cushion side frames 311 and 311 are separated from each other in the right to left direction to define a width of the cushion frame 310, and are disposed to extend in the front to rear direction of the vehicle. Furthermore, a front pipe 313 and a rear pipe 314 that connect the pair of cushion side frames 311 and 311 are attached to front end portions and rear end portions of the pair of cushion side frames 311 and 311, respectively.

The pan frame 312 is fixedly joined to a front side of the pair of cushion side frames 311 and 311, and the right and left cushion side frames 311 and 311 are connected to each other on the front side by the pan frame 312. In more detail, end portions of the pan frame 312 in the right to left direction are fixed to respective flanges, which are provided on the cushion side frames 311 and 311, by fixing means such as welding.

The pan frame 312 is mainly intended to support the thighs of the seated occupant (occupant), and is a frame made of a metal plate formed in a substantially rectangular shape and having a substantially flat an upper surface.

### <Regarding Pressure Receiving Plate 315>

The pressure receiving plate 315 is a member that receives a weight from a seating surface of the seat cushion 301. The pressure receiving plate 315 is supported by hooking a front end portion and a rear end portion of the pressure receiving plate 315 onto the front pipe 313 and the rear pipe 314, respectively.

### <Back Frame 320>

As shown in FIG. 34, the back frame 320 is made of a pipe processed into a rectangular frame shape. The back frame 320 includes a pair of back side frames 321 and 321 constituting right and left end portions of the back frame 320 in the seat width direction; an upper frame 322 that connects upper end portions of the pair of back side frames 321 and 321; and a lower frame 323 that connects lower end portions of the pair of back side frames 321 and 321. The upper frame 322 is formed in an inverted U-shape.

In addition, the back frame 320 is provided with a pressure receiving plate 325 suspended from the back frame 320, and a suspension frame 324 for suspending the pressure receiving plate 325 is provided to span a lower end of the upper frame 322. Headrest guides 326 having a tubular shape are attached to an upper end central portion of the back frame 320. The headrest 303 is attached to the seat back 302 by inserting a headrest pillar 327 into the headrest guides 326, the headrest pillar 327 extending from a lower end of the headrest 303.

Examples of a constituent material of each member constituting the cushion frame 310 and the back frame 320 include a material having sufficient rigidity so as not to significantly deform when the material is subjected to a load, for example, a metal material such as steel or aluminum alloy. Joining means for the members constituting the cushion frame 310 and the back frame 320 is welding; however, as the joining means, joining by bolts and joining by an adhesive may be used in combination.

### <Cushion Heater 350>

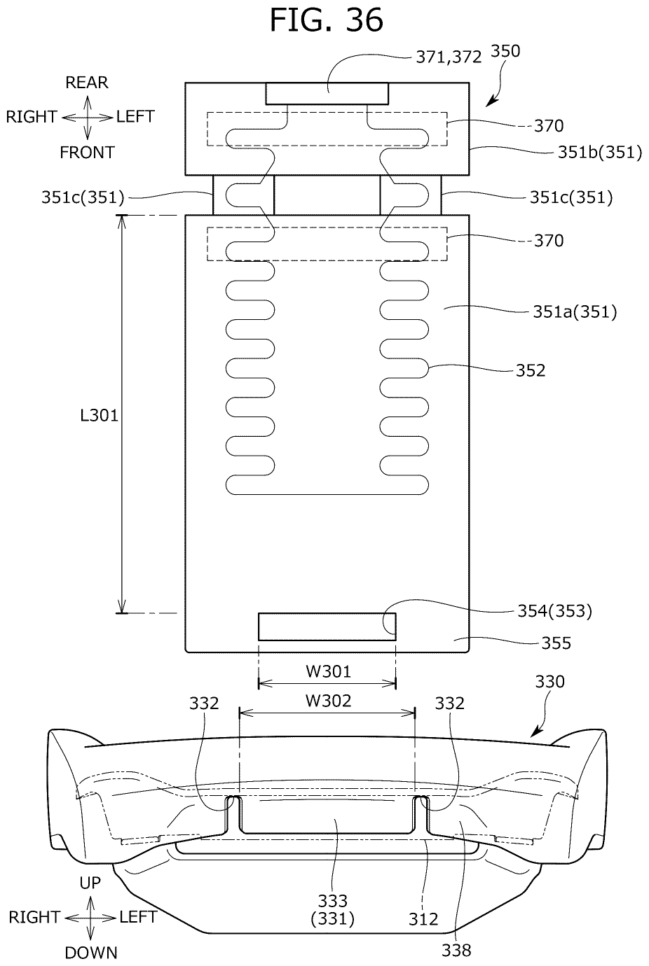

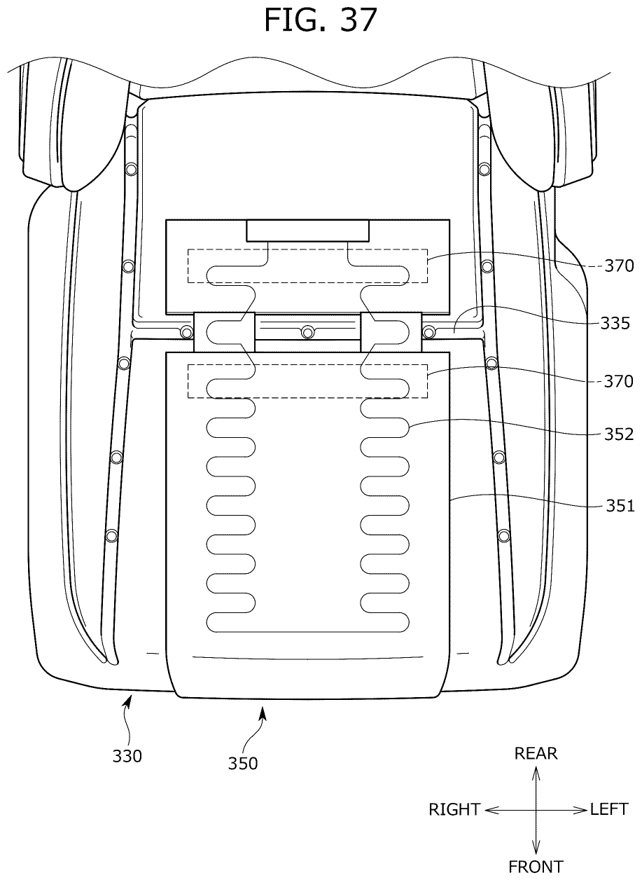

The cushion heater 350 will be described with reference to FIG. 36. The cushion heater 350 is a planar heating element that warms the seat cushion 301. The upper part of FIG. 36 shows the cushion heater 350 before being attached to the cushion pad 330. In addition, the lower part of FIG. 36 is a view of the cushion pad 330 when viewed from the front.

The cushion heater 350 is mainly composed of a heater base material 351 having a planar shape and made of a polyester fabric material or the like, and a heater wire 352 that is adhesively fixed to the heater base material 351.

The heater base material 351 is made of a stretchable fabric material formed in a substantially rectangular shape, and as shown in FIG. 36, is composed of a front planar body 351a, a rear planar body 351b, and two connecting planar bodies 351c that have a substantially rectangular shape and that connect the front planar body 351a and the rear planar body 351b. The connecting planar bodies 351c are inserted and placed in the pull-in groove 335 of the cushion pad 330.

The heater wire 352 meanders substantially parallel to the front to rear direction, and is fixed onto the heater base material 351. The disposition of the heater wire 352 is not limited thereto, and may be changed as appropriate. The heater wire 352 is fixed onto the heater base material 351 by an adhesive. The heater wire 352 may be woven inside the heater base material 351.

A thermistor 372 that detects the temperature of the cushion heater 350 and a breaker 371 are provided at the rear of the heater wire 352. In addition, a controller (not illustrated) for controlling the temperature of the cushion heater 350 and a connector that is connected to a harness on a vehicle body side are attached.

An adhesive member 370 for adhering to the seat cushion is provided on a back surface of the rear planar body 351b. In addition, the adhesive member 370 is also provided on a rear end portion of the front planar body 351a. The adhesive member 370 is, for example, a double-faced tape. By fixing the front and rear of the pull-in groove 335 using the adhesive members 370, a situation where when the load of the occupant is applied, the heater base material 351 is pulled and collected in the pull-in groove 335 is suppressed.

In addition, an engaging portion 353 that engages with the cushion pad 330 is provided at a front end portion 355 of the heater base material 351 (in more detail, the front planar body 351a). An engaged portion 331 is formed at a front end portion (wrapping portion 338) of the cushion pad 330, and the front end portion 355 of the heater base material 351 can be attached by engaging the engaging portion 353 with the engaged portion 331.

In the present embodiment, as the engaging portion 353, an opening portion 354 having a rectangular shape is formed in the front end portion 355 of the heater base material 351. In addition, a protrusion 333 is formed at the front end portion of the cushion pad 330, in more detail, at the wrapping portion 338 of the cushion pad 330, as the engaged portion 331 that engages with the opening portion 354. As shown in the lower part of FIG. 36, the protrusion 333 of the cushion pad 330 is formed by making two slits 332 in the front end portion (wrapping portion 338) of the cushion pad 330.

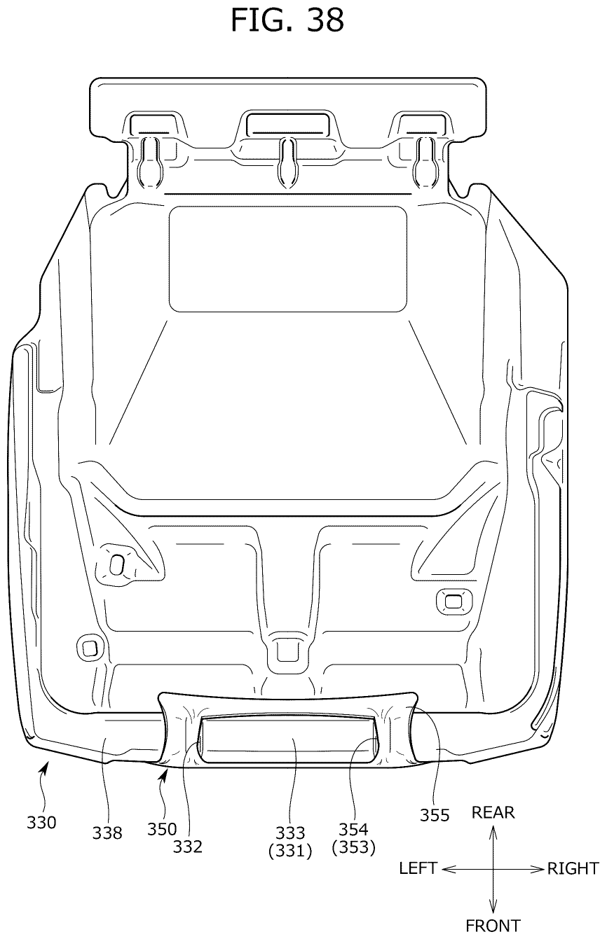

As shown in FIG. 37, a rear end portion of the cushion heater 350 is fixed using the adhesive member 370. Thereafter, as shown in FIG. 38, the cushion heater 350 is fixed to the cushion pad 330 by hooking the opening portion 354, which is provided in the front end portion 355 of the heater base material 351, onto the protrusion 333 of the cushion pad 330.

Conventionally, as shown in FIG. 45, in order to fix the cushion heater 3150 to the cushion pad 3130, a front end portion of a heater base material 3151 is also fixed using the adhesive member 3170. A rear end portion of the cushion heater 3150 needs to be fixed to the cushion pad 3130 using the adhesive member 3170 even after manufacture so as not to be pulled into a pull-in groove. Meanwhile, a front end portion of the cushion heater 3150 may be fixed in any manner as long as the falling off of the cushion heater 3150 from the cushion pad 3130 can be suppressed or the occurrence of fold creases can be suppressed during the manufacturing process. After the cushion heater 3150 is fixed, since the cushion pad 3130 is covered with the skin T300, the front end portion of the cushion heater 3150 may not be fixed using the adhesive member 3170.

In the conveyance seat S300 of the present embodiment, the opening portion 354 is formed in the front end portion 355 of the cushion heater 350, and the cushion heater 350 is fixed by hooking the opening portion 354 onto the protrusion 333 of the cushion pad 330. Therefore, the adhesive member 370 (double-faced tape) that is conventionally used to fix the front end portion is not necessary, so that the amount of use of the adhesive member 370 can be reduced and material costs can be reduced. In addition, in the manufacturing process of the conveyance seat S300, the number of work steps related to the adhesive member, for example, the work step of affixing a double-faced tape to a back surface of the cushion heater 350 or the work step of peeling a release paper of the double-faced tape, can be reduced.

In addition, in the present embodiment, the protrusion 333 is formed by making the two slits 332 in the front end portion, in more detail, the wrapping portion 338 of the cushion pad 330.

The front end portion 355 of the heater base material 351 can be easily fixed to the cushion pad 330 by forming the opening portion 354 as the engaging portion 353, and forming the protrusion 333 as the engaged portion 331.

In addition, since the protrusion 333 is formed by making the slits 332 in the cushion pad 330, the engaged portion 331 can be made compact. In addition, compared to the case of newly providing a protruding portion, no additional material is required, so that material costs can be reduced.

In addition, as in the cushion pad 330 shown in the lower part of FIG. 36, in the present embodiment, at least parts of the slits 332 forming the protrusion 333 are disposed at positions overlapping the pan frame 312 in a front view. The cushion heater 350 can be more firmly fixed by causing the slits 332 to overlap the pan frame 312 in a front view.

In addition, the protrusion 333 that is the engaged portion 331 is disposed at the center of the cushion pad 330 in the seat width direction. By disposing the protrusion 333 at the center in the seat width direction, the cushion heater 350 can be stably engaged without being shifted to the right or left. In addition, it is preferable that the protrusions 333 is disposed at a bilaterally symmetrical position, and therefore, for example, the occurrence of creases in the heater base material 351 can be suppressed.

Incidentally, the position or number of the protrusions 333 can be selected according to the design of the cushion pad 330 set for each vehicle model; however, it is preferable that one protrusion 333 is provided at the center in the seat width direction (right to left direction). By providing one protrusion 333, the man-hours required to attach the cushion heater 350 are reduced, and the fixation of the heater base material 351 is also improved. In addition, the protrusion 333 provided in the cushion pad 330 needs to have a certain degree of rigidity. For that reason, it is preferable that a length W302 of the protrusion 333 in the seat width direction is large. For that reason, it is most preferable that only one protrusion 333 with a wide width is formed.

In addition, as shown in FIG. 36, the length W302 of the protrusion 333 in the seat width direction is formed to be larger than a length W301 of the opening portion 354 in the seat width direction. By making the length W302 of the protrusion 333 in the seat width direction larger than the length W301 of the opening portion 354 in the seat width direction, when the protrusion 333 and the opening portion 354 are engaged with each other, the heater base material 351 is made to bite into the protrusion 333 of the pad, and the opening portion 354 is made less likely to come off from the protrusion 333.

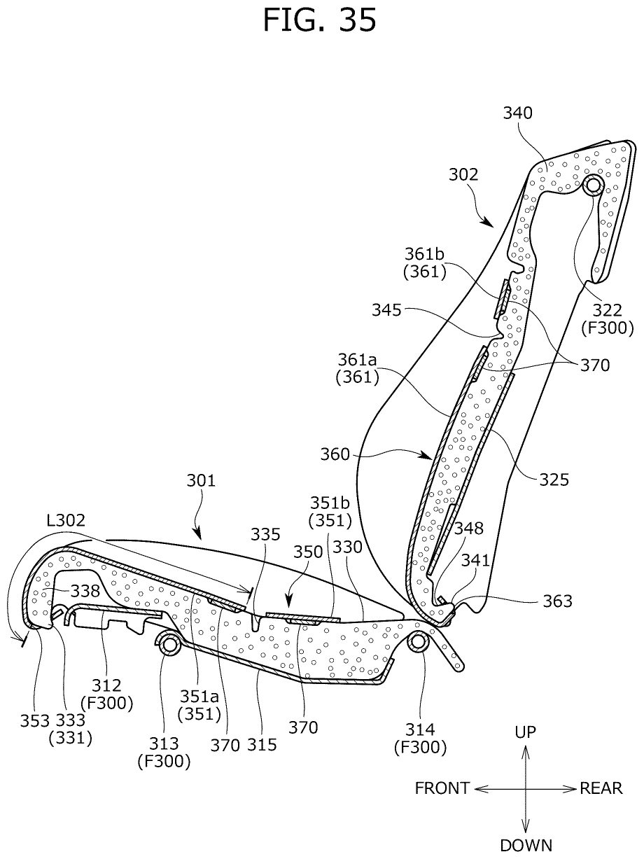

In addition, it is preferable that the position of the opening portion 354 before engaging with the protrusion 333 is disposed slightly further inward in an extending direction of the heater (front to rear direction in FIG. 36) than when the opening portion 354 is engaged with the protrusion 333. In other words, it is preferable that the opening portion 354 is disposed such that a distance L301 from the rear end portion of the front planar body 351a to the opening portion 354 before engagement is shorter than a distance L302 from the rear end portion of the front planar body 351a to the protrusion 333 shown in FIG. 35. By disposing the opening portion 354 in such a manner, when the opening portion 354 is engaged with the protrusion 333, the opening portion 354 is hooked onto the protrusion 333 in a state where the heater base material 351 is pulled and stretched beyond the original length, so that tension is applied toward the inside in the extending direction (front to rear direction) of the cushion heater 350. For that reason, slack of the heater base material 351 can be suppressed. In addition, since the heater base material 351 around the opening portion 354 bites into the protrusion 333, the opening portion 354 is less likely to come off from the protrusion 333.

In addition, it is preferable that the opening portion 354 that is the engaging portion 353 is provided at a position where the opening portion 354 avoids the heater wire 352, the breaker 371, and the thermistor 372 included in the cushion heater 350. Namely, it is preferable that the opening portion 354 is formed at a location on the heater base material 351, at which the heater wire 352, the breaker 371, and the thermistor 372 are not disposed. By providing the opening portion 354 at a position where the opening portion 354 avoids the heater wire 352, the breaker 371, and the thermistor 372, the cushion heater 350 can be attached to the cushion pad 330 without affecting the function of the cushion heater 350.

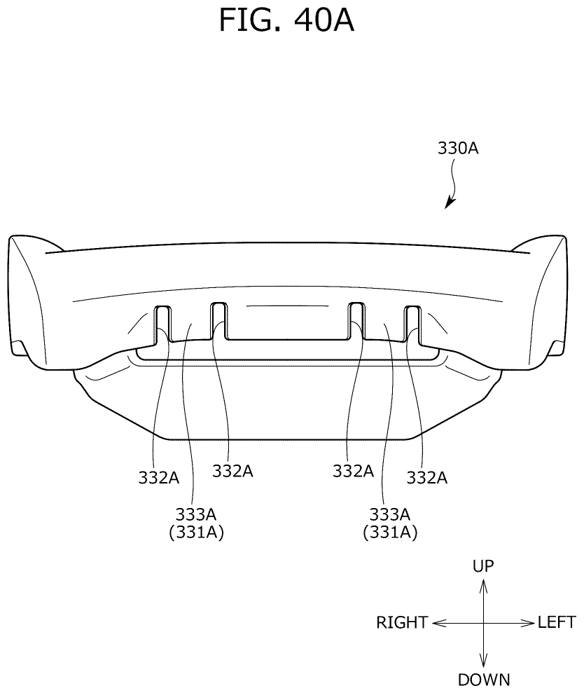

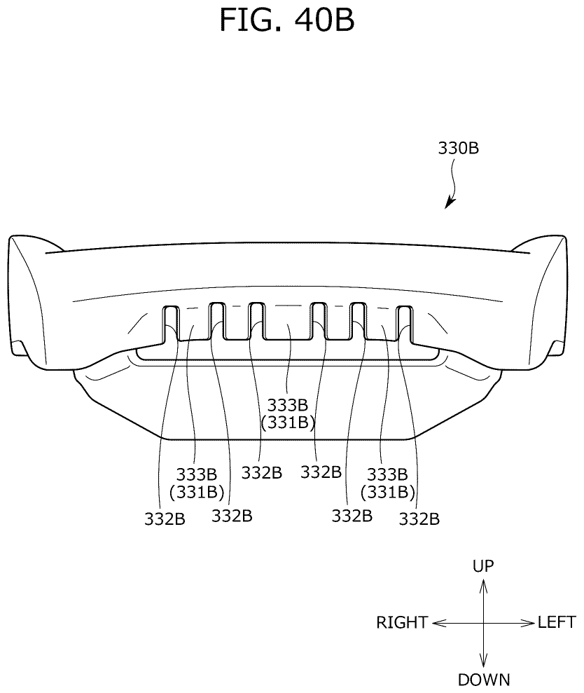

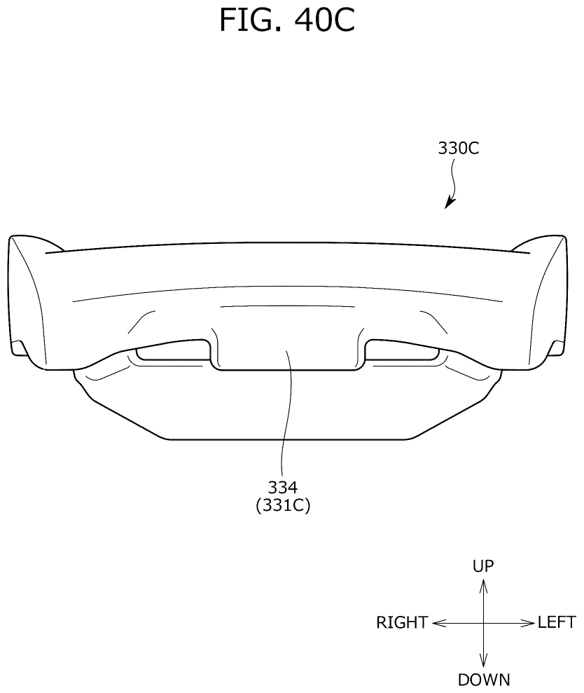

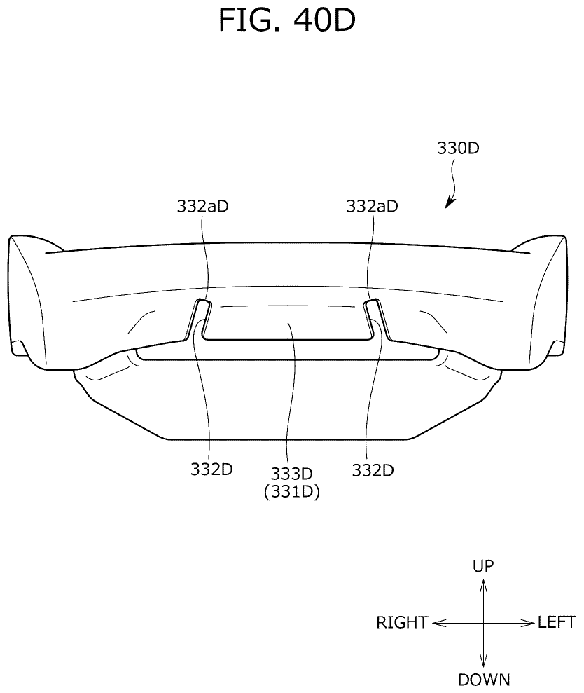

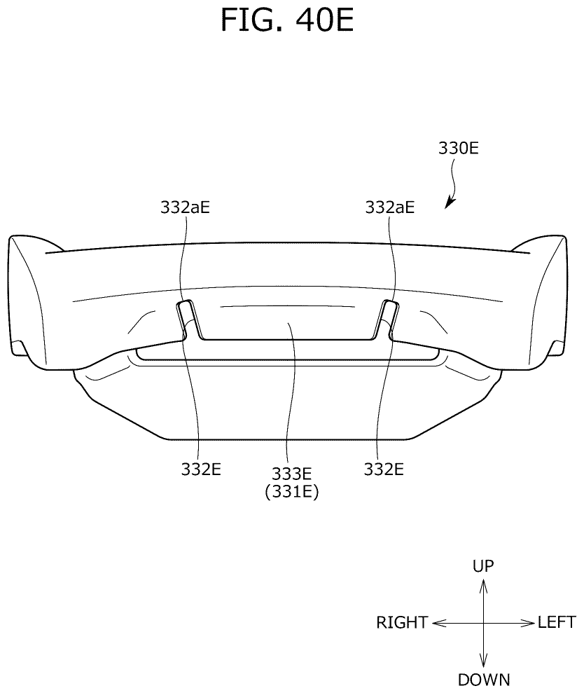

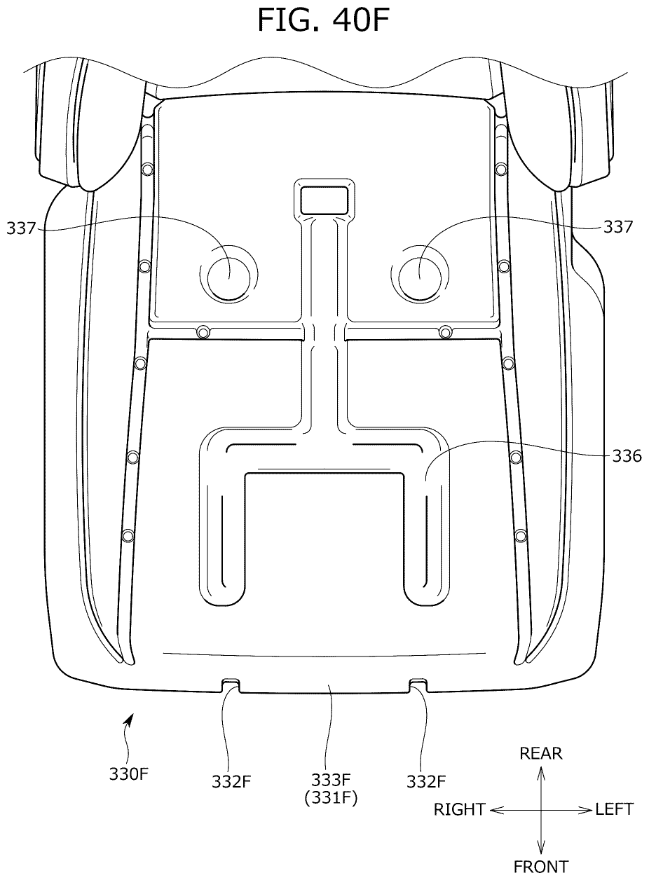

Other examples of the engaged portion 331 formed in the cushion pad 330 will be described with reference to FIGS. 40A to 40F.

As in a cushion pad 330A shown in FIG. 40A, four slits 332A may be made in a front end portion (wrapping portion 338) of the cushion pad 330A to form two protrusions 333A serving as engaged portions 331A. In this case, although not shown, two opening portions 354 are formed in the heater base material 351 of the cushion heater 350 at positions corresponding to the two protrusions 333A.

In addition, as in a cushion pad 330B shown in FIG. 40B, six slits 332B may be made in the front end portion of the cushion pad 330A to form three protrusions 333B serving as engaged portions 331B. In this case, although not shown, three opening portions 354 are formed in the cushion heater 350 at positions corresponding to the protrusions 333B.

The cushion heater 350 can be more firmly attached by providing a plurality of the protrusions 333A and 333B. In addition, even when the plurality of protrusions 333A and 333B are provided, the occurrence of creases in the heater base material 351 can be suppressed by disposing the protrusions 333A and 333B at bilaterally symmetrical positions.

In addition, as in a cushion pad 330C shown in FIG. 40C, a protruding portion 334 protruding from a front end portion of the cushion pad 330C may be provided at the front end portion. The protruding portion 334 is allowed to easily pass through the opening portion 354 of the cushion heater 350 by providing the protruding portion 334 protruding from the front end portion.

In addition, as in a cushion pad 330D shown in FIG. 40D, two slits 332D forming a protrusion 333D may be formed in an inverted V-shape when viewed from the front. In other words, it is preferable that the two slits 332D adjacent to each other are formed such that bottom portions 332aD thereof are closer to each other. By forming the two slits 332D in such a manner, compared to the case of forming the two slits 332D in a straight shape as in the slits 332 shown in FIG. 36, the opening portion 354 that is engaged with the protrusion 333D is made less likely to come off therefrom.

In addition, as in a cushion pad 330E shown in FIG. 40E, two slits 332E forming a protrusion 333E may be formed in a V-shape when viewed from the front. In other words, it is preferable that the two slits 332E adjacent to each other are formed such that bottom portions 332aE thereof are further spaced apart from each other. By forming the two slits 332E in such a manner, compared to the case of forming the two slits 332E in a straight shape as in the slits 332 shown in FIG. 36, the opening portion 354 is easily hooked onto the protrusion 333E.

In addition, as in a cushion pad 330F shown in FIG. 40F, in some conveyance seats, a ventilation groove 336 may be formed to allow air blown from an installed blower device (not illustrated) to exit from the seating surface. In addition, recessed portions 337 in which a pressure sensor for a seat belt reminder and the like are provided may be formed in the cushion pad 330F.

It is preferable that slits 332F and a protrusion 333F formed in the cushion pad 330F are provided at positions where the slits 332F and the protrusion 333F avoid the ventilation groove 336 or the recessed portions 337 for a seat belt reminder.

Namely, it is preferable that the slits 332F and the protrusion 333F are formed at locations where the groove 336 and the recessed portions 337 are not provided. By disposing an engaged portion 331F at such a position, the cushion heater 350 can be attached without affecting the function of the seat.

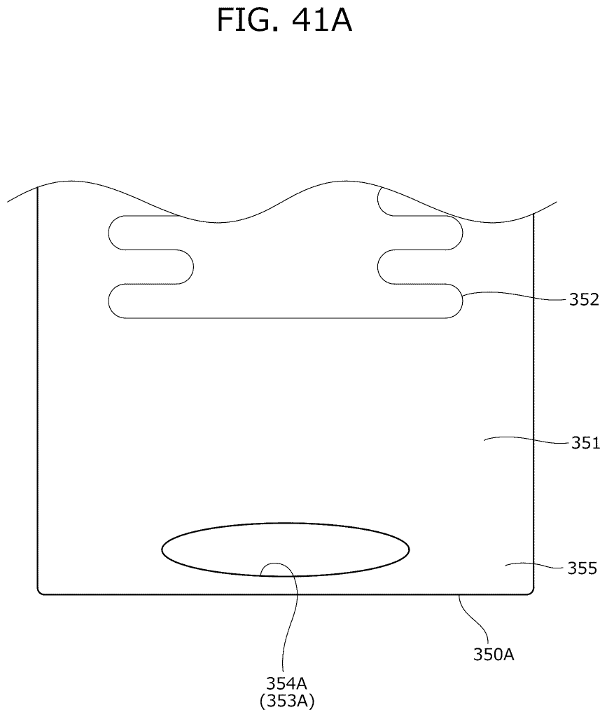

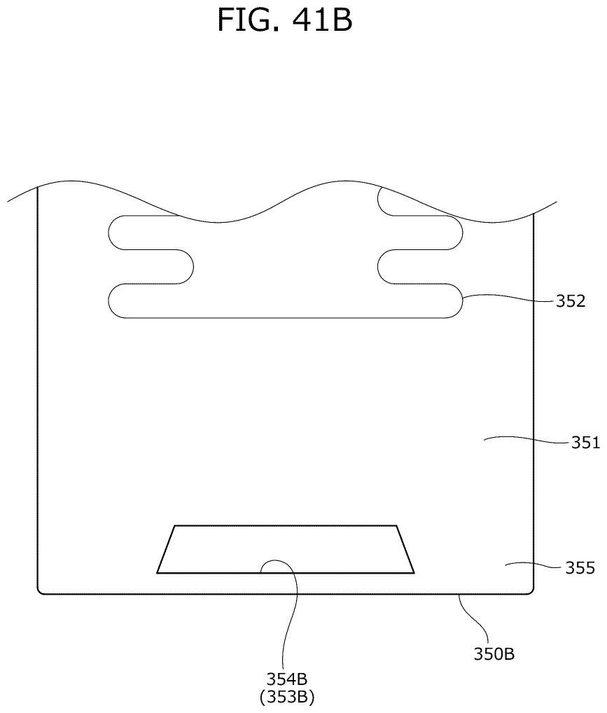

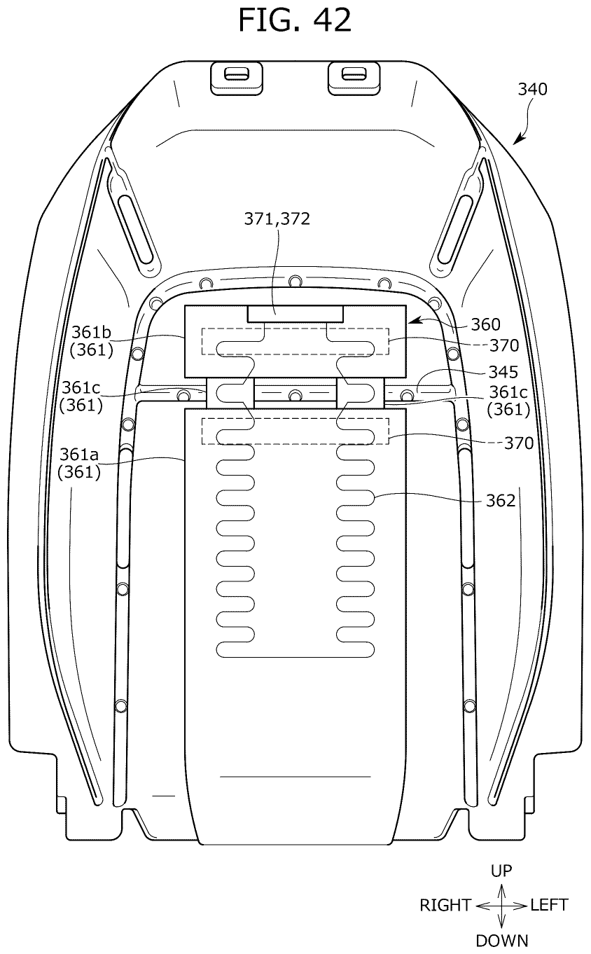

Next, other examples of the cushion heater 350 will be described with reference to FIGS. 41A and 41B. The opening portion 354 of the cushion heater 350 shown in FIG. 36 is formed in a rectangular shape; however, the shape of the opening portion 354 is not limited thereto.

For example, as in a cushion heater 350A shown in FIG. 41A, an opening portion 354A that is an engaging portion 353A may be formed in an elliptical shape that is long in the right to left direction in a top view. The opening portion 354A is easily hooked onto the protrusion 333 by forming the opening portion 354A in such a manner.

In addition, as in a cushion heater 350B shown in FIG. 41B, an opening portion 354B that is an engaging portion 353B may be formed in a trapezoidal shape in a top view. The opening portion 354B is easily hooked onto the protrusion 333 by forming the opening portion 354B in a trapezoidal shape.

### <Back Heater 360>

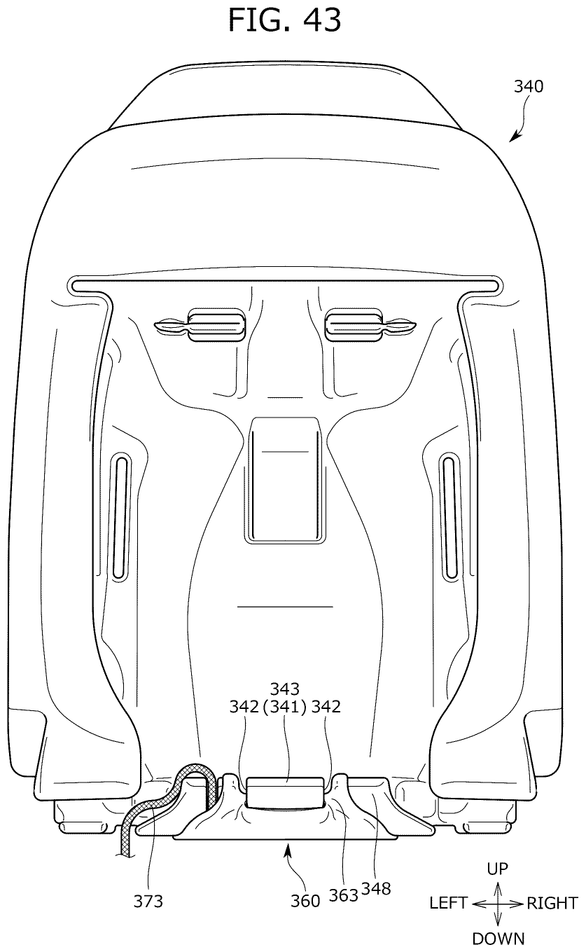

The cushion heater 350 provided in the seat cushion 301 has been described; however, the same configurations may be applied to the back heater 360 provided in the seat back 302. FIG. 42 is a front view of the back pad 340 to which the back heater 360 is attached, when viewed from the front, and FIG. 11 is a rear view of the back pad 340 to which the back heater 360 is attached, when viewed from the rear.

Similarly to the cushion heater 350, the back heater 360 is also mainly composed of a heater base material 361 having a planar shape and made of a polyester fabric material or the like, and a heater wire 362 that is adhesively fixed to the heater base material 361.

The heater base material 361 is made of a stretchable fabric material formed in a substantially rectangular shape, and as shown in FIG. 42, is composed of a lower planar body 361a, an upper planar body 361b, and two connecting planar bodies 361c that connect the lower planar body 361a and the upper planar body 361b. The connecting planar bodies 361c are inserted and placed in the pull-in groove 345 of the back pad 340.

As shown in FIG. 42, the upper planar body 361b and an upper end portion of the lower planar body 361a are fixed using the adhesive member 370.

An opening portion 364 is formed at a lower end portion of the heater base material 361, as an engaging portion 363 that engages with an engaged portion 341 of the back pad 340. A protrusion 343 is provided at a lower end (in more detail, a wrapping portion 348) of the back pad 340 as the engaged portion 341. The protrusion 343 is formed by making two slits 342 in the lower end (wrapping portion 348) of the back pad 340. In addition, the two slits 342 are formed to avoid a harness 373 routed at the lower end of the back pad 340.

The back heater 360 is fixed by fixing an upper end portion side of the back heater 360 using the adhesive member 370, and then rotating a lower end portion of the back heater 360 rearward as shown in FIG. 43, and hooking the opening portion 364 of the back heater 360 onto the protrusion 343 of the back pad 340.

Conventionally, the lower end portion of the back heater 360 is fixed using the adhesive member 370; however, the lower end portion of the back heater 360 is fixed by hooking the opening portion 364 onto the protrusion 343, so that the adhesive member 370 at the lower end portion of the back heater 360 is not necessary. For that reason, the amount of use of the adhesive member 370 can be reduced. In addition, the number of work steps related to the adhesive member 370, for example, the work step of affixing a double-faced tape to a back surface of the back heater 360 or the work step of peeling a release paper of the double-faced tape, can be reduced.

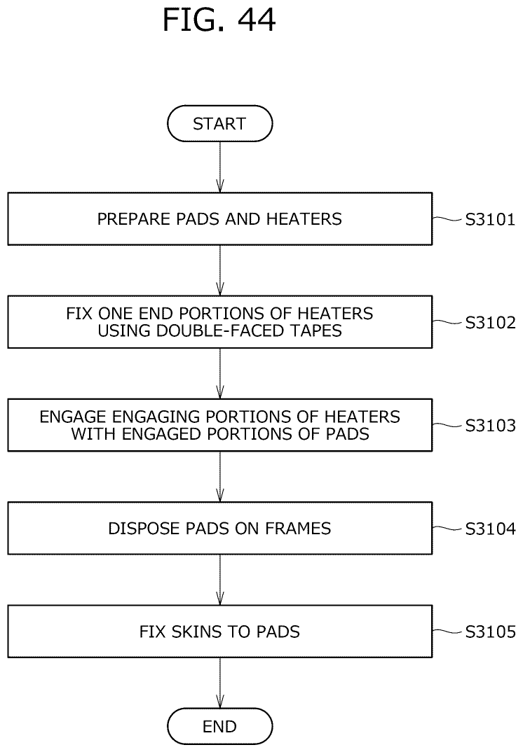

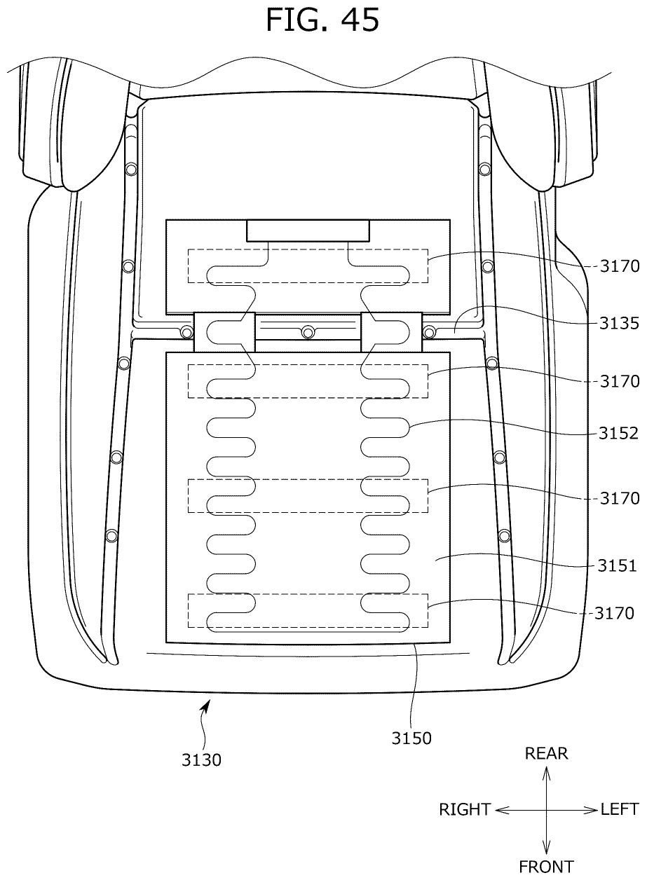

A method for manufacturing the conveyance seat S300 including heaters will be described with reference to a flowchart shown in FIG. 44.

In order to assemble the conveyance seat S300, in step S3101, pads (the cushion pad 330 and the back pad 340) and heaters (the cushion heater 350 and the back heater 360) to be attached to the pads are prepared.

Double-faced tapes are provided on one end portions of the heaters as the adhesive members 370, and the engaging portions 353 and 363 that engage with the engaged portions 331 and 341 of the pads are formed in the other end portions (preparation step).

The process proceeds to step S3102, and the one end portions of the heaters are fixed to the pads using the double-faced tapes (adhesion step). The process proceeds to step S3103, and the engaging portions 353 and 363 formed in the other end portions of the heaters are engaged with the engaged portions 331 and 341 formed in the pads (engagement step).

Next, in step S3104, the pads to which the heaters are attached are disposed on the frame F300 (pad disposing step). The conveyance seat S300 is completed by covering the pads, to which the heaters are attached, with the skins T300, and fixing the skins T300 (skin covering step).

The conveyance seat S300 according to the present embodiment has been described above with reference to the drawings. In the present embodiment, the opening portion is formed in the heater base material as an engaging portion, and the protrusion is formed on a cushion pad side; however, the heater may be fixed to the pad by forming a protrusion in the heater base material, and forming a recess, into which the protrusion is inserted, on a pad side. For example, the heater is fixed to the pad by providing a clip on the heater base material, and providing a clip receiving portion on the pad side. In addition, in the present embodiment, at the front end portion of the cushion pad, the engaged portion engages with the engaging portion of the heater base material; however, the engaged portions may be provided at right and left end portions or a rear end portion of the cushion pad, and may be engaged with the engaging portions of the heater base material. However, it is preferable that the engaged portion is provided at the front end portion (wrapping portion) of the cushion pad, which is the best in the ease of assembly.

In addition, the conveyance seat of the present embodiment is installed in a vehicle; however, the present invention is not limited to the conveyance seat S300 installed in ground-traveling conveyances including wheels such as an automobile and a train, and can also be applied to, for example, the conveyance seat S300 installed in an aircraft, a ship, or the like that moves in environments other than the ground.

Supplementary notes regarding the second to fourth embodiments will be provided as follows.

### Second Embodiment

### Supplementary Note 1

A vehicle seat device, including:
a first vehicle seat; and
a second vehicle seat disposed in front of or behind the first vehicle seat in a front to rear direction of a vehicle,
wherein the first vehicle seat includes a seat back and a seat cushion, and is switchable between a usage state where an occupant can be seated and a stored state where the seat back and the seat cushion are folded from the usage state to overlap each other, are moved downward while heading toward a second vehicle seat side, and are stored,
the second vehicle seat includes a support member that supports the first vehicle seat,
the support member is switchable between a stowed position where the support member is stowed on the second vehicle seat and a support position where the support member is deployed from the stowed position toward a first vehicle seat side to support the first vehicle seat, and
when the first vehicle seat is in the stored state, the support member supports the first vehicle seat so as to restrict a movement of the first vehicle seat by switching from the stowed position to the support position.

### Supplementary Note 2

The vehicle seat device according to Supplementary Note 1,
wherein the second vehicle seat includes a seat cushion,
the support member is attached to the seat cushion of the second vehicle seat, and
the support member is stowed on the seat cushion of the second vehicle seat when the support member is in the stowed position, and is deployed from the stowed position toward the first vehicle seat side to switch to the support position.

### Supplementary Note 3

The vehicle seat device according to Supplementary Note 1,
wherein the second vehicle seat includes a seat body including a seat back and a seat cushion, and a foot member that is attached to the vehicle and that supports the seat body,
the support member is attached to the foot member of the second vehicle seat, and
the support member is stowed on the foot member when the support member is in the stowed position, and is deployed from the stowed position toward the first vehicle seat side to switch to the support position.

### Supplementary Note 4

The vehicle seat device according to Supplementary Note 1,
wherein the second vehicle seat includes a seat body including a seat back and a seat cushion,
the support member is a string-shaped member,
one end portion of the support member is fixed to the seat body of the second vehicle seat,
an engaging portion for detachably engaging with an engaged portion provided in the first vehicle seat is provided at the other end portion of the support member, and
when the first vehicle seat is in the stored state, the engaging portion of the support member engages with the engaged portion of the first vehicle seat, so that the support member supports the first vehicle seat from above.

### Supplementary Note 5

The vehicle seat device according to Supplementary Note 1,
wherein the support member is a plate-shaped member having a support surface, and supports the first vehicle seat from below via the support surface when the first vehicle seat is in the stored state.

### Supplementary Note 6

The vehicle seat device according to Supplementary Note 5,
wherein a recess or a hole portion for storing an item to be stored is formed on the support surface.

### Supplementary Note 7

The vehicle seat device according to Supplementary Note 1,
wherein a hook portion for hooking luggage is formed at a tip portion of the support member.

### Supplementary Note 8

The vehicle seat device according to any one of Supplementary Notes 1 to 7,
wherein the second vehicle seat includes a seat back and a seat cushion, is disposed in front of the first vehicle seat in the front to rear direction of the vehicle, and is switchable between a normal state where the occupant can be seated and a tumble state where the seat back is folded from the normal state to overlap the seat cushion and a rear end portion of the seat cushion is rotated toward a front side while being flipped and becomes upright.

### Supplementary Note 9

The vehicle seat device according to any one of Supplementary Notes 1 to 7,
wherein the first vehicle seat is disposed behind the second vehicle seat in the front to rear direction of the vehicle, and is switchable between the usage state and the stored state where the seat back is folded from the usage state to overlap the seat cushion, a rear end portion of the seat cushion is rotated toward a front side while being flipped, and the seat cushion is overlapped on the seat back.

### Supplementary Note 10

The vehicle seat device according to any one of Supplementary Notes 1 to 7,
wherein the first vehicle seat is disposed behind the second vehicle seat in the front to rear direction of the vehicle, and is switchable between the usage state and the stored state where the seat back and the seat cushion are folded from the usage state to overlap each other, are moved downward while heading forward in the folded posture, and are stored.

### Supplementary Note 11

A vehicle, including:
the vehicle seat device according to Supplementary Note 1.

### Third Embodiment

### Supplementary Note 12

A vehicle seat, including:
a seat back;
a seat cushion;
the vehicle seat being switchable between a usage state where an occupant can be seated, a first folded state where the seat back is folded from the usage state toward the seat cushion, and a second folded state where a rear end portion of the seat cushion is flipped forward from the usage state to cause the seat cushion to become upright, and the seat back is folded toward a vehicle body floor at a position behind the seat cushion that is upright,
a first rotating shaft for rotating the seat back with respect to the vehicle body floor when the vehicle seat is switched from the usage state to the first folded state; and
a second rotating shaft for rotating the seat back with respect to the vehicle body floor when the vehicle seat is switched from the usage state to the second folded state,
wherein the first rotating shaft and the second rotating shaft are disposed at different positions in a side view of the vehicle seat.

### Supplementary Note 13

The vehicle seat according to Supplementary Note 12,
wherein when the vehicle seat is in the usage state, the first rotating shaft is disposed above the second rotating shaft, and
the first rotating shaft and the second rotating shaft are separated from each other in an up to down direction by a distance larger than a thickness of the seat cushion.

### Supplementary Note 14

The vehicle seat according to Supplementary Note 12, further including:
a base member movably attached to the vehicle body floor,
wherein the seat back is rotatably attached to the base member,
the seat cushion is rotatably attached to the base member, and
the vehicle seat is switchable between the usage state, the first folded state, and a stored state where the base member, together with the seat back and the seat cushion, is moved downward from the first folded state while heading toward a front side and is stored.

### Supplementary Note 15

The vehicle seat according to Supplementary Note 14, further including:
a link member that rotates the seat back with respect to the base member,
wherein the link member includes a link portion that is long,
the first rotating shaft is attached to one end portion of the link portion, and the second rotating shaft is attached to the other end portion of the link portion,
the seat back is attached to the link member to be rotatable about the first rotating shaft, and
the link member is attached to a rear end portion of the base member to be rotatable about the second rotating shaft.

### Supplementary Note 16

The vehicle seat according to Supplementary Note 14,
wherein the vehicle seat is switchable between the usage state, the first folded state, and an upright state where a rear end portion of the base member is flipped from the first folded state, and the base member, together with the seat back and the seat cushion, is rotated toward the front side to become upright.

### Supplementary Note 17

The vehicle seat according to Supplementary Note 14,
wherein the vehicle seat is switchable between the usage state, the first folded state, and the stored state where the base member, together with the seat back and the seat cushion, is moved downward from the first folded state while heading toward the front side in the posture where the seat back is folded on the seat cushion, and is stored.

### Supplementary Note 18

The vehicle seat according to any one of Supplementary Notes 12 to 14, further including:
a first lock member for locking the first rotating shaft;
a second lock member for locking the second rotating shaft; and
an operating member that releases a locked state of the first lock member and a locked state of the second lock member,
wherein the operating member includes an operating lever that is operated by the occupant, and a cable that connects the operating lever to the first lock member and the second lock member,
the first lock member is caused to transition from a locked position to an unlocked position by pulling the cable from a normal position to a first release position via the operating lever, and
the second lock member is caused to transition from a locked position to an unlocked position by further pulling the cable from the first release position to a second release position via the operating lever.

### Supplementary Note 19

A vehicle, including:
the vehicle seat according to Supplementary Note 12.

### Fourth Embodiment

### Supplementary Note 20

A conveyance seat, including:
a frame;
a pad disposed on the frame; and
a heater disposed on the pad,
wherein the heater is composed of a heater base material and a heater wire provided on the heater base material,
the heater base material is provided with an engaging portion that engages with the pad, and
the pad is provided with an engaged portion that engages with the engaging portion.

### Supplementary Note 21

The conveyance seat according to Supplementary Note 20,
wherein the engaging portion is an opening portion formed in the heater base material, and
the engaged portion is a protrusion formed in the pad to engage with the opening portion.

### Supplementary Note 22

The conveyance seat according to Supplementary Note 2,
wherein the protrusion is formed by slits made in the pad.

### Supplementary Note 23

The conveyance seat according to Supplementary Note 21,
wherein the protrusion is provided at an end portion of the pad.

### Supplementary Note 24

The conveyance seat according to Supplementary Note 22,
wherein the frame is a cushion frame including a pan frame at a front of the cushion frame,
the pad is a cushion pad that supports buttocks of an occupant, and
at least parts of the slits forming the protrusion are disposed at positions overlapping the pan frame in a front view.

### Supplementary Note 25

The conveyance seat according to Supplementary Note 20,
wherein the engaged portion is disposed at a center of the pad in a seat width direction.

### Supplementary Note 26

The conveyance seat according to Supplementary Note 21,
wherein a length of the protrusion in a seat width direction is larger than a length of the opening portion in the seat width direction.

### Supplementary Note 27

The conveyance seat according to Supplementary Note 21,
wherein the opening portion before engaging with the protrusion is disposed slightly further inward in an extending direction of the heater than when the opening portion is engaged with the protrusion.

### Supplementary Note 28

The conveyance seat according to Supplementary Note 20,
wherein the engaging portion is provided at a position where the engaging portion avoids the heater wire, a breaker, and a thermistor included in the heater.

### Supplementary Note 29

The conveyance seat according to Supplementary Note 20,
wherein the engaged portion is provided at a position where the engaged portion avoids a ventilation groove or a recessed portion for a seat belt reminder that are formed in the pad.

### REFERENCE SIGNS LIST

RS: rear seat
S, SA: conveyance seat
1: seat back
2: seat cushion
3: headrest
5: reclining knob
10, 10A: back frame (frame member)
11: hole portion (engaged portion)
   11a: upper side
   11b: lower side
12: step portion
13: bead
14: seat fixing portion (fixing portion)
15: tether anchor
   15a: slit
16: first hole portion (engaged portion)
17: second hole portion (engaged portion)
20, 20A: skin material
   20a, 20Aa: first end portion (one end portion)
   20b, 20Ab: second end portion (the other end portion)
21, 21A: first engaging portion
   21a: tip
22, 22A: second engaging portion
   22a: tip
23: first extending portion
   23b: rear end
24, 24A: second extending portion
   24b: rear end
25a, 25b: skin piece
26, 26A: hanging portion
27: opening portion
28: linear fastener
   28a: terminal portion
29: strap (hiding portion)
30: back pad
31: upper wrapping portion
32: lower wrapping portion
33: recess
34: lock device
36: recess

### Second Embodiment

V100: vehicle
S101, S102, S103, S104, S105, S106, S107: vehicle seat device
F100: vehicle body floor
   F101: upper step portion
   F102: lower step portion
P100: pad material
T100: skin material
101, 101A: rear seat
102, 102A: front seat
110: seat back
   110a: back frame
   110b: lower end portion
   110c: upper end portion
   110d: engaged portion
111: seat cushion
   111a: front end portion
   111b: rear end portion
   111c: cushion frame
112: headrest
113: base member
   113a: rotating shaft
   113b: biasing mechanism
114: rotation lock member
   114a: tilt shaft
   114b: lock mechanism
115: operating portion
120: seat back
   120a: back frame
   120b: lower end portion
   120c: upper end portion
121: seat cushion
   121a: front end portion
   121b: rear end portion
   121c: cushion frame
122: headrest
123, 123A: foot member
   123a, 123Aa: leg portion
   123b: support shaft
   123c: holding portion
   123d: biasing mechanism
124: rotation lock member
   124a: tilt shaft
   124b: lock mechanism
   124c: held portion
125: operating portion
130: support member
131: plate-shaped member
   131a: support surface
132: rotating shaft
133: storage portion
   133a: recess
   133b: hole portion
134: hook portion
140: support member
141: pipe member
   141a: support portion
142: pipe rotating shaft
150: support member
151: string-shaped member
   151a: one end portion
   151b: the other end portion
152: engaging portion
160: support member
170: support member
171: pipe member
   171a: support portion
172: pipe rotating shaft
180: support member
181: string-shaped member
   181a: one end portion
   181b: the other end portion
182: engaging portion
190: rotating member
191: upper rotating portion
   191a: upper fixing portion
   191b: upper arm portion
   191c: upper connecting portion
192: lower rotating portion
   192a: lower fixing portion
   192b: lower arm portion
   192c: lower connecting portion

### Third Embodiment

V200: vehicle
S200: vehicle seat device
F200: vehicle body floor
   F201: upper step portion
   F202: lower step portion
P200: pad material
T200: skin material
201: rear seat (vehicle seat)
202: front seat
210: seat back
   210a: back frame
   210b: lower end portion
   210c: upper end portion
211: seat cushion
   211a: cushion frame
   211b: rotating end portion
212: headrest
213: base member
   213a: fixing portion
   213b: arm portion
   213c: bracket
   213d: biasing mechanism
   213e: rear end portion
   213f: pivot shaft
214: rear link member (link member)
   214a: link portion
   214b: first rotating shaft
   214c: second rotating shaft
215: front link member
   215a: connecting portion
   215b: third rotating shaft
   215c: fourth rotating shaft
216: lock device
   216a: first lock member
   216b: second lock member
217: operating member
   217a: operating lever
   217b: cable
   217b1: intermediate portion
   217b2: lower end portion
220: seat back
   220a: back frame
   220b: lower end portion
   220c: upper end portion
221: seat cushion
   221a: front end portion
   221b: rear end portion
   221c: cushion frame
222: headrest
223: foot member
   223a: leg portion
   223b: support shaft
   223c: holding portion
   223d: biasing mechanism
224: rotation lock member
   224a: tilt shaft
   224b: lock mechanism
   224c: held portion
225: operating portion

### Fourth Embodiment

S300: conveyance seat
301: seat cushion
302: seat back
303: headrest
306: reclining device
F300: frame
T300: skin
310: cushion frame (frame)
311: cushion side frame
312: pan frame
313: front pipe
314: rear pipe
315: pressure receiving plate
320: back frame (frame)
321: back side frame
322: upper frame
323: lower frame
324: suspension frame
325: pressure receiving plate
326: headrest guide
327: headrest pillar
330, 330A to 330F: cushion pads (pads)
331, 331A to 331F: engaged portions
332, 332A to 332F: slits
   332aD, 332aE: bottom portion
333, 333A to 333F: protrusions
334: protruding portion
335: pull-in groove
336: ventilation groove
337: recessed portion
338: wrapping portion
340: back pad (pad)
341: engaged portion
342: slit
343: protrusion
345: pull-in groove
348: wrapping portion
350: cushion heater (heater)
351: heater base material
   351a: front planar body
   351b: rear planar body
   351c: connecting planar body
352: heater wire
353, 353A, 353B: engaging portion
354, 354A, 354B: opening portion
355: front end portion
360: back heater (heater)
361: heater base material
   361a: lower planar body
   361b: upper planar body
   361c: connecting planar body
362: heater wire
363: engaging portion
364: opening portion
370: adhesive member
371: breaker
372: thermistor
373: harness

1. A conveyance seat, comprising:
a frame member; and
a skin material that covers the frame member,
wherein the skin material includes a first engaging portion and a second engaging portion that engage with the frame member,
the first engaging portion is provided at one end portion of the skin material,
the second engaging portion is provided at the other end portion located on the side opposite to the one end portion,
the frame member includes an engaged portion with which the first engaging portion and the second engaging portion of the skin material engage, and
the first engaging portion and the second engaging portion engage with the same engaged portion.

2. The conveyance seat according to claim 1,
wherein the engaged portion is a hole portion formed in a rectangular shape in the frame member,
the first engaging portion engages with one side of the hole portion, and
the second engaging portion engages with the other side facing the one side.

3. The conveyance seat according to claim 1,
wherein the first engaging portion is provided with a first extending portion that is formed such that a length of the first extending portion in a seat width direction decreases as the first extending portion extends toward a tip of the first engaging portion, and
the second engaging portion is provided with a second extending portion that is formed such that a length of the second extending portion in the seat width direction decreases as the second extending portion extends toward a tip of the second engaging portion.

4. The conveyance seat according to claim 3,
wherein a length of a rear end of the second extending portion in the seat width direction is shorter than a length of a rear end of the first extending portion in the seat width direction.

5. The conveyance seat according to claim 3,
wherein a length of the first extending portion in a direction perpendicular to the seat width direction is longer than a length of the second extending portion in the direction perpendicular to the seat width direction.

6. The conveyance seat according to claim 1,
wherein a step portion is formed in the frame member, and
the engaged portion is disposed in the vicinity of the step portion.

7. The conveyance seat according to claim 6,
wherein a bead is formed in the vicinity of the step portion.

8. The conveyance seat according to claim 1,
wherein the frame member includes a fixing portion for fixing the conveyance seat to a conveyance, and
the engaged portion is disposed at a position overlapping the fixing portion in a direction perpendicular to a seat width direction.

9. The conveyance seat according to claim 1,
wherein the frame member includes a tether anchor for fixing a child seat, and
the engaged portion is disposed at a position overlapping the tether anchor in a seat width direction.

10. The conveyance seat according to claim 1,
wherein the skin material is provided with a linear fastener that couples side portions of the skin material after the frame member is covered with the skin material, and
a terminal portion of the linear fastener is covered by a hiding portion.
